(19) United States
(12) Patent Application Publication
(10) Pub. No.: US 2020/0310985 A1
(43) Pub. Date: Oct. 1, 2020

(54) LEASE CACHE MEMORY DEVICES AND METHODS

(71) Applicant: University of Rochester, Rochester, NY (US)

(72) Inventors: Pengcheng Li, San Jose, CA (US); Chen Ding, Pittsford, NY (US); Colin Pronovost, Rochester, NY (US)

(21) Appl. No.: 16/829,443

(22) Filed: Mar. 25, 2020

Related U.S. Application Data
(60) Provisional application No. 62/824,622, filed on Mar. 27, 2019.

(51) Int. Cl. G06F 12/123; G06F 12/0815; G06F 9/30

(52) U.S. Cl. CPC G06F 12/123; G06F 9/30101; G06F 9/30138; G06F 12/0815

(57) ABSTRACT

A processor includes at least one core and an instruction set logic including a plurality of lease cache memory instructions. At least one cache memory is operatively coupled to the at least one core. The at least one cache memory has a plurality of lease registers. A lease cache memory method and a software lease cache product are also described.

### CROSS-REFERENCE TO RELATED APPLICATIONS

This application claims priority to and the benefit of co-pending U.S. provisional patent application Ser. No. 62/824,622, LEASE CACHE MEMORY DEVICES AND METHODS, filed Mar. 27, 2019, which application is incorporated herein by reference in its entirety.

### STATEMENT REGARDING FEDERALLY FUNDED RESEARCH OR DEVELOPMENT

This invention was made with government support under Contract Nos. CCF-1717877, CCF-1629376, CNS-1319617, CCF-1116104 awarded by the National Science Foundation. The government has certain rights in the invention.

### FIELD OF THE APPLICATION

The application relates to memory management and particularly to management of cache memory.

### BACKGROUND

In the background, other than the bolded paragraph numbers, non-bolded square brackets (“[ ]”) refer to the citations listed hereinbelow.

Locality is a fundamental property of computation and a central principle in software, hardware and algorithm design [1_8]. Denning defines locality as the “tendency for programs to cluster references to subsets of the address space for extended periods” [1_10, pp. 143]. Computing systems exploit locality to provide greater performance at lower cost: algorithms keep some data items in expensive fast memory and other data items in plentiful memory that is inexpensive but slower. Examples include compiler register allocation, software-managed and hardware-managed memory caches, and operating system demand paging. Optimal algorithms must know all of the data elements that will be accessed in the future and the order in which they will be accessed [1_12]. Because such information is usually not available, many algorithms use information about recent data element accesses in the past to predict future behavior [1_19].

### SUMMARY

A processor includes at least one core and an instruction set logic including a plurality of lease cache memory instructions. At least one cache memory is operatively coupled to the at least one core. The at least one cache memory has a plurality of lease registers.

The at least one cache memory can include a first-level cache.

The lease cache shared memory system can include a lease controller, and a lease cache memory operatively coupled to and controlled by the lease controller.

The lease cache shared memory system can include for each of the at least one core: an occupancy counter and an allocation register.

The instruction set logic can include a processor instruction set architecture (ISA).

The lease cache shared memory system can include an optimal steady state lease (OSL) statistical caching component.

The lease cache shared memory system can include for each of the at least one core, a space efficient approximate lease (SEAL) component.

The data structure of the lease cache shared memory system can include a SEAL metadata.

The space efficient approximate lease (SEAL) component can achieve an O(1) amortized insertion time and uses a

$$O ( M + \frac{1}{α} log L )$$

space while ensuring that data stay in cache for no shorter than their lease and no longer than one plus some factor α times their lease, where O is a time, M is a number of unique items, α is an accuracy parameter, and L is a maximal lease.

The processor can further include a near memory disposed on a same or different substrate as the processor, the near memory operatively coupled to the processor and including a lease controller; and a lease cache memory operatively coupled to and controlled by the lease controller.

A lease cache memory method includes: providing a computer program on a non-volatile media; compiling the computer program with a program lease compiler to generate a binary code; executing the binary code on a processor having a lease cache memory and an instruction set including a plurality of lease cache memory instructions; and managing a population and an eviction of data blocks of the lease cache memory based on leases, each lease having assigned thereto a lease number.

The step of compiling can include an assignment of a lease demand type of program lease, a time a data item is to stay in lease cache.

The step of compiling can include an assignment of a lease request type of program lease, a time a data item is to stay in lease cache based on a cache size.

The step of compiling can include an assignment of a lease termination type of program lease, to evict a data item from a lease cache.

The step of managing a population and an eviction of data blocks of the lease cache memory can be based on an optimal steady state lease (OSL) statistical caching.

The OSL caching can include a space efficient approximate lease (SEAL) component achieves O(1) amortized insertion time and uses an

$$O ( M + \frac{1}{α} log L )$$

space while ensuring that data stay in cache for no shorter than their lease and no longer than one plus some factor α times their lease, where O is a time, M is a number of unique items, α is an accuracy parameter, and L is a maximal lease.

The step of executing the binary code on a processor can include executing the binary code on a processor having at least one lease controller and at least one lease cache.

The step of executing the binary code on a processor can include executing the binary code on a processor having at least one lease mark cache.

A software product can be provided on a non-volatile media which manages a main memory use by at least one or more clients. The software product includes a lease cache interface to manage a main memory use by at least one or more clients. The lease cache interface is operatively coupled to the at least one or more clients. A software lease cache system is operatively coupled to the lease cache interface. The software lease cache system has a plurality of lease cache registers which manage use of a plurality of size classes of the main memory as directed by an OSL caching component.

A client can include file caching of at least one local application.

A client can include at least one remote client.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a diagram showing the universality and canonicity of the lease-cache model;

FIG. 2 is a drawing which illustrates two factors of cache demand, liveness and reuse;

FIG. 3 shows an exemplary calculation of lease cache demand and cache performance;

FIG. 4 is a graph which illustrates the effect of Theorem 5;

FIG. 5 is a reuse time histogram which illustrates OSL;

FIG. 6 shows an exemplary PPUC process algorithm;

FIG. 7 shows an exemplary OSL process algorithm;

FIG. 8 is a drawing which illustrates a basic SEAL design;

FIG. 9 shows a table 1 of trace characteristics;

FIG. 10A is a graph showing a performance comparison for a wdev MSR trace;

FIG. 10B is a graph showing a performance comparison for a is MSR trace;

FIG. 10C is a graph showing a performance comparison for a rsrch MSR trace;

FIG. 10D is a graph showing a performance comparison for a hm MSR trace;

FIG. 10E is a graph showing a performance comparison for a prxy MSR trace;

FIG. 10F is a graph showing a performance comparison for a proj MSR trace;

FIG. 10G is a graph showing a performance comparison for a web MSR trace;

FIG. 10H is a graph showing a performance comparison for a stg MSR trace;

FIG. 10I is a graph showing a performance comparison for a prn MSR trace;

FIG. 10J is a graph showing a performance comparison for a src1 MSR trace;

FIG. 10K is a graph showing a performance comparison for a usr MSR trace;

FIG. 11A is a graph showing maximal cache size and capped OSL for mds;

FIG. 11B is a graph showing maximal cache size and capped OSL for src2;

FIG. 12 is a graph showing a Memcached comparison for fb6;

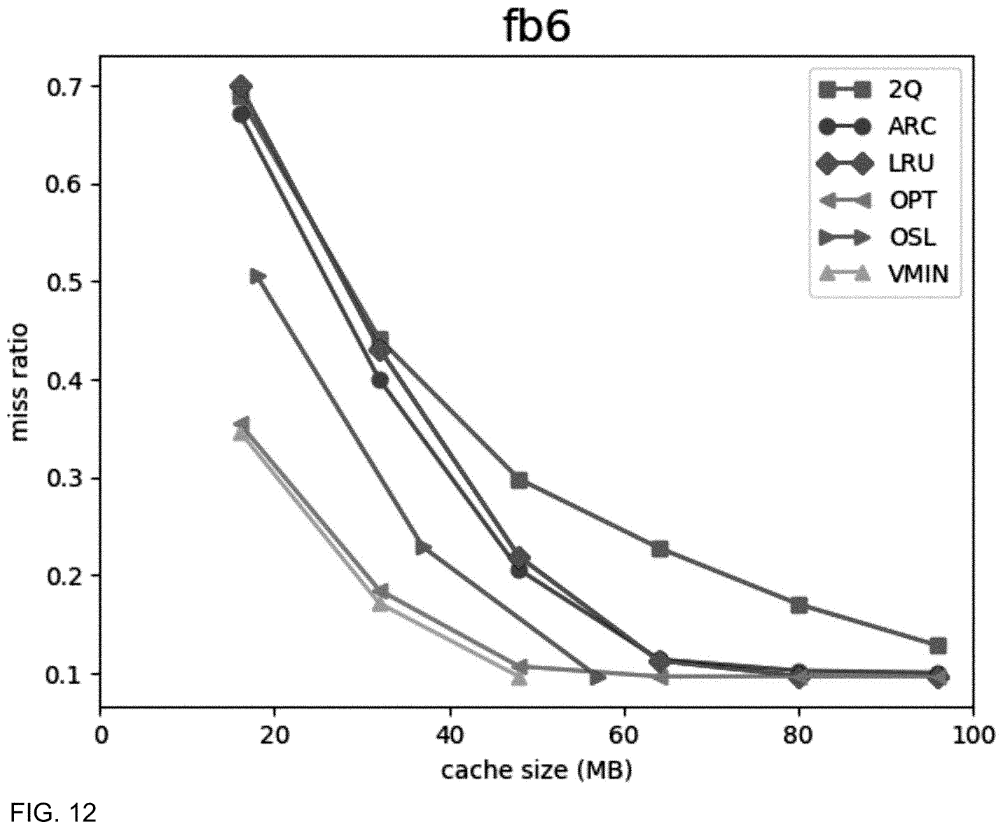

FIG. 13 is a block diagram showing a full implementation of lease cache in hardware;

FIG. 14 is a block diagram showing a partial implementation of lease cache in hardware;

FIG. 15 is a block diagram showing an exemplary processor, near memory, and main memory;

FIG. 16 is a block diagram showing an exemplary full implementation of lease cache in hardware;

FIG. 17 is a block diagram showing more detail of the hardware shared lease cache system of FIG. 16;

FIG. 18 is a block diagram showing an exemplary partial implementation of lease cache in hardware;

FIG. 19 is a block diagram showing more detail of the hardware lease cache block of FIG. 18;

FIG. 20 is a block diagram showing an exemplary data format for an implementation of lease cache in hardware; and

FIG. 21 is a block diagram showing an exemplary implementation of a lease cache in software.

### DETAILED DESCRIPTION

In the description, other than the bolded paragraph numbers, non-bolded square brackets (“[ ]”) refer to the citations listed hereinbelow.

Following the introduction, the Application is in 3 parts. Part 1 describes locality theory for Program Managed Cache of the new lease cache process in eight sections. Part 2 describes verification of the theory, and the OSL and SEAL process algorithms, and Part 3 describes implementation of the new lease cache methods, in new hardware devices and in new software methods and structures.

### INTRODUCTION

As described hereinabove, locality is a fundamental property of computation and a central principle in software, hardware and algorithm design [1_8]. Denning defines locality as the “tendency for programs to cluster references to subsets of the address space for extended periods” [1_10, pp. 143].

Computing systems exploit locality to provide greater performance at lower cost: algorithms keep some data items in expensive fast memory and other data items in plentiful memory that is inexpensive but slower. Examples include compiler register allocation, software-managed and hardware-managed memory caches, and operating system demand paging. Optimal algorithms must know all of the data elements that will be accessed in the future and the order in which they will be accessed [1_12]. Because such information is usually not available, many algorithms use information about recent data element accesses in the past to predict future behavior [1_19].

However, certain applications may know when some data items are no longer needed. In some cases, static analysis can determine how long a data item is needed. Data-flow analysis can determine when a data value is dead and no longer needed [1_15, 1_20], and dependence analysis [1_1] can determine how many loop iterations into the future a data item is needed. Similarly, application-specific knowledge may reveal how long data will need to be cached: a calendar application knows that a meeting today need not be cached tomorrow, and an online store may not need to cache coupon information past the coupon's expiration date.

A challenge in designing and analyzing caching algorithms is having a single framework which can leverage information on future accesses when it is available while performing best-effort caching of data for which no future information exists. To address this challenge, this Application presents a new lease cache process. The lease cache assigns a lease to each data item brought into the cache. A data item is cached when the lease is active and evicted when the lease expires. Leases can be assigned to data items using a myriad of policies. As described hereinbelow in more detail, the lease cache is universal: the behavior of any caching policy can be expressed as a set of leases in a lease cache. As a result, the lease cache provides a unified formal model for reasoning about policies that manage fast memory.

The Application describes how to compute the average cache size and miss ratio of a lease cache given a set of data accesses and the leases assigned to those data accesses. Using these metrics, we show how to compare the performance of different caching policies by expressing their behavior as leases in a lease cache. The Application then describes how to construct a hybrid lease cache which utilizes information about future memory accesses when it is available but resorts to uniform leases for data when future information is not available. The Application then describes how this hybrid lease cache provides the same performance as an Least Recently Used (LRU) cache but with a smaller average cache size; furthermore, it can provide optimal performance (like VMIN [1_22]) if all future information about data accesses is known. Finally, The Application then describes how to construct an optimal lease cache process algorithm, for systems which partition a cache among different groups of data.

Part 1—Theory

Part 1 of the Application describes lease-cache techniques and metrics, uniform lease cache and equivalence to LRU, optimal lease cache, hybrid lease cache, and optimal cache allocation.

Lease-cache techniques and metrics: The Application defines and describes a new “lease cache” process, the characterization of the lease-cache demand, formal mathematical metrics for measuring cache size and miss ratio, and the properties including universality, canonicity, monotonicity and concavity.

Uniform lease cache and equivalence to LRU: Application describes a uniform lease cache (a lease cache in which all leases are the same length) and show that it is equivalent to a traditional fully associative LRU cache.

Optimal lease cache: The Application describes how to assign leases so that the lease cache exhibits the same performance as the optimal VMIN caching algorithm [1_22].

Hybrid lease cache: The Application introduces, describes, and analyzes the hybrid lease cache which uses information on future data accesses when available and a constant lease time for all other data. We show that this cache can provide the same miss ratio as a cache that uses a uniform lease (such as an LRU cache) but with a cache size that is either the same or smaller than that used by the uniform lease cache. If all future information on data accesses is known, the hybrid lease cache performs optimally like the optimal lease cache.

Optimal Cache Allocation: The Application describes and introduces a process algorithm, based on the lease cache, which optimally allocates cache space between data elements that are placed into different groups and provide examples of real-world problems in which the algorithm would be useful.

Part 1 of the Application includes sections 1-8. Section 1_1 is an introduction. Section 1_2 defines the lease cache and explains how we model the data accesses of programs with it. Section 1_3 shows that any caching policy can be represented as a set of leases in a lease cache and explains how the behaviors of different caching algorithms can be compared using the lease cache model. Section 1_4 defines the lease cache demand metric and shows how it can be used to measure cache algorithm performance metrics such as cache size and cache miss ratio. Section 1_5 shows that a lease cache using leases of the same length is equivalent to an LRU cache. Section 1_6 presents the hybrid lease cache and the optimal cache allocation algorithm. Section 1_7 presents related work, and Section 1_8 concludes Part 1 of the Application.

1_2 Lease Cache Definitions—This section presents the concepts and properties of the lease cache.

1_2.1 Problem Formulation

For the description of the new process algorithm, we assume a two-level memory. The upper level is the cache memory whose size is finite, and the lower level is the main memory which is large enough to store all program data. The data is stored in fixed-size data blocks.

We model a program by its memory accesses. A program generates a sequence of n accesses to m data blocks. A data block must first be fetched to the fast memory before it can be accessed.

Cache behavior is the series of actions by the cache each time a program accesses memory. At each memory access, if the accessed data block is in the cache, no action is needed. Otherwise, the access is a miss, and the data block is loaded from main memory. At the end of each access, the cache may optionally evict one or more data blocks. We consider only two types of actions: misses and evictions. In this exemplary model, we study cache policies by their cache behaviors.

The performance of a cache is measured using two metrics: the amount of resident data within the cache and the number of cache misses it incurs. Because the size of resident data, i.e., the number of data blocks in the cache, may vary, the cache size is measured by the average number of cached data blocks at the start of each program access.

Logical time is used, which starts at 1 at the first program access and increments by 1 at each subsequent access. An access is a time tick. At each time tick, a caching implementation may have at most 1 cache miss and 0 or more evictions. It takes n time ticks to execute the program. The cache size c is the average number of cached data blocks at each time tick i.e. the total number of cached blocks at all time ticks divided by n. The miss ratio mr(c) is the number of misses divided by n. An exemplary implementation is the empty cache, which has mr(0)=1 for all programs.

1_2.2 Lease Traces and Lease Assignments

By way of an analogy to law, a lease is a contract that gives the lease holder specific rights over a property for a specified duration of time. In a lease cache, each memory access is accompanied by a lease, which is a non-negative integer. This number may also be called a lease length, lease term, lease time or expiration time. In this Application, the number is called a lease.

The content of a lease cache is controlled entirely by leases. Let capital letters represent data blocks. At an access to block A at time t with a lease l, the cache loads A into the cache and evicts it at t+l. Any number of evictions can happen at the time tick t+l, and they happen after the data access at that time.

A program using the lease cache is a sequence of n accesses, each of which is assigned a lease. The sequence of memory accesses is called a “program trace”, and the sequence of leases is called a “lease assignment”. The interleaving of the two is given the name, “lease trace”.

Consider an example lease trace A2B1A0. Because the second access of A is covered by the lease of the first access, A is reused in the lease trace. A trace where two or more leases for the same data overlap is not considered a valid trace. This case is handled by lease fitting.

1_2.3 Lease Fitting—A lease is a hold on a cache slot. In general, a lease trace may have a data block with two leases that overlap in time. Lease fitting creates a lease trace in which no two leases for the same data block overlap. During lease fitting, when a block A is discovered that is accessed at time t, if the previous lease of A covers beyond time t and ends at time t+1 or later, the previous lease is shortened to end at time t. The overlap at t is needed—it is the condition for a cache reuse. For example, A3B1A0 becomes A2B1A0 after lease fitting.

Unfitted lease traces have the undesirable property that they may exhibit the same cache behavior (cache misses and evictions, as Section 1_4 describes) when their leases are modified. In contrast, a lease trace after lease fitting has unique cache behavior; a change in any lease in the lease trace would cause the lease cache to exhibit different cache behavior.

1_3 Universality and Canonicity—Comparing different caching algorithms with the lease cache model depends upon two key properties. The first is “universality”: the caching behaviors of all caching algorithms on a memory trace can be encoded as a lease trace for a lease cache. The second is “canonicity”: each unique fitted lease assignment for a memory trace exhibits its own unique cache behavior. Changing one or more leases in a fitted lease assignment will result in a different fitted lease assignment that exhibits different cache behavior for the memory trace. We describe each of these two properties hereinbelow.

1_3.1 Universality—The lease cache is universal: the cache behavior of any caching algorithm on a memory trace can be replicated by assigning leases to each element of the memory trace and processing the resulting lease trace with a lease cache. We first show, by an example, how the lease cache can model two well known policies: LRU and working set (WS). An example program trace ABC DDD DDD CBA includes four sections: the first and last sections access ABC, and the middle two sections access only D. Assume that the cache content is to be cleared (evicted) after the last access.

Fully associative LRU Cache—A fully associative LRU cache has a constant size c and ranks data by the last access time. For any program, the behavior of any cache size can be implemented using leases. For c=2, the equivalent lease cache is obtained by assigning the following leases A2B2C7 D1D1D1 D1D1D2 C2B1A0. Like the LRU policy, the leases maintain a constant cache size and enable reuses of C and D in cache.

Working-set Cache—In the classic design by Denning, time is divided into a series of epochs of length τ [1_6]. At the end of an epoch, data accessed in the last epoch form the working set and are kept in physical memory while all other data is evicted. In the example, if the four sections are four epochs (τ=3), the working set is ABC after the first and last epoch and D after the middle two epochs. The equivalent lease assignment is A5B4C3 D1D1D1 D1D1D3 C2B1A0.

Denning and Kahn examined the difference between LRU and working-set cache [1_9]. Compared to the fixed size LRU cache, the variable-size working-set cache has two benefits. First, when a program uses a large amount of data, the cache is large enough to avoid thrashing. Second, when a program uses a small amount of data, the cache can use less space to save memory.

The use of a lease cache to model the behaviors of these two caching algorithms can be generalized. The following theorem states the generality of lease cache:

(Universality) Given any program and any cache behavior, there exists a lease assignment such that the lease cache has the same sequence of cache operations and the same space consumption (at each data access) as the given cache.

Proof. Universality can be proved by construction. Given a program trace and its cache behavior, a lease assignment is constructed as follows: at each access from the first to the last, we assign a lease that keeps the data block in the cache until its eviction.

Formally, consider some set of data D={d₁, d₂, . . . , dₘ} and an access trace T={t₁, t₂, . . . , tₙ} where ∀i (tᵢ∈D). Let eᵢ be index of the access after which tᵢ is evicted in some caching policy. Assign to each access tᵢ the lease eᵢ−i. Let [symbol] be the resulting lease trace.

The lease cache on [symbol] has the same sequence of cache operations as the original cache.

The lease cache will miss on a given access if and only if the original cache missed on that access: For an access tⱼ such that i>j, tᵢ=tⱼ, and ∀i<k<j (tₖ≠tᵢ) (in other words, tⱼ is the next access of tᵢ after time i). tⱼ is a miss if and only if j>eᵢ by definition of eᵢ in the original cache and by construction in the lease cache, so an access is a miss in the lease cache if and only if it is a miss in the original cache. Note that the effect of lease fitting was not considered in the preceding argument. The result is unchanged after lease fitting, as a lease being fitted implies that there is a reuse and therefore no miss.

Items will be evicted from the lease cache exactly when they are evicted from the original cache: By definition, tᵢ is evicted after access eᵢ in the original cache. By construction, tᵢ is evicted after access i+(eᵢ−i)=eᵢ in the lease cache.

At each access, the lease cache consumes the same amount of space as the original cache.

This is equivalent to stating that at each access, the number of items in each cache is the same, which follows from the previous two paragraphs.

The Universality Theorem states that every cache behavior can be modeled by a lease cache and a lease trace. For example, for the program trace ABC DDD DDD CBA, the two example cache policies can be shown in two lease traces in Table 1. A valid lease trace is denoted by using [symbol] .

TABLE 1
Example Lease Assignments

| | |
|---|---|
| Cache | Lease Trace |
| LRU (c = 2) | A1B1C6 D1D1D1 D1D1D1 A1B1C0 |
| Working Set (τ = 3) | A5B4C3 D1D1D1 D1D1D3 A2B1C0 |

Universality is used to characterize optimality. To claim an optimal solution, the space of all candidate solutions is first defined. We define the solution space to be the set of valid lease assignments.

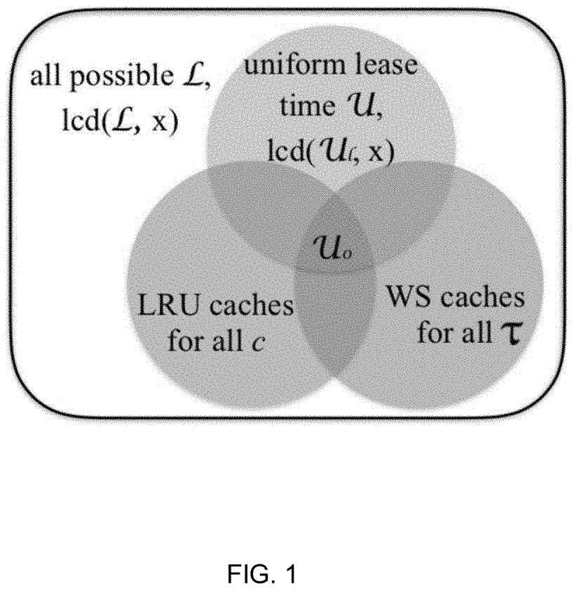

For the remainder of Part 1 of the Application, a lease cache is considered for a single program with n memory accesses. Lease traces differ only in the lease assignment. The space of all valid lease assignments is the set of all possible lease sequences after lease fitting, which we represent by the set Ω={ [symbol] [symbol] ∈ [symbol] ({0 . . . n}ⁿ)}, where n is the length of the program trace, {0 n}ⁿ is the set of all lease sequences, and [symbol] is the lease fitting function. The Ω set is shown visually in FIG. 1. The lease assignment is always defined with respect to some program trace, and usually by comparing and fitting two different lease assignments for the same program trace, so the program trace is omitted, as an explicit parameter to the lease fitting function. [symbol] denotes a valid lease assignment, i.e. a sequence of n lease times after lease fitting.

One reason a lease trace is useful is that for any given cache, if the lease trace for that cache is known, then what elements are in the cache at any given time can also be known without knowing any specifics of the cache. Therefore, regardless of the size of the cache or what the replacement policy is of that cache, the state of the cache at a given point in time can be known.

FIG. 1 is a diagram showing the universality and canonicity of the lease-cache model. The whole set includes all valid lease assignments [symbol] . LRU cache, WS cache and uniform lease are subsets. In FIG. 1, LRU and working-set caches are represented by two subsets, each containing a lease assignment for each c≥0 and τ≥0 respectively. A third subset is a set of policies we call Uniform Lease policies. Uniform lease policies are policies in which all accesses in a trace are assigned the same lease time l. A Uniform Lease policy is symbolized as [symbol] ₗ.

FIG. 1 shows a common case, the empty cache, which operates the same in all cache policies. Formally, this can be shown by the identity of lease assignment, e.g., 00 . . . 0 for [symbol] _{LRU(0)} and [symbol] _{WS(0)}, which is also [symbol] ₀.

1_3.2 Canonicity—Universality allows any caching behavior to be represented by a lease trace. Canonicity allows the cache behaviors of different caching algorithms to be compared by comparing lease traces.

Property 1 (Canonicity)—Changing one or more leases in a fitted lease assignment will change the cache behavior of the lease cache on that memory trace. This property holds: extending a lease will cause the data item to be evicted one time-step later (or multiple time-steps if it extends into a new lease for the same data item), and reducing a lease will cause a data item to be evicted one time-step earlier.

Property 1 ensures that every fitted lease assignment encodes distinct cache behavior. Cache behavior is identical if and only if their fitted lease assignments are identical. Canonicity allows one to compare the behavior of two caching algorithms by comparing the fitted lease assignments.

The next section describes the formalism to model lease cache performance, i.e. the cache size and the miss ratio.

1_4—Lease Cache Demand

1_4.1 Definition of Lease Cache Demand

A method of measuring the amount of cache demanded by a particular program within a lease cache is now defined. The method is called the “lease cache demand” Measuring a program's demand for cache memory is a prerequisite for calculating the performance metrics (namely, the cache size and cache miss ratio).

Given a program, its lease cache demand is the two-parameter function lcd( [symbol] ,x). The first parameter is the lease assignment [symbol] , and the second is the timescale x≥0. It shows the average cache demand of the program in all windows of length x.

A window and its cache demand is first defined. Following the convention of the working-set definition by Denning [1_6], backward windows are used. A “time window” is ω=(t,x) which ends at time t and has the length x. The time window includes the time period from t−x+1 to t, including t−x+1 and t. A time window is also called a “time interval” in the literature.

Cache demand is defined next. Cache demand depends on two factors: liveness and reuse. Now, more precisely:

Definition 1 (Liveness) A lease is live at time t, if the range of the lease covers t. A lease is live in a window ω, if it is live at any point in ω. For a lease assignment [symbol] and x≥0, the function live ( [symbol] ,x) is the average number of live leases in all windows of length x.

Liveness shows the total demand for cache, because each live lease requires a cache block for its data. The actual demand is moderated by reuse, i.e. how often the same cache block is reused for two leases. A “reuse interval” is defined to count the number of reuses in a window.

Definition 2 (Reuse Interval) A reuse interval exists between every two consecutive accesses (and leases) of the same data. The reuse interval spans from the end of the previous lease to the start of the next lease.

Definition 3 (Reuse) The number of reuses in a window ω is the number of reuse intervals that are entirely contained in co. For a lease assignment [symbol] and x≥0, the function reuse( [symbol] ,x) is the average number of reuses in all windows of length x.

Lease cache demand defined more precisely: Definition 4 (Lease Cache Demand) The lease cache demand of a window ω is the number of its live leases minus the number of its reuses. For a lease assignment [symbol] and x≥0, the function lcd( [symbol] ,x) is the average lease cache demand in all windows of length x.

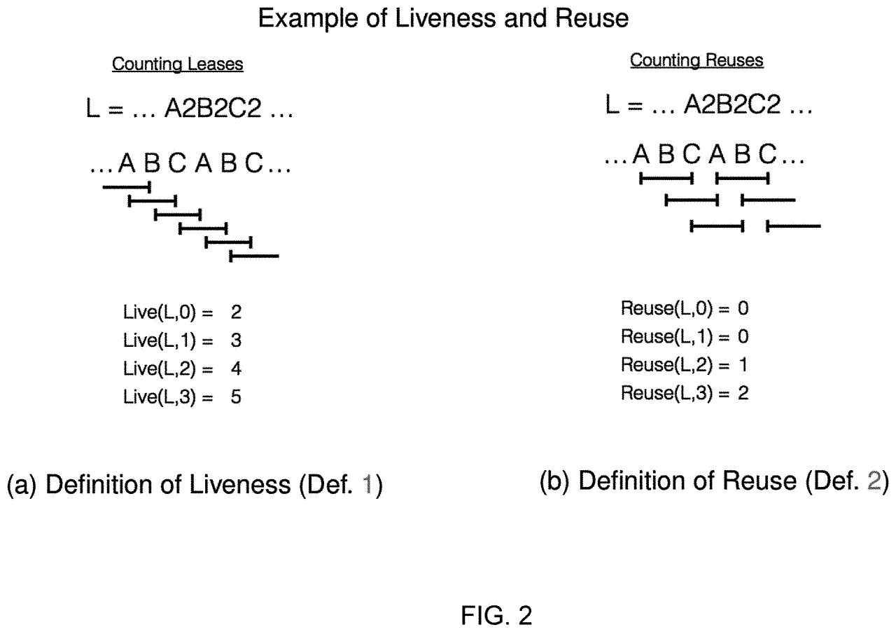

FIG. 2 is a drawing which illustrates two factors of cache demand, liveness and reuse. FIG. 2 illustrates these definitions together and visually for the example [symbol] =A2B2C2 A2B2C2 . . . because the example trace is infinitely repetitive, any single window of length x gives the average of all windows of length x. Part (a) shows the liveness: live( [symbol] ,0)=2, live( [symbol] ,1)=3, live( [symbol] ,2)=4, and live( [symbol] ,3)=5. Part (b) shows the reuse: reuse( [symbol] ,0)=0, reuse( [symbol] ,1)=0, reuse( [symbol] ,2)=1, and reuse( [symbol] ,3)=2.

Computing live( [symbol] ,x)—In lease cache, time is measured by the number of allocations. For a window of length x, the number of new leases is x. The number of previously existing leases is estimated by dividing the sum of all leases by the length of the program:

$$live ( ℒ , x ) = \frac{L}{n} + x \qquad ( 1 )$$

where n is the length of the program, and L=Σᵢ₌₁ⁿlᵢ is the total length of all leases.

Computing reuse( [symbol] ,x)—It is tricky to compute reuse( [symbol] ,x) in all windows because the number of windows is quadratic to n. We show a linear-time solution. First, we convert the problem of reuse counting per window to that of window counting per reuse. Counting by windows is inefficient because the total number of windows is quadratic. Counting by reuses is more efficient because the total number of reuses is linear (at most one interval per access).

From the view of window counting, an execution is a collection of n reuse intervals (sᵢ,eᵢ) (i=1 . . . n), where sᵢ and eᵢ is the start and end of the i^{th} reuse interval. A window of length x may contain a reuse interval if eᵢ−sᵢ+1≤x or equivalently, eᵢ−sᵢ<x; otherwise no window can contain this interval, and the window count is 0. If the function I( ) takes a predicate and returns 0 if the predicate is false and 1 if the predicate is true, then the following equation shows the result of window counting:

$$\begin{matrix}reuse ( ℒ , x ) = \frac{{\sum }_{i = 1}^{n} I ( {e}_{i} - {s}_{i} < x ) ( min ( n - x + 1 , {s}_{i} ) )}{n - x + 1} + \frac{{\sum }_{i = 1}^{n} I ( {e}_{i} - {s}_{i} < x ) ( - max ( x , {e}_{i} ) + x )}{n - x + 1} & ( 2 ) \\ \approx \frac{{\sum }_{i = 1}^{n} I ( {e}_{i} - {s}_{i} < x ) ( {s}_{i} - {e}_{i} + x )}{n} & ( 3 )\end{matrix}$$

Eq. 2 is precise. It has special terms to count windows at the start and the end of the trace. Eq. 3 simplifies it by removing these terms of boundary effects. As an approximation, it is accurate if the length of the trace is much greater than the window length, n>>x. In fact, this is the limit value when n→∞. We call approximation the steady-state reuse or the limit reuse.

For each access, the reuse time rᵢ is the time difference between the previous and the current access. Because rᵢ−lᵢ=eᵢ−sᵢ, Eq. 3 can be rewritten as

$$reuse ( ℒ , x ) = \frac{{\sum }_{{r}_{i} - {l}_{i} < x} x - ( {r}_{i} - {l}_{i} )}{n} \qquad ( 4 )$$

Computing lcd is similar to computing the footprint, which counts the number of distinct data items in each window. Xiang [1_14] discovered an efficient solution based on differential counting [1_14]. However, differential counting does not work here because a lease is a time span, not a single point. Take the window (t,x). When we shift from (t,x) to (t+1,x), in the footprint analysis, the access at t falls out of the window, but for the current problem, a lease at t may still be contained in the window.

Computing lcd( [symbol] ,x)

Combining Eqs. 1, 5, and 4, we have the following Eq. 6 to compute the lease cache demand:

(Lease Cache Demand) For any program and its lease assignment [symbol] ={lᵢ},1≤i≤n, and all 0≤x≤n, we have

$$\begin{matrix}lcd ( ℒ , x ) = live ( ℒ , x ) - reuse ( ℒ , x ) & ( 5 ) \\ \approx \frac{L}{n} + x - \frac{{\sum }_{{ }_{{r}_{i} - {l}_{i} < x}} x - ( {r}_{i} - {l}_{i} )}{n} & ( 6 )\end{matrix}$$

where L=Σ₁ⁿlᵢ is the total length of all leases, and rᵢ is the reuse time of the ith access (which is ∞ if it is the first access to a data block).

1_4.2 Cache Size and Miss Ratio

The lease cache does not have a constant size. We compute the average size as the cache size, which is the average number of data blocks in the cache before each access. From the lease cache demand of a lease trace [symbol] , it is simple to compute the average cache size and the miss ratio.

(Lease Cache Size) The average cache size of the lease cache is lcd( [symbol] ,0).

Because a data block stays in the cache when and only when it has a lease, it is obvious that the average cache size is the total lease of all data divided by the trace length. This is exactly lcd( [symbol] ,0) (see Eq. 6).

The following property is a result of lease fitting and aids our proof for computing the miss ratio from the lease cache demand:

Property 2 (Lease Time Bound) Given a fitted lease trace, if lᵢ is the lease time for access at time i and rᵢ is the distance between the access at time i and the next access of the same element in the future i.e., the reuse distance, then ∀i: lᵢ≤rᵢ.

(Miss Ratio)—For a given L, the miss ratio of the lease cache is lcd( [symbol] ,1)−lcd( [symbol] ,0).

Proof. Because,

$$lcd ( ℒ , 0 ) = \frac{L}{n}$$

$$lcd ( ℒ , 1 ) = \frac{L}{n} + 1 - \frac{{\sum }_{{r}_{i} - {l}_{i} < 1} ( 1 - ( {r}_{i} - {l}_{i} ) )}{n}$$

$$Thus , \\ lcd ( ℒ , 1 ) - lcd ( ℒ , 0 ) = 1 - \frac{{\sum }_{{r}_{i} - {l}_{i} < 1} ( 1 - ( {r}_{i} - {l}_{i} ) )}{n} = 1 - \frac{{\sum }_{{r}_{i} \leq {l}_{i}} ( 1 - ( {r}_{i} - {l}_{i} ) )}{n}$$

From Property 2, we have lᵢ≤rᵢ, thus,

$$lcd ( ℒ , 1 ) - l cd ( ℒ , 0 ) = 1 - \frac{{\sum }_{{r}_{i} = {l}_{i}} 1}{n}$$

Therefore, lcd( [symbol] ,1)−lcd( [symbol] ,0) is the miss ratio.

The miss-ratio formula can be shown as being equivalent to the probability that the lease is less than the reuse time, i.e. P(l<rt).

### Example

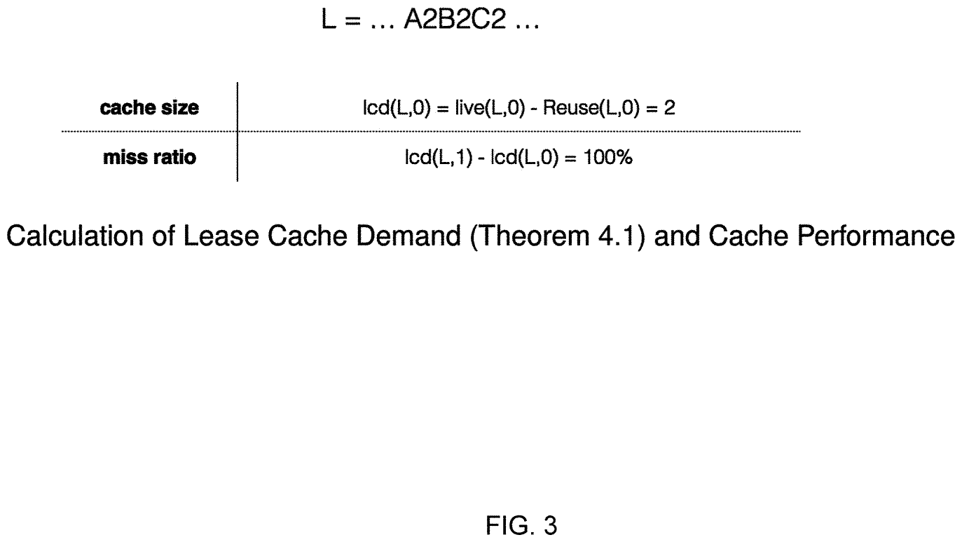

FIG. 3 shows an exemplary calculation of lease cache demand and cache performance. Using the example in FIG. 3 it can be verified that for each single window, the lease cache demand is 2 for x=0 and 3 for x>0, and lcd( [symbol] ,x) is the same when computed using live and reuse as in Eq. 5 and using reuse time rᵢ=3 as in Eq. 6. It is also easy to see that lcd( [symbol] ,x) can be computed in linear time over one pass profiling of the data accesses and the lease times, because Eq. 6 requires only the histogram of reuse times.

A final feature of lease cache demand is that lease fitting does not change the lease cache demand of a lease trace. We formally prove this in Theorem 5:

(Lease Fitting Equivalence) If [symbol] ^{b} is an unfitted lease trace and [symbol] ^{a} is a fitted lease trace for [symbol] ^{b}, then lcd( [symbol] ^{b},x)=lcd( [symbol] ^{a},x).

Proof. We use lᵢ^{b} and lᵢ^{a} to denote the lease times before and after lease fitting for memory access i in the trace. If rᵢ is the reuse distance between access i and the next access of the same data item, we have

$${l}_{i}^{a} = ( \begin{matrix}{r}_{i} & if {l}_{i}^{b} > {r}_{i} \\ {l}_{i}^{b} & otherwise\end{matrix}$$

We use lcd( [symbol] ^{b},x) and lcd( [symbol] ^{a},x) to denote the lease cache demands computed using lease times before and after lease fitting. We therefore have:

$$lcd ( {ℒ}^{a} , x ) = \frac{{\sum }_{i = 1}^{n} {l}_{i}^{a}}{n} + x - \frac{{\sum }_{{r}_{i} - {l}_{i}^{a} < x} x - ( {r}_{i} - {l}_{i}^{a} )}{n} = \frac{{\sum }_{{l}_{i}^{b} \leq {r}_{i}} {l}_{i}^{a}}{n} + \frac{{\sum }_{{l}_{i}^{b} > {r}_{i}} {l}_{i}^{a}}{n} + x - \frac{{\sum }_{{l}_{i}^{b} \leq {r}_{i} , {r}_{i} - {l}_{i}^{a} < x} x - ( {r}_{i} - {l}_{i}^{a} )}{n} - \frac{{\sum }_{{l}_{i}^{b} > {r}_{i} , {r}_{i} - {l}_{i}^{a} < x} x - ( {r}_{i} - {l}_{i}^{a} )}{n} = \frac{{\sum }_{{l}_{i}^{b} \leq {r}_{i}} {l}_{i}^{a}}{n} + x - \frac{{\sum }_{{l}_{i}^{b } \leq {r}_{i} , {r}_{i} - {l}_{i}^{a} < x} x - ( {r}_{i} - {l}_{i}^{a} )}{n} + \frac{{\sum }_{{l}_{i}^{b} > {r}_{i}} {l}_{i}^{a}}{n} - \frac{{\sum }_{{l}_{i}^{b} > {r}_{i} , {r}_{i} - {l}_{i}^{a} < x} x - ( {r}_{i} - {l}_{i}^{a} )}{n}$$

Applying the definition of lᵢ^{a} from above gives=

$$\frac{{\sum }_{{l}_{i}^{b} \leq {r}_{i}} {l}_{i}^{b}}{n} + x - \frac{{\sum }_{{l}_{i}^{b} \leq {r}_{i} , {r}_{i} - {l}_{i}^{b} < x} x - ( {r}_{i} - {l}_{i}^{b} )}{n} + \frac{{\sum }_{{l}_{i}^{b} > {r}_{i}} {r}_{i}}{n} - \frac{{\sum }_{{l}_{i}^{b} > {r}_{i} , {r}_{i} - {r}_{i} < x} x - ( {r}_{i} - {r}_{i} )}{n} = \frac{{\sum }_{{l}_{i}^{b} \leq {r}_{i}} {l}_{i}^{b}}{n} + x - \frac{{\sum }_{{l}_{i}^{b} \leq {r}_{i} , {r}_{i} - {l}_{i}^{b} < x} x - ( {r}_{i} - {l}_{i}^{b} )}{n} + \frac{{\sum }_{{l}_{i}^{b} > {r}_{i}} {r}_{i} - x}{n} = \frac{{\sum }_{{l}_{i}^{b} \leq {r}_{i}} {l}_{i}^{b}}{n} + x - \frac{{\sum }_{{l}_{i}^{b} \leq {r}_{i} , {r}_{i} - {l}_{i}^{b} < x} x - ( {r}_{i} - {l}_{i}^{b} )}{n} + \frac{{\sum }_{{l}_{i}^{b} > {r}_{i}} {l}_{i}^{b} - ( x - ( {r}_{i} - {l}_{i}^{b} ) )}{n} = \frac{{\sum }_{{l}_{i}^{b} \leq {r}_{i}} {l}_{i}^{b}}{n} + x - \frac{{\sum }_{{l}_{i}^{b} \leq {r}_{i} , {r}_{i} - {l}_{i}^{b} < x} x - ( {r}_{i} - {l}_{i}^{b} )}{n} + \frac{{\sum }_{{l}_{i}^{b} > {r}_{i}} {l}_{i}^{b}}{n} - \frac{{\sum }_{{l}_{i}^{b} > {r}_{i}} x - ( {r}_{i} - {l}_{i}^{b} )}{n}$$

$$Because x \geq 0 , {r}_{i} - {l}_{i}^{b} < 0 \leq x when {l}_{i}^{b} > {r}_{i} = \frac{{\sum }_{{l}_{i}^{b} \leq {r}_{i}} {l}_{i}^{b}}{n} + x - \frac{{\sum }_{{l}_{i}^{b} \leq {r}_{i} , {r}_{i} - {l}_{i}^{b} < x} x - ( {r}_{i} - {l}_{i}^{b} )}{n} + \frac{{\sum }_{{l}_{i}^{b} > {r}_{i}} {l}_{i}^{b}}{n} - \frac{{\sum }_{{l}_{i}^{b} > {r}_{i} , {r}_{i} - {l}_{i}^{b} < x} x - ( {r}_{i} - {l}_{i}^{b} )}{n} = \frac{{\sum }_{i = 1}^{n} {l}_{i}^{b}}{n} + x - \frac{{\sum }_{{r}_{i} - {l}_{i}^{b} < x} x - ( {r}_{i} - {l}_{i}^{b} )}{n} = lcd ( {ℒ}^{b} , x )$$

1_4.3 Monotonicity and Concavity

Monotonicity means that the demand of a window increases as the window extends. Concavity means that this increase of the demand diminishes in longer window lengths.

The monotonicity of reuse( [symbol] ,x) does not imply the monotonicity of lcd( [symbol] ,x). We still need to show that the difference reuse( [symbol] ,x+1)−reuse( [symbol] ,x)≤1.

(Monotonicity) lcd( [symbol] ,x) is monotone.

Proof. To prove the theorem, it is equivalent to show that reuse( [symbol] ,x+1)−reuse( [symbol] ,x)≤1. We define s′ₓ as the sum of reuses in the first n−x length-x windows, i.e. not including the last window starting at (n−x+1).

s′ₓ=Σᵢ₌₁^{n-x}reuse( [symbol] ,x,i)

sₓ=s′ₓ+reuse( [symbol] ,x,n−x+1)

sₓ₊₁=Σᵢ^{n-x}reusue( [symbol] ,x+1,i)

since reuse( [symbol] ,x+1,i)−reuse( [symbol] ,x,i)≤1

sₓ₊₁−s′ₓ≤n−x

If we compare only between sₓ₊₁ and s′ₓ, the bound obviously holds. If we consider the last window and let Δ=reuse( [symbol] ,x,n−x+1), we have

$$reuse ( ℒ , x + 1 ) - reuse ( ℒ , x ) = \frac{{s}_{x + 1}}{n - x} - \frac{{s}_{x}}{n - x + 1} = \frac{{s}_{x + 1} + ( n - x ) ( {s}_{x + 1} - {s}_{x} )}{( n - x ) ( n - x + 1 )}$$

$$Since {s}_{x + 1} - {s}_{x}^{′} \leq n - x$$

$$reuse ( ℒ , x + 1 ) - reuse ( ℒ , x ) \leq \frac{{s}_{x + 1} + ( n - x ) ( n - x - Δ )}{( n - x ) ( n - x + 1 )}$$

$$we have \frac{{s}_{x + 1} + ( n - x ) ( n - x - Δ )}{( n - x ) ( n - x + 1 )} \leq 1 if Δ \geq \frac{{s}_{x + 1}}{n - x} - 1.$$

(Concavity) lcd( [symbol] ,x) is concave.

Proof. Showing lcd( [symbol] ,x) is concave is equivalent to showing that reuse( [symbol] ,x) is convex. To show this, we see that

$$reuse ( ℒ , x + 1 ) - reuse ( ℒ , x ) = \frac{{s}_{x + 1}}{n - x} - \frac{{s}_{x}}{n - x + 1} = \frac{{s}_{x + 1}}{( n - x ) ( n - x + 1 )} + \frac{{s}_{x + 1} - {s}_{x}}{n - x + 1} = \frac{{s}_{x + 1}}{( n - x ) ( n - x + 1 )} + \frac{{I}_{x + 1}}{n - x + 1}$$

where lₓ is defined as the number of reuse intervals of length <x. Note that when we increase the length of the windows by 1, each reuse interval of length <x+1 contributes 1 extra reuse to the total. The length x reuse intervals now contribute 1 reuse, and the reuse intervals of length <x are each enclosed in one extra window, so each contributes 1 more reuse. Therefore the difference in reuses is sₓ₊₁−sₓ=Iₓ₊₁.

Now, we consider (reuse( [symbol] ,x+2)−reuse( [symbol] ,x+1))−(reuse( [symbol] ,x+1)−reuse( [symbol] ,x)). By the previous, we have

$$( \frac{{s}_{x + 2}}{( n - x - 1 ) ( n - x )} + \frac{{I}_{x + 2}}{n - x} ) - ( \frac{{s}_{x + 1}}{( n - x ) ( n - x + 1 )} + \frac{{I}_{x + 1}}{n - x + 1} ) = \frac{2 {s}_{x + 2}}{( n - x - 1 ) ( n - x ) ( n - x + 1 )} + \frac{{s}_{x + 2} - {s}_{x + 1}}{( n - x ) ( n = x + 1 )} + \frac{{I}_{x + 2}}{n - x} - \frac{{I}_{x + 1}}{n - x + 1} = \frac{2 {s}_{x + 2}}{( n - x - 1 ) ( n - x ) ( n - x + 1 )} + \frac{{I}_{x + 2}}{( n - x ) ( n - x + 1 )} + \frac{{I}_{x + 2}}{n - x} - \frac{{I}_{x + 1}}{n - x + 1}$$

$$Because \frac{{I}_{x + 2}}{n - x} \geq \frac{{I}_{x + 1}}{n - x + 1} , ( reuse ( ℒ , x + 2 ) - reuse ( ℒ , x + 1 ) ) - ( reuse ( ℒ , x + 1 ) - reuse ( ℒ , x ) ) \geq 0 ,$$

reuse( [symbol] ,x) is convex and lcd( [symbol] ,x) is concave.

Section 1_5 Uniform Lease (UL) Cache and LRU Equivalence

A uniform lease-time cache [symbol] ₗ is a lease cache in which the same lease time l≥0 is assigned to every access. We can think of a uniform lease cache as a regular lease cache which is only used on lease traces in which all leases have the same length l. Because all leases have the same length, we can make the constant lease time a global parameter for the uniform lease-time cache.

A uniform lease cache has the same cache performance as a fully associative LRU cache. To start our proof, we present the notation for uniform lease extensions. A lease extension is a function that takes, as input, a lease sequence [symbol] and an integer l and yields a new lease sequence in which all leases in [symbol] have been extended by the value l. Given a window size x, a trace that is the result of a lease extension has the same lease cache demand as the original lease trace with the window size extended by the same amount:

(Uniform Lease Extension) Given a lease sequence [symbol] , if [symbol] ⊕l is the new sequence after adding a non-negative constant l to every lease in [symbol] , then

lcd( [symbol] ⊕l,x)≡lcd( [symbol] ,x+l)

Proof. Let the ith lease be lᵢ in [symbol] and l′ᵢ in [symbol] ⊕l, and L=Σ₁ⁿlᵢ. We have

$$lcd ( L ⊕ l , x ) = \frac{{\sum }_{1}^{n} {l}^{′} i}{n} + x - \frac{{\sum }_{{r}_{i} - {l}_{{i}^{′}} < x} x - ( {r}_{i} - {l}_{{i}^{′}} )}{n} = \frac{L + l n}{n} + x - \frac{{\sum }_{{r}_{i} - ( {l}_{i} + 1 ) < x} x - ( {r}_{i} - ( {l}_{i} + l ) )}{n} = \frac{L}{n} + x + l - \frac{{\sum }_{{r}_{i} - {l}_{i} < x + l} x + l - ( {r}_{i} - {l}_{i} )}{n} = lcd ( ℒ , x + l )$$

A uniform lease extension may yield a lease trace which has overlapping leases i.e., the resulting lease trace may not be fitted. However, Theorem 5 states that the lease cache demand remains the same before and after lease fitting. As a result, the extended lease cache demand computed by Theorem 5 also applies to the result of the lease extension after lease fitting.

The cache demand of a uniform lease-time cache is denoted as lcd( [symbol] ₗ,x). Because the uniform lease time is a special case of a general lease time, it is easy to derive the cache demand by simplifying lcd( [symbol] ,x):

$$lcd ( {𝒰}_{l} , x ) = l + x - \frac{{\sum }_{{r}_{i} - l < x} x - ( {r}_{i} - l )}{n} \qquad ( 7 )$$

The following is the Xiang formula to compute the footprint, i.e. the average working-set size, simplified by omitting the effect of the first and last accesses [1_27]:

$$f p ( x ) = m - \frac{{\sum }_{{r}_{i} > x} ( {r}_{i} - x )}{n} \qquad ( 8 )$$

Xiang et al. [1_27] proved that the derivative of the footprint is the miss ratio of the fully associative LRU cache:

mr(c)=fp(x+1)−fp(x) (9)

where fp(x)=c and c is cache size.

The next two theorems prove that the uniform lease-time cache has the same performance as a fully associative LRU cache:

(Uniform Lease)

lcd( [symbol] ₗ,x)≡fp(x+l)

Proof. We show that lcd( [symbol] ₀,x)≡fp(x). We use the relation Σrᵢ=nm.

$$f p ( x ) = m - \frac{{\sum }_{{r}_{i} > x} ( {r}_{i} - x )}{n} = m + \frac{{Σ}_{{r}_{i} > x} ( x - {r}_{i} )}{n} = m + \frac{{Σ}_{i} ( x - {r}_{i} )}{n} - \frac{{Σ}_{{r}_{i} < x} ( x - {r}_{i} )}{n} = m + x - \frac{{Σ}_{i} {r}_{i}}{n} - \frac{{Σ}_{{r}_{i} < x} ( x - {r}_{i} )}{n} = x - \frac{{Σ}_{{r}_{i} < x} ( x - {r}_{i} )}{n} = lcd ( {𝒰}_{0} , x )$$

From the above and Theorem 5, we have

lcd( [symbol] ₗ,x)≡lcd( [symbol] ₀⊕l,x)≡fp(x+l)

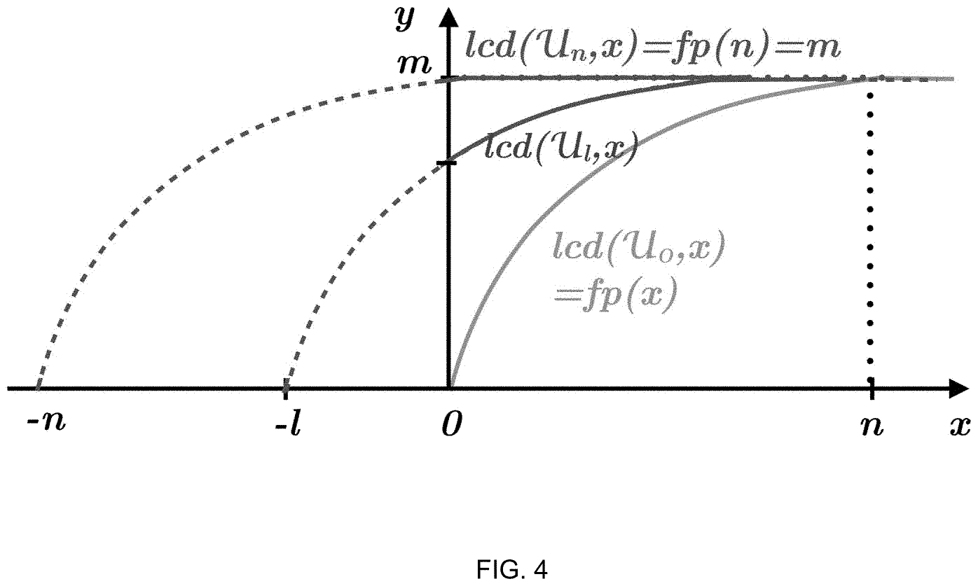

FIG. 4 shows a graph which illustrates the effect of Theorem 5. The three curves show the demand of a uniform lease cache lcd( [symbol] ₗ,x) for an example access trace for three lease times. The lowest and the highest curves are for the minimal lease time (0) and the maximal lease time n. All other demand curves lie in between these two. The middle curve shows the demand for some intermediate 0<l<n. The three curves show the example demand of uniform-lease cache for two extreme values 0, n and some intermediate value 1. Uniform Lease Theorem states that they are identical curves, that is, lcd( [symbol] ₙ,x) and lcd( [symbol] ₗ,x) are lcd ( [symbol] ₀,x) shifted left.

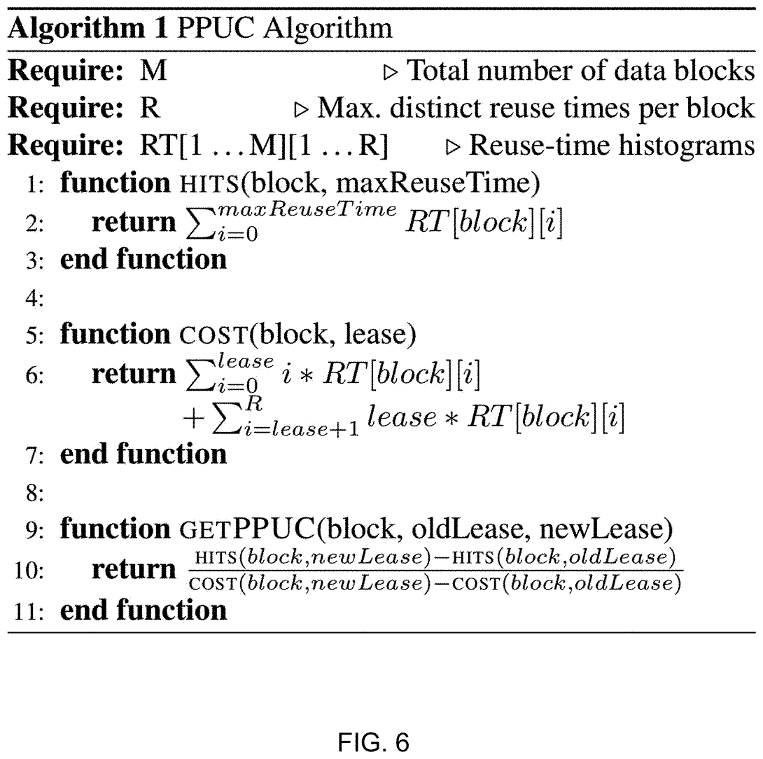

When the lease time is 0, the Uniform Lease Theorem (Theorem 5) states that lcd ( [symbol] ₀,x)=fp(x), that is, the cache demand is the footprint, which grows from 0 to m when x grows from 0 to n. When the lease time is n, the cache demand is always m for all x≥0. When the lease time is 0<l<n, the cache demand grows from fp(l) to m for x≥0. If the values are shown for negative values of x (the two dotted lines in FIG. 6), the Uniform Lease Theorem states that the three curves are identical, that is, lcd( [symbol] ₚ,x) and lcd( [symbol] ₗ,x) are lcd( [symbol] ₀,x) shifted left.

Consider an example p=abc abc . . . . Assuming the trace length n is infinite, each access makes identical contribution to the terms of lcd( [symbol] ₗ,x), in particular,

$$\frac{L}{n} = l and \frac{{\sum }_{{r}_{i} - l < x} x - ( {r}_{i} - l )}{n} = I ( {r}_{i} - l < x ) ( x - ( {r}_{i} - l ) ) ,$$

where I(y) takes a predicate and returns 1 if the predicate is true and 0 if it is false. The latter term is further simplified: consider the reuse time rᵢ=3 for all i:

lcdₚ( [symbol] ₗ,x)=l+x−I(3−l<x)(x+l−3)

When the lease time is 0, we have the cache demand increasing as a function of x as lcdₚ( [symbol] ₀,x)=x−I(3<x)(x−3). When the time length is 0, we have the average cache size increasing as a function of l as lcdₚ( [symbol] ₗ,0)=l−I(3<l)(l−3). They are identical. In fact, we have lcdₚ( [symbol] ₀,x)=lcdₚ( [symbol] ₗ,0)=min(x,3)=fpₚ(x).

Consider how the lease cache operates. When the lease time is 0, the cache does not store any data. When the lease time is 1, a data item is accessed and then evicted before the next access. The cache sizes are 0 and 1 respectively. These are given by lcd( [symbol] ₗ,0) for l=1, 2.

We can now prove LRU equivalence:

(LRU Equivalence) Given a lease trace with uniform lease times and average (lease) cache size c, the number of misses of the lease cache is the same as that of a fully associative LRU cache of the same size c.

Proof. The two miss ratios are computed as follows:

mr_{ulc}(c_{ulc})=lcd( [symbol] ₗ,1)−lcd( [symbol] ₗ,0) where c_{ulc}=lcd( [symbol] ₗ,0)

mrₗᵣᵤ(cₗᵣᵤ)=fp(l+1)−fp(l) where cₗᵣᵤ=fp(l)

From Theorem 5, we have c_{ulc}=lcd( [symbol] ₗ,0)=fp(l)=cₗᵣᵤ and lcd( [symbol] ₗ,1)−lcd( [symbol] ₗ,0)=fp(l+1)−fp(l), so mr_{ulc}(c)=mrₗᵣᵤ(c) for all c.

On the one hand, the equivalence between uniform lease-time cache and LRU cache is intuitive and not surprising, because the order of data eviction is based on the last access time. On the other hand, there is an important difference. The size of lease cache can grow and shrink. The maximal cache size can be as high as l and as low as 1. LRU cache, on the other hand, has a constant size. The theory of lease cache is able to formally and precisely derive this equivalence, making the intuition a logical conclusion.

There is a relation between the derivative of lcd( [symbol] ,x) and the derivative of footprint fp(x) [1_27].

(Smaller Gradient) For any given set of lease times [symbol] , ∀x, lcd′( [symbol] ,x)≤fp′(x).

Proof. The function I( ) takes a predicate as input and returns 0 if the predicate is false and 1 if the predicate is true. Then, from Eq. 6, we have

$${lcd}^{′} ( ℒ , x ) = l cd ( ℒ , x + 1 ) - l cd ( ℒ , x ) = 1 - \frac{{Σ}_{i = 1}^{n} I ( {r}_{i} - {l}_{i} \leq x )}{n}$$

From Eq. 8, we have

$${fp}^{′} ( x ) = 1 - \frac{{\sum }_{i = 1}^{n} l ( {r}_{i} \leq x )}{n}$$

### For any x,

Σᵢ₌₁ⁿ(rᵢ−lᵢ≤x)≥Σᵢ₌₁ⁿI(rᵢ≤x)

Thus, we have

lcd′( [symbol] ,x)≤fp′(x)

1_6 Optimal Lease Cache

1_6.1 Optimal Lease—The optimal method of (variable-size) caching is called VMIN, first given by Prieve and Fabry [1_22]. The VMIN optimality is stronger than the optimal management of fixed-size cache, OPT [1_19]. OPT obtains the lowest possible miss ratio for a cache of any constant size. It is possible that VMIN obtains a lower miss ratio than OPT for the same average cache size by evicting items that cannot be reused.

The following lease assignment implements VMIN in a lease cache is called optimal lease:

Definition 5 (Optimal Lease) Given a series of n data accesses i (i=1 . . . n) each with the forward reuse time the optimal lease lᵢ is

$${l}_{i} = ( \begin{matrix}{r}_{i} , & if {r}_{i} \leq h \\ 0 & otherwise\end{matrix}$$

where the threshold h >0 determines the average lease-cache size.

As the threshold h increases, the program uses more lease cache and benefits from having more memory. No other program change is needed. Hence, the optimal lease enables memory scaling. The use of memory is not only variable, efficient but optimal, as stated by the following theorem:

Let the threshold h >0 result in cache size c. The miss ratio from the optimal lease is the lowest possible for any cache of size c.

The proof of optimality is trivial because a lease cache performs exactly as VMIN with this lease assignment. Because no other cache solution can have a lower miss ratio than VMIN for the same cache size, the equivalent lease cache using this lease assignment strategy is also optimal.

The optimal lease makes the strong assumption that a program has complete knowledge of the future. In the case of partial knowledge of future accesses, the optimal lease can still be used as Section 1_6.2 shows.

1_6.2 Hybrid Lease

Having partial future knowledge of a program means that in its execution, the future data access is known for some of its data or in some uses but not all data or all uses. Optimal lease assignment and uniform lease assignment can be used together. We call this general case the hybrid lease. If the future access is known, the hybrid lease is the optimal lease; otherwise, it is the uniform lease.

Definition 6 (Hybrid Lease) Given a series of accesses n data accesses i (i=n) each tagged with either the forward reuse time rᵢ or a flag meaning no information, the hybrid lease lᵢ is assigned as follows

$${l}_{i} = ( \begin{matrix}{r}_{i} & if {r}_{i} \leq {h}_{opt} \\ 0 & if {r}_{i} > {h}_{opt} \\ {h}_{uni} & if {r}_{i} is unknown\end{matrix}$$

where rᵢ is the forward reuse time, and hₒₚₜ, hᵤₙᵢ>0 are two thresholds that determine the cache size.

For data access i, if the forward reuse time is known, the hybrid lease is the optimal lease with the threshold hₒₚₜ; otherwise, the hybrid lease is the uniform lease hᵤₙᵢ. The two thresholds determine the size of the lease cache.

If a program execution provides partial knowledge of the future, it is desirable to utilize the partial knowledge to improve performance. Here we show a general result comparing hybrid lease, which utilizes program knowledge, with LRU cache, which does not.

It would be very difficult to directly compare hybrid lease and LRU, because they operate very differently. Fortunately, most of this difficulty is already handled by the main theorem of the Application, Theorem 6, which shows the equivalence between the uniform lease cache and the LRU cache. As a result, comparing with the LRU cache can be done by comparing with a uniform lease cache. The latter comparison is simple because hybrid lease is partly uniform lease. It departs from the uniform lease only when it has knowledge about future accesses.

The following theorem shows that, by benefiting from any knowledge, the hybrid lease cache is guaranteed to outperform a uniform lease cache in that the former has the same miss ratio with smaller cache size compared to the latter. In other words, the theorem proves that knowledge is power: knowing forward reuse time reduces the cache consumption.

(Strict Improvement) Given an access sequence using the uniform lease h and the same sequence using the hybrid lease, if the hybrid lease is set hₒₚₜ=hᵤₙᵢ=h, then knowing any forward reuse time rᵢ≠h allows the hybrid lease to use a smaller cache size without incurring additional cache misses.

Proof. Assume the reuse time rᵢ is known and rᵢ≠h. In the uniform lease cache, the lease is h for access i. In the hybrid lease cache, the lease is set according to Definition 6 with hₒₚₜ=h. The hybrid lease is lᵢ=rᵢ if rᵢ<h or lᵢ=0 if rᵢ>h. In both uniform and hybrid lease caches, the access is a hit in the first case and a miss in the second. In both cases, however, the hybrid lease lᵢ is smaller than the uniform lease h, so the cache consumption is smaller in the hybrid lease cache. For any accesses without the knowledge of rᵢ or rᵢ=h, the hybrid lease is the same as the uniform lease because hᵤₙᵢ=h. The hybrid and uniform lease behaves the same, i.e. both hit or both miss, and they have the same cache consumption.

Therefore, the hybrid lease cache behaves the same as the uniform lease cache by default, but its average cache size is reduced for every known rᵢ≠h without increasing the number of cache misses.

The theorem shows that the improvement is a reduction in the lease cache size, and this reduction is strict and per access. Whenever a forward reuse time rᵢ≠h is known, the hybrid lease is reduced from the uniform lease. If we define the number of known reuse times as the amount of future knowledge, then the cache-size reduction is strictly proportional to future knowledge used by the hybrid lease.

Combining Theorem 6.2 and Theorem 6 (LRU Equivalence), we have the proof that the hybrid lease cache is guaranteed to improve over the LRU cache whenever it has knowledge of the forward reuse time.

Further combining Theorem 6.1 (VMIN Leasing), we see that the hybrid lease covers the space of performance between LRU and optimal. When there is no future knowledge about future data access, the hybrid lease cache performs the same as the LRU cache. When there is full future knowledge, the hybrid lease cache becomes the optimal cache. Therefore, the hybrid lease is the general case, and as Theorem 6.2 shows, it makes use of any amount of knowledge.

Both the optimal and hybrid lease algorithms optimize performance by choosing a lease for each access based on future knowledge about the access (if available). Next, we increase the granularity of optimization to a group of accesses based on a weaker form of knowledge in which we know the overall property of a group without knowing precise information about each access.

1_6.3 Optimal Cache Allocation—This section considers the problem when program data is divided into d non-overlapping groups, g₁, g₂, . . . , g_{d} with nᵢ accesses to group gᵢ, where Σᵢ₌₁^{d}|gᵢ|=m, the total data size, and Σᵢ₌₁^{d}|nᵢ|=n, the total number of accesses.

Given the size of a lease cache c, Optimal Cache Allocation (OCA) divides the space between data groups to minimize the total of cache misses across all groups. OCA is a function that assigns a portion of cache cᵢ to group gᵢ such that:

1. Each group is assigned a non-negative portion of cache space (cᵢ≥0);

2. The space assigned to all groups uses all of the cache (c=Σᵢ₌₁^{d}cᵢ); and

3. the total miss ratio from all groups, Σᵢ₌₁^{e} mr(gᵢ,cᵢ), is the smallest possible. Here, mr(gᵢ,cᵢ) is the number of misses (among its nᵢ accesses) divided by n (not nᵢ) and called the normalized per group miss ratio.

In lease cache, increasing cache allocation means increasing the lease. We consider the uniform lease extension (ULE) described in Section 1_5. Given an initial lease assignment [symbol] , ULE adds a constant extension x to each lease, i.e. changing [symbol] to [symbol] ⊕x.

Let each group i be a lease sequence [symbol] ᵢ. OCA chooses the best extension amount xᵢ for each group. The solution has two steps. The first step determines the cache performance of all lease extensions, and the second step chooses the best extension. The next theorem shows how to compute the effect of any extension x on cache performance.

(ULE Performance) For an initial [symbol] and uniform extension lease x, the average cache size is lcd( [symbol] ,x), and the miss ratio is lcd( [symbol] ,x+1)−lcd( [symbol] ,x).

Proof. For an initial lease trace [symbol] , extending the leases uniformly by x results in the lease trace [symbol] ⊕x. By Theorem 4.2, the cache size of [symbol] ⊕x is lcd( [symbol] ⊕x, 0). By Theorem 5, we have

lcd( [symbol] ⊕x,0)=lcd( [symbol] ,x+0)=lcd( [symbol] ,x)

Therefore, the average cache size of [symbol] ⊕x is lcd( [symbol] ,x).

By Theorem 5, lcd( [symbol] ,x+1)=lcd( [symbol] ⊕x, 1), and lcd( [symbol] ,x)=lcd( [symbol] ⊕x, 0). By Theorem 4.2, lcd( [symbol] ⊕x,1)−lcd( [symbol] ⊕x, 0) is the miss ratio of a lease cache processing the lease trace [symbol] ⊕x. Therefore, its miss ratio is also lcd( [symbol] ,x+1)−lcd( [symbol] ,x).

Because the lease cache demand is monotone (Theorem 4.3), the cache size resulting from ULE is monotone. Furthermore, because the lease cache demand is concave (Theorem 4.3), the derivative is monotone. Therefore, the miss ratio resulting from ULE is also monotone. Using more cache never increases the miss ratio; it does not suffer from Belady's anomaly [1_3]. The following theorem states these properties.

(ULE Monotonicity) For any lease sequence [symbol] under ULE, as the extension x increases, the cache size is monotonically non-decreasing, and its miss ratio is monotonically non-increasing.

The ULE Monotonicity theorem is trivially proved by combining Theorems 4.5, 4.6, and 6.3. The ULE monotonicity result applies to all programs and all lease caches.

Optimal Allocation—When allocating more cache for data group gᵢ, the effect of additional cache on the miss ratio is given by the ULE Performance theorem. We compute the allocation that minimizes the total miss ratio across all groups. This problem can be solved using dynamic programming, as shown before for the LRU cache [1_5, 1_17]. When the miss ratio is concave, the optimal allocation can be computed in linear time using a greedy algorithm [1_24]. To measure the lease cache demand (and therefore the cache miss ratio) efficiently, OCA uses the linear-time measurement algorithm for measuring the lease cache demand from Section 1_4.1.

We now show four practical problems which OCA can solve:

Cache Allocation Among Arrays in Scientific Code—A loop nest in a scientific program can access multiple arrays, some with regular access and others with irregular access. An example is sparse matrix-vector multiplication. With the lease cache, the compiler can assign optimal leases for regular arrays, uniform leases for irregular arrays, and OCA to allocate the cache space among all the arrays.

Multi-level Lease Cache—When the lease cache has multiple levels of an increasing amount of space, some lease assignments, e.g. uniform lease with ULE and optimal lease, can utilize the available memory at each level. Others will require a minimal amount of space. It is conceivable that a program is written to utilize the smallest top-level cache and then uses ULE to utilize lower levels of cache. OCA can be applied top-down level by level. A benefit of the preceding theory is that the lease cache demand is measured once and used to optimize the allocation at all cache levels, with arbitrary (non-decreasing) size at each level.

Multi-granularity Data—Software caches can store data with variable granularity. For example, Hu et. al. [1_17] described how Memcached divides data by size into size classes and allocates a pool of memory for each size class; a typical installation uses 32 size classes. They further explained that each unit of allocation is a 1 MB slab, and the slab is divided into slots of equal size [1_17]. Memcached can re-adjust the memory allocation by moving a slab (after evicting cached data) from one size class to another [1_17].

Hu et al. developed LAMA for optimal cache partitioning in Memcached [1_17]. It measures the miss ratio curve of all size classes and partitions the memory so the total number of misses is minimized LAMA was compared with heuristic-based policies including auto-move in Memcached 1.4.11 as of 2014, which re-purposes unused memory; the Twitter policy, which randomly chooses a slab for re-assignment; Periodic Slab Assignment (PSA), which identifies two size classes with uneven demands and changes the allocation between them; and the Facebook policy, which tries to affect a global LRU policy across size classes. The comparison showed that the optimal allocation in LAMA achieves better steady-state performance, faster convergence to the steady-state, and faster and better adaptation to a dynamically changing workload [1_17].

OCA for a software lease cache can be compared to LAMA for a software LRU cache. Compared to the heuristic solutions that incrementally move memory from one size class to another, the optimal allocation computes the global adjustments among all size classes. The global re-assignment avoids inefficiency in incremental re-assignment. It moves memory in batches. Finally, it may achieve an allocation not reachable with incremental solutions.

Multi-programmed Workloads—If the lease cache is used by multiple programs, the partitioning problem is another instance of OCA in which the data from different programs is non-overlapping. In the software lease cache, there is also the problem of OCA among size classes. The two problems may be solved in different orders: OCA first among programs and then size classes within the same program, or alternatively first among size classes and then among programs for the same size class. Because OCA is optimal, the order of these two steps do not matter. The final cache allocation for each size class of each program is the same, and so is the total miss ratio.

1_7 Related Work—This section discusses related work on the formal properties of cache memory.

Working set theory—Denning established the first formalism of the working set [1_6]. Numerous techniques were based on the concept including early techniques for virtual memory reviewed by Denning [1_7] and server load balancing by Pai et al. [1_21]. A recent extension by Xiang et al. defined a working-set concept called footprint as an all-window metric and an algorithm to compute it precisely [1_27]. Similar to the footprint, we define the lease cache demand as an all-window metric, i.e. the average demand of all windows of the same length and for all window lengths. In fact, the lease cache demand subsumes the footprint as a special case where all lease times are zero.

Denning and his colleagues showed the formal relation between the working-set size and the miss ratio for a broad range of caching policies including LRU, working-set cache, VMIN, and stack algorithms including OPT [1_11, 1_12, 1_23]. Xiang showed the same relation for the footprint and called it Denning's law of locality [1_27]. We prove the formal relation for the basic lease cache (Theorem 4.2) and its memory-adaptive extension (Theorem 6.3).

Stack algorithms—Mattson et al. defines a formal property called the inclusion property where the content of a smaller cache is a subset of the content of a larger cache [1_19]. Caching algorithms with the inclusion property are called stack algorithms and include the LRU, most-recently used (MRU), and optimal (OPT) eviction policies [1_19] and a relatively recent addition called the LRU-MRU collaborative cache [1_14]. Stack algorithms are models of fixed-size caches.

The lease cache is both a cache design and a model of performance. For performance, the miss ratio is computed as the derivative of the lease cache demand (Theorem 4.2) and is monotone (Theorem 4.3). In the previous theory of stack algorithms, the inclusion property ensures monotone miss ratios. The monotonicity of the lease cache is based on the uniform lease extension and can be viewed as a generalized inclusion property applicable to any cache (including variable-size caches).

LRU stack distance is called reuse distance for short and has extensive uses in workload characterization. Recent systems make it possible to measure reuse distance with extremely low time and space overhead, including Counter Stack (which has sub-linear space complexity [1_28]), SHARDS (which can also simulate non-LRU policies such as ARC and LIRS [1_25]), and AET (which models cache sharing [1_18]).

Collaborative cache—Wang et al. [1_26] first used the term collaborative caching. Past collaborative policies were designed for CPU caches, most for fixed memory sizes and require re-programming when the memory size changes [1_4, 1_14, 1_26]. The hybrid lease cache is collaborative; it allows a user or a program to assign leases if needed and uses a default lease when there is no external input. Unlike previous solutions, a collaborative lease cache is memory adaptive. By using uniform extension lease, it can utilize more memory when available, and it guarantees monotone performance (Theorem 6.4).

Algorithmic Control of Local Memory—Many algorithms have been developed to make efficient use of a local memory by selectively copying in the input and copying out the result. In 1981, Hong and Kung defined input/output (I/O) complexity as the amount of data transfer between the fast and slow memory required by an algorithm (as a function of the problem size and the fast-memory size) and showed that a set of algorithms including matrix multiply and FFT transfer the least amount of data, i.e. the I/O lower bound [1_16]. A lower-bound algorithm has the optimal locality—no other algorithm can make better use of local memory. A series of studies followed, including lower-bound algorithms for parallel computers with multiple levels of memory [1_2] and cache-oblivious algorithms based on cache instead of explicit I/O operations. A recent technique by Elango et al. derived the asymptotic I/O lower bound by static analysis of loop nests [1_13]. For either I/O efficiency or optimality, these algorithms often require direct control of the local memory and may lose its locality properties when implemented on general-purpose processors with automatically managed cache. With the lease cache, the copy-in and copy-out operations can be used to begin and terminate leases, and the revised algorithm using the lease cache uses the same amount of cache space and performs the same amount of data transfer as the original algorithm using the local memory.

There are different levels of program control. A carefully designed program can adapt to any given memory size and change its input/output operations. A cache oblivious algorithm can utilize any amount of cache memory. Less powerful than those, a program may be designed for specific but not all sizes of local memory or cache. With lease cache, this latter type of programs can make use of cache of all sizes. Assuming that a program has full knowledge of its data access, and the order of the data access does not change with the memory size, the optimal lease (Theorem 6.1) guarantees the best use of local memory.

1_8 Summary—This Application describes the lease cache: a new caching algorithm that assigns leases to data as they enter the cache and evicts data when the lease expires. We have described the universality and canonicity of the lease cache with respect to cache behavior. We defined an all-window metric called lease cache demand and used it to compute the lease cache performance. Using these metrics, we showed that the performance of uniform lease assignments is equivalent to fully associative LRU caches and that the lease cache can provide optimal performance when all future data accesses are known a priori. We also described a hybrid lease cache algorithm that uses future information when available and uniform lease assignments when necessary; this hybrid cache can provide the same cache miss ratio while using a smaller cache size than a caching algorithm that utilizes no future information at all. Finally, we described the optimal cache allocation algorithm which can divide a cache optimally among groups of data elements.

Part 2—Verification and Metrics, OSL and SEAL

Beating OPT with Statistical Clairvoyance and Variable Size Caching

Caching techniques are widely used in today's computing infrastructure from virtual memory management to server cache and memory cache. Part 2 of the Application builds on two observations. First, the space utilization in cache can be improved by varying the cache size based on the dynamic application demand Second, it is easier to predict application behavior statistically than precisely. Part 2 describes a new, variable-size cache that makes optimal use of statistical knowledge of program behavior. Performance is measured using data access traces from real-world workloads, including Memcached traces from Facebook, and storage traces from Microsoft Research. In an offline setting, the new cache is demonstrated to outperform even OPT, the optimal fixed-size cache which makes use of precise knowledge of program behavior.

2_1 Introduction—On modern computer systems, memory has become often the largest factor in cost, power and energy consumption. Significant amounts of memory are used as software managed caches for data on persistent storage or data stored on remote systems. Examples include caching done by operating system kernel file system code [2_27], memory caches such as Memcached [2_18], and caching performed by network file servers [2_27]. Cache management has been extensively studied, leading to many effective techniques.

For fixed size caches, the optimal solution is known as Belady, MIN [2_5], B₀ [2_11], or OPT [2_26]. It has set the goal for decades of improvements in research and practice, including a number of recent techniques closely modeling or mimicking OPT [2_24, 2_42, 2_9]. While the past work tries to achieve OPT, this Application improves beyond OPT in two ways.

First, OPT [2_5] is optimal only for fixed-size caches. The working set of an application is not a constant size and may benefit from a temporary increase of cache space. It has long been a principle of virtual memory management that when memory is shared among multiple applications, a variable-size allocation is more effective than a constant-size partition. Part 2 describes how much variable-size cache can outperform OPT while using the same amount of cache on average.

Second, OPT requires precise knowledge of future data reuse [2_5]. It is usually impossible to precisely predict when a data item will be reused in the future. However, it is often possible to have a probabilistic prediction on when a data item will be accessed again. Let data item a be reused 4 times in axxaaaxxa. OPT requires knowing the next reuse each time a is accessed [2_5]. A probabilistic prediction states that the reuse time is 1 for half of the a accesses and 3 for the other half. Part 2 studies the optimal caching performance that can be achieved when using statistical, rather than precise, knowledge of future accesses.

This Application includes three advances. First, the Application describes an Optimal Steady-state Lease (OSL) algorithm, a variable-size caching algorithm which utilizes statistical information about future program behavior. We show that OSL is optimal for any algorithm that has only statistical information about future memory access and provides a reachable bound on such algorithms We also show that OSL has asymptotically lower complexity than OPT in both time and space. Second, the Application describes a space-efficient implementation of OSL named Space Efficient Approximate Lease (SEAL) and evaluates its space and time complexity. Finally, the Application evaluates the proposed implementation of OSL against existing caching solutions on data access traces from real-world workloads. These workloads include Memcached traces from Facebook [2_2] and traces of network file system traffic from Microsoft Research [2_29].

The new techniques are described in Section 2_2.2, including the lease definition in Section 2_2.2.1, the OSL algorithm and its properties in Section 2_2.2.2, and efficient lease-cache implementation in Section 2_2.2.3. Section 2_2.3 evaluates OSL using traces from real-world workloads, Section 2_2.4 describes related work, and Section 2_2.5 concludes.

2_2 Caching Using Probability Prediction

2_2.1 Managing Cache by Leases—In this Application, the cache is controlled by leases. This section describes the interface and performance of such a cache.

Lease Cache—At each access, the cache assigns a lease to the data block being accessed, and the data block is cached for the length of the lease and evicted immediately when the lease expires. We call this type of cache the lease cache. In this Application, the lease is measured by logical time, i.e. the number of data accesses. A lease of x means to keep the data block in cache for the next x accesses.

Miss Ratio—Given a data access trace, the forward reuse time is defined for each access as the number of accesses between this current access and the next access to the same data block [2_7]. In this Application, we called it reuse time in short. If the access is the last to a data block, the reuse time is infinite.

At each access, the next reuse is a cache hit if the lease extends to the next access. Otherwise, it is a miss. The cache hit ratio is the portion of the accesses whose lease is no shorter than its reuse time.

Average Cache Size—The cache does not have a constant size. Instead, we compute the average cache size, which is the average number of data blocks in the cache at each access. Following the past work, e.g. [2_14], we consider cache usage as a time-space product. A lease x means allocating one cache block for x accesses. The sum of all leases is the total time-space consumption, and the average cache size is computed by time-space divided by time, i.e. the total lease divided by the number of accesses. The average cache size is the average number of leases active at each access.

To compute the total lease, we must include the effect of lease fitting, which happens at every cache hit: when a data block in the cache is accessed, the remaining lease is canceled and replaced by the lease of the current access.

### Example

Consider an example infinite-long trace abc abc . . . . The reuse time is 3 at all accesses. If we assign the unit lease at each access, the miss ratio is 100%, and the cache size is 1. If we increase each lease to 3, the miss ratio drops to 0%, and the cache size is 3. If we increase each lease to 4, the cache size is still 3, not 4, due to lease fitting.

Prescriptive vs Reactive Caching—With leases, cache management is prescriptive. The eviction time of a data block is prescribed each time it is accessed. If a data block is accessed during the lease, its lease is renewed. In contrast, traditional cache management is reactive. In LRU cache, the data block is evicted by another data block. Prescriptive caching manages space by allocation, while reactive caching by replacement.

Locality in computing is characterized by Denning as computing in a series of phases where each accesses a different set of data [2_15]. Each data is accessed often only in its phases, separated by long periods of no access. If we collect statistics, we will see most data reuses with short reuses and a few long reuses. Prescriptive caching makes use of such statistics and keeps data in cache in phases where it is accessed but not in cache in-between these phases.

Lifetime vs Per Access Lease—Cache leases were initially used in distributed file caching [2_19], later in most Web caches, e.g. Memcached [2_18], and recently in TLB [2_3]. Such leases specify the lifetime of data in cache to reduce the cost of maintaining consistency. Their purpose and implementation are different from the problems solved in our Application, where a lease is assigned for each access and used to implement prescriptive and variable size caching.

Next, we show how to optimize prescriptive caching based on statistical predictions (next section), with asymptotically lower time and space cost than optimal reactive caching (Section 2_2.2.5).

2_2.2 Lease Optimization by OSL—This section describes the optimal assignment algorithm: given the reuse times of a data block, it assigns an optimal per-block lease, i.e. the best lease used every time the data block is accessed. We call it the Optimal Steady-state Lease (OSL). The section describes the steady-state condition, the algorithm, and then its optimality.

2_2.2.1 Steady State—In a steady state, a program accesses m data blocks. Each data block i is accessed with a probability distribution Pᵢ(rt=x), where rt=x denotes that the reuse time is x such that x≥0. In the steady state, Pᵢ(rt=x) does not change. In the following description, we take the list of memory accesses of a complete program that is in a steady state. Each data block i is accessed fᵢ times, and the probability Pᵢ(rt=x) is the ratio of fᵢ to its total number of accesses.

2_2.2.2 Intuition and Illustration—A key metric OSL uses is profit per unit of cost(PPUC). In PPUC, the profit is a number of hits, and the cost is the amount of cache occupied over a time. Hence, PPUC is measured in the number of hits per unit of lease. If we simplify, assume initial lease 0, and do not consider lease fitting, the PPUC of assigning lease y to data i is computed as

$$\frac{{f}_{i} {P}_{i} ( rt \leq y )}{{f}_{i} y} = {P}_{i} ( rt \leq y ) / y ,$$

where fᵢ is the access frequency of data i, and Pᵢ is the reuse probability. The cost with lease fitting is computed in cost in Algorithm 2. OSL assigns leases iteratively and may increase the lease from y to y′. Then the PPUC of y′ is based on the change from y to y′, not just y′. This is computed by get PPUC in Algorithm 2, which would compute the PPUC of y by computing the change from 0 to y.

The example has two data blocks A and B. A has four reuse times, and B has three. OSL assigns leases iteratively: first 5 to all A accesses, then an increase to 19 for A, and finally 12 for B. At each step, OSL first selects the reuse time of data block b that has the greatest PPUC, boxed in blue, and then re-computes the affected PPUCs.

OSL is an iterative, greedy algorithm. OSL first initializes all leases for all blocks to zero. In each step, OSL computes the PPUC of all reuse times of all data blocks using the existing leases that it has previously assigned and chooses the reuse time and data block that has the highest PPUC. OSL assigns this reuse time as the lease for all accesses of this data block. OSL repeats this computation until either the assigned leases reach the target average cache size or all data blocks have their longest reuse time as their assigned lease.

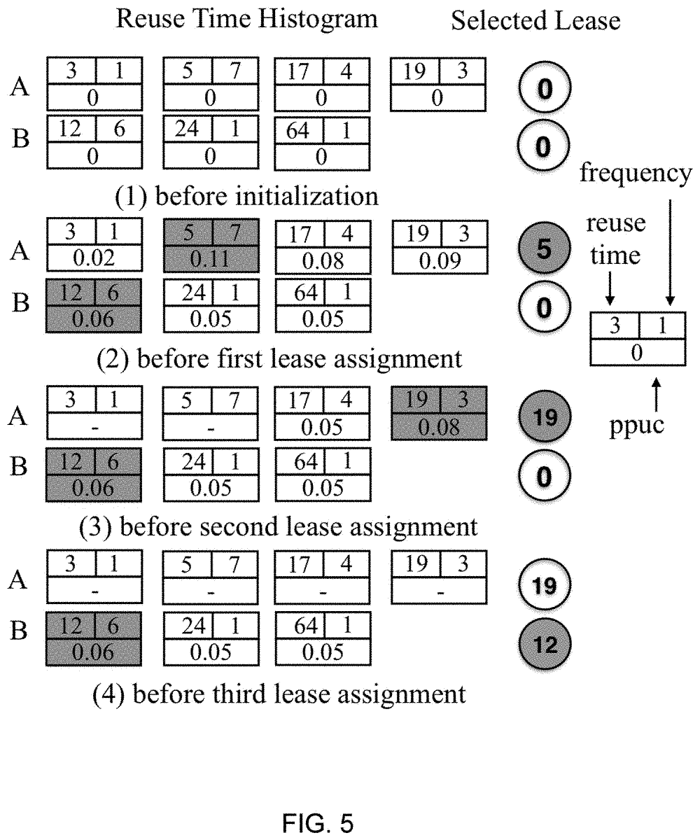

FIG. 5 is a reuse time histogram which illustrates OSL. FIG. 5 shows the reuse time histogram of two data blocks, A and B. Each reuse time is paired with the number of accesses that have this reuse time; this can be represented as a pair of integers in which the first integer is the reuse time and the second integer is the number of data accesses with that reuse time. For example, A's histogram has 4 pairs, (3,1), (5,7), (17,4), and (19,3), for a total of 4 reuse times and 15 accesses. B's histogram has 3 pairs: (12,6), (24,1), and (64,1).

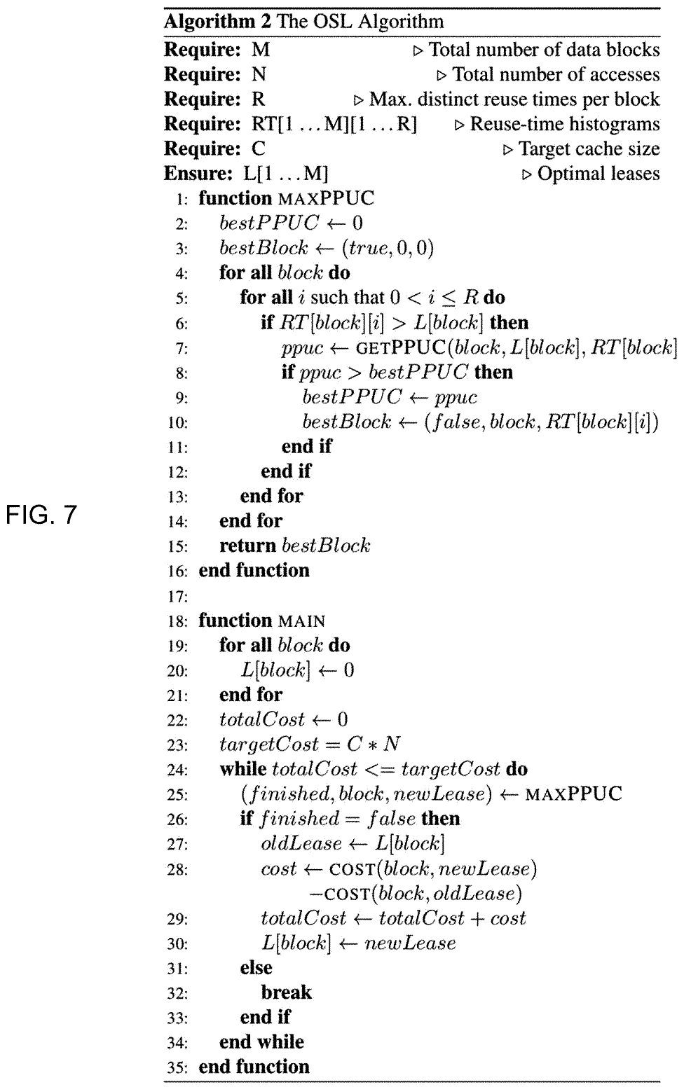

FIG. 6 shows an exemplary PPUC process algorithm. FIG. 7 shows an exemplary OSL process algorithm.

OSL first initializes the leases of all data blocks to 0. OSL then computes the PPUC for all reuse times of A and B. Take, for example, the reuse time 5 of A. If the lease for all 15 accesses of A is 5, we have 8 hits. The total lease is roughly 5×15, but actually 73 (considering lease fitting, the actual total lease is 3×1+5×(7+4+3)=73). The PPUC is the ratio of these two numbers, 8/73=0.11. Similarly, OSL computes the PPUC of all reuse times for all data blocks; they are shown in FIG. 5.

Initially, the lease of A and B is 0. In the first step, OSL selects the greatest PPUC, which is 0.11 at reuse time 5 of block A. OSL assigns the lease 5 to all 15 accesses of A. Following the lease assignment, OSL updates the PPUCs for reuse times of A that are greater than 5. The updated values in FIG. 5 (2) show PPUCs when the lease is increased from 5.

In the second step, OSL repeats the greedy selection and (re-)assigns the lease 19 to all 15 accesses of A. There is no further update because A has no greater reuse time than 19. In the third step, OSL assigns the lease 12 to all 8 accesses of B.

2.2.3 Lease Assignment—Algorithm 1, FIG. 6, shows an exemplary algorithm for computing PPUC, and algorithm 2, FIG. 7, shows an exemplary OSL algorithm. The inputs to OSL are M, the total number of data blocks; N, the total number of accesses; RT, the reuse-time histograms of all data blocks; and C, the target cache size. OSL computes the optimal leases for all data blocks that achieve target average cache size C.

The main loop at line 2 keeps calling maxPPUC to assign leases until one of two conditions is met. The first condition is when the cache size reaches the target cost, i.e. total space-time computed by the target cache size times the trace length N. The second condition is when maxPPUC returns true as the first element of the tuple it returns, indicating that there are no more leases to assign, and the cache is already at the maximum possible size (with only cold-start misses).

maxPPUC computes the PPUC for each reuse time of each data block given the leases assigned in the last iteration of the loop at line 2. For each block, the old lease is stored in L (initialized to 0 at line 2). Each greater reuse time is a candidate lease. The optimal lease must be equal to one of the reuse times. If an optimal lease were larger than one of the reuse times, we could reduce it to the closest reuse time and not incur more misses. To select the best lease, maxPPUC calls getPPUC at line 2 in Algorithm 2, which calculates the PPUC as the increase in hits divided by the increase in cost (in cache space), where the hits and cost are calculated by functions hits and cost, respectively. The nested loop in maxPPUC selects the candidate lease and candidate block with the highest PPUC in line 2 of Algorithm 3. maxPPUC returns a tuple of the candidate lease and candidate block to main which assigns the lease to the candidate block in line 2.

The nested loop in maxPPUC computes PPUC after each lease assignment. This is needed because the same data block may be assigned multiple times with increasingly longer leases. Each assignment necessitates recomputing the PPUCs because they are based on the old lease, which has just been changed. In the example in FIG. 6, we can see that the PPUC of two reuse times, 17 and 19, is changed after the first lease assignment.

maxPPUC can be made faster. For each block, the PPUC is changed only if its lease is changed. Instead of a nested loop, only the block that was just assigned a new lease requires updating. In an actual implementation, we store all lease candidates in a heap, update the PPUC for only those affected candidates after each assignment, and select the best candidate for the next assignment by a heap pop. Let M be the number of data blocks, and R the maximal number of distinct reuse times per data block. The nested loop takes O(RM) per step, but a heap-based implementation takes only O(R) per step.

2_2.2.4 Optimality—By choosing the maximal PPUC, OSL attempts to maximize the profit at each step. A problem, however, is that OSL recomputes PPUCs after each assignment, so it may be questioned whether a greater PPUC may appear later. The following theorem rules out such possibility.

Theorem 1 (Monotone PPUC) In Algorithm 3, let x be the PPUC selected at any step and x′ be the PPUC selected at the next step, then x≥x′.

Proof. We first consider the case involving two data blocks. Let OSL find the largest PPUC x at data block b in the current step and the largest PPUC x′ at a different data block b′ in the next step. After the current step, only the PPUCs of b are updated, and the PPUCs of b′ stay the same. It is obvious x≥x′; otherwise, OSL would have selected x′ instead of x in the current step.

We next consider when OSL finds the largest PPUCs at the same data block d in both steps. Let the reuse times of b in ascending order be rt₁, rt₂, . . . , rtₖ. Assume that OSL selects the largest PPUC x at reuse time rtⱼ=y in the current step. Then OSL recomputes the PPUC for reuse times rtⱼ₊₁, rtⱼ₊₂, . . . , rtₖ. After this update, OSL selects the largest PPUC x′ at reuse time rt_{j′}, =y′ in the next step. We prove x>x′ by contradiction. Note that the inequality to be established is actually strict, not just x≥x′, but x>x′.

Assume the opposite, i.e. x′≥x. Let x′_{old} be the PPUC at reuse time y′ before the update (x′ is the PPUC after the update). Because the assignment chooses reuse time y over y′, we have x>x′_{old}. Combining the two inequalities yields x′≥x>x′_{old}. By substituting the formula for computing PPUC, we have

$$\frac{P ( rt \leq y ′ ) - P ( rt \leq y )}{y ′ - y} \geq \frac{P ( r t \leq y )}{y} > \frac{P ( rt \leq y ′ )}{y ′} \qquad ( 1 )$$

We now show that the first inequality contradicts with the second inequality. Rewriting the first inequality, we have

$$\frac{P ( r t \leq y )}{y} \frac{( \frac{P ( rt \leq y ′ )}{P ( rt \leq y )} - 1 )}{( \frac{y ′}{y} 1 )} \geq \frac{P ( r t \leq y )}{y}$$

### Because

$$\frac{P ( r t \leq y )}{y} > 0 ,$$

we can remove it from both sides. By re-arranging the terms, we have

$$\frac{P ( r t \leq y )}{y} \leq \frac{P ( r t \leq y ′ )}{y ′} ,$$

which is the opposite of the second inequality. The two inequalities contradict; therefore, the assumption x′≥x is wrong, and x>x′.

The preceding derivation assumes that y and y′ are the first two lease assignments of data block d. In the general case, a previous lease y″ has been assigned before y. This implies two changes to the PPUC calculation: removing P(rt≤y″) from the numerator and y″ from the denominator. Because the changes happen on every fraction in Eq. 1, the same proof applies. Still, the cost of the lease did not consider lease fitting. Instead of y and y′ in the denominators, they should be a cost function c(y) and c(y′). The derivation considers only that c(y′)>c(y)>0, which is the case with lease fitting. Therefore, the same proof applies, and the two inequalities still contradict each other after generalizing the lease assignment and cost.

Combining the (generalized) second case and the first case, we have that x≥x′ always, that is, the PPUC selected by OSL is monotone.

The PPUC monotonicity means that OSL maximizes its profit at each step. Informally speaking, OSL assigns leases in decreasing importance. This suggests convexity in OSL performance. As the cache size increases, the performance increases less from the same amount of additional cache space.

Next we show that OSL makes optimal use of the per-data-block reuse time distribution. Because OSL may not exactly “match” a target cache size, i.e. total allocated leases occupies the entire target cache, the following corollary considers only cache sizes that are produced by OSL.

Corollary 1 (Statistical Optimality) No algorithm which determines the lease for a particular access using only the per-data-block reuse time histogram can have a lower miss ratio than OSL.

Proof. Because the lease for an access is determined solely from the data block being accessed and the per-data-block reuse time histogram, the algorithm must assign the same lease to all accesses of any particular data item (assuming the algorithm is deterministic).

Let m be the number of distinct data blocks in a trace. Let L[1 . . . m] be the leases that OSL assigns to each data block, and let L′[1 . . . m] be an arbitrary assignment of leases to data blocks that achieves the same average cache size as L. If there is some i such that L[i]<L′[i], there must also be a j such that L[j]>L′[j], otherwise L and L′ couldn't achieve the same average cache size. We know that

$$\frac{hits ( i , L ′ [ i ] ) - hits ( i , L [ i ] )}{cost ( i , L ′ [ i ] ) - cost ( i , L [ i ] )} < \frac{hits ( j , L [ j ] ) - hits ( j , L ′ [ j ] )}{cost ( j , L [ j ] ) - cost ( j , L ′ [ j ] )} ,$$

otherwise OSL would have assigned lease L′[i] to data block i in lieu of assigning lease L[j] to data block j. However, because L and L′ achieve the same target cache size, we also know that cost(i,L′[i])−cost(i,L[i])=cost(j,L[j])−cost(j,L′[j]). Therefore hits(i,L′[i])−hits(i,L[i])<hits(j,L[j])−hits(j,L′[j]) This means that L′ must have fewer hits than L. Therefore L must achieve the best possible miss ratio of all possible lease assignments with the same average cache size.

2_2.2.5 Complexity—The algorithm complexity is as follows. Let the total number of blocks be M, and the maximal number of distinct reuse times per data block be R. The number of lease candidates is at most MR. At each assignment in OSL, at most R candidates are updated. Assuming a binomial heap is used, the maximization time is O(log(MR))=O(log M+log R). The total cost per lease assignment is O(log M+log R+R)=O(log M+R). The number of assignments is at most MR (for the largest cache size). Overall, OSL takes O(MR (log M+R)) in time. The space cost is O(MR).

If we approximate and use a histogram with logarithmic size bins, R=O(log N), where N is the trace length, and N−1 the longest possible reuse time. The time cost is O(M log N(log M+log N)). Because M<N, it equals to O(M log N(log N+log N))=O(M log²N). The space cost is O(M log N).

Optimization Complexity: OSL vs OPT—OPT uses precise knowledge, meaning the reuse time for each access, so its space cost is O(N). OPT can be implemented by stack simulation, requiring O(M) space and O(M) operations at each access to maintain a constant cache size [2_26]. The time cost is therefore O(MN) In comparison, by using statistical clairvoyance, OSL reduces the space cost from O(N) to O(M log N). By targeting an average cache size, instead of maintaining a constant cache size, OSL reduces the optimization cost from O(MN) to O(M log²N).

2_2.2.6 Generalization—OSL assigns an optimal lease for a group of accesses. In the description so far, accesses are grouped by data identity, i.e. all accesses to same data block. OSL can be used in any type of grouping. It may group by program code, i.e. accesses by the same load/store instruction, the same function, or the same data structure.

In general, OSL divides all data accesses into a set of groups, feeds their reuse-time statistics and other parameters such as cache size to Algorithm 3, and computes the optimal lease for each group. This lease is then the lease for every access of that group. The optimality and complexity results are unchanged—OSL provides optimal caching at the time cost of O(G log²N) and space cost of O(G log N), where G is the number of groups. This number of groups may be reduced by coarse grouping, i.e. putting a class of data blocks into one group or all load/store instructions of a function into one group.

OSL optimization, however efficient, still has to assign a lease at each access, and the lease can be arbitrarily long. Next we consider efficient implementation of leases.

2_2.3 Lease Implementation by SEAL—Lease cache can be implemented using an approach called expiration circular bins. We maintain an array of bins. A bin is created for each lease. Thus, the number of bins is proportional to the maximal lease. Each bin contains a doubly-linked list with the same lease and is indexed by the lease. All bins are sorted in the ascending order of lease. At every time point, we delete all nodes in the list of the oldest bin i.e., evicting all expired data items. The oldest bin is then reused as the newest bin that has maximal lease relative to the present time point. Therefore, the array of bins is in fact a circular array. The insertion operation takes O(1) time. However, this approach uses O(M+L) space, where M is the number of unique items and L the maximal lease. While M is small, L may be very large and possibly up to the full trace length.

This section describes the Space Efficient Approximate Lease cache algorithm (SEAL). SEAL achieves O(1) amortized insertion time and uses

$$O ( M + \frac{1}{α} log L )$$

space while ensuring that data stay in cache for no shorter than their lease and no longer than one plus some factor α times their lease.

2_2.3.1 Design—SEAL creates “buckets” into which it places cached objects. Buckets are “dumped” into the next bucket at some interval, called the “dumping interval.” This interval is fixed for each bucket. When an object is dumped out of the last (smallest) bucket, it is evicted.

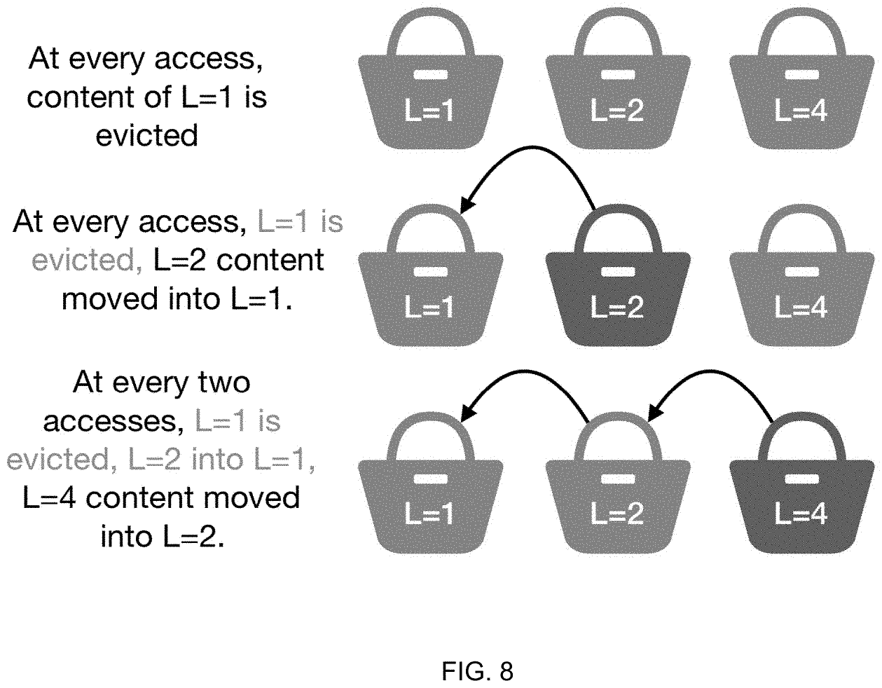

FIG. 8 is a drawing which illustrates a basic SEAL design. FIG. 8 shows three buckets that store leases of increasing lengths. The first is for unit leases, the second for length-two leases, and the third for leases from 3 to 4. The first buckets is emptied at every access because all leases expire. The second is dumped to the first, because they become unit leases. The third is dumped to the second at every two accesses.

When an object is accessed, its lease is renewed and recorded by SEAL. SEAL assigns the lease to the bucket whose contents have the smallest time to eviction which is still at least the object's lease. Buckets are indexed in ascending order of time to eviction, starting from zero.

The dumping interval of any particular bucket is a power of two. The amount of buckets with dumping interval 2^{k} for k∈ [symbol] depends on the accuracy parameter, α, but does not depend on k. We call the number of buckets at each dumping interval N, to which we assign the value

$$\frac{2}{α} .$$

SEAL uses N buckets for each dumping interval. These buckets are organized as a linear sequence with increasing interval lengths. At each access, SEAL assigns a bucket for the accessed data. The following function B determines the bucket by determining the exponent s of the dumping interval, the offset o among buckets of the dumping interval, and the adjustment $ (when the access happens in the middle of a dumping interval):

$$s = ⌈ {log}_{2} ( \frac{l}{N} + 1 ) ⌉ - 1$$

$$o = ⌈ \frac{l - N ( {2}^{s} - 1 )}{{2}^{s}} ⌉ - 1$$

$$β = ( \begin{matrix}0 & if l \leq N ( {2}^{s} - 1 ) + ( o + 1 ) {2}^{s} - ( i mod {2}^{s} ) \\ 1 & otherwise\end{matrix}$$

B(l,i,N)=Ns+o+β, where the parameters l and i are respectively the lease time and access number (i.e. the “clock time,” or index in the trace) and N is the number of buckets of each dumping interval.

2_2.3.2 Time and Space Complexity—Theorem 2 The function B assigns objects to the bucket whose contents will be evicted soonest among those buckets whose contents will not be evicted before the object's lease expires.

Proof. We begin by assuming that all buckets are at the beginning of their dumping interval. Under this assumption, we prove that the exponent s of the dumping interval and the index o of the bucket are computed correctly.

Trivially, the time to eviction of the contents of largest bucket of dumping interval 2^{k} when it is at the beginning of its interval (the access after the previous dump) is

Σⱼ₌₀^{k}N2^{j}=N(2^{k+1}−1).

Therefore, for a lease of time 1, s should be such that

N(2^{s}−1)<l≤N(2^{s+1}−1).

In other words, there is a bucket of dumping interval 2^{s} whose contents will be evicted at or after time l, but the contents of all buckets of dumping interval less than 2^{s} will be evicted before time l. It follows that

$${log}_{2} ( \frac{l}{N} + 1 ) - 1 \leq s < {log}_{2} ( \frac{l}{N} + 1 ) .$$

The unique integer which satisfies this inequality is

$$⌈ {log}_{2} ( \frac{l}{N} + 1 ) ⌉ - 1.$$

Once an object is dumped into a bucket of dumping interval 2^{s-1}, it will be evicted in exactly N(2^{s}−1) accesses (in the case where s=0, it is simply evicted, as no buckets of dumping interval 2⁻¹ exist. The argument is analogous). Therefore, for a lease time 1, o should be such that

N(2^{s}−1)+o2^{s}<l≤N(2^{s}−1)+(o+1)2^{s}.

In other words, an object with lease time l is placed into a bucket whose contents will be evicted at or after least time l, but the contents of all buckets farther down the chain will be evicted before time l. It follows that

$$\frac{l - N ( {2}^{s} - 1 )}{{2}^{s}} - 1 \leq o < \frac{l - N ( {2}^{s} - 1 )}{{2}^{s}} .$$

The unique integer which satisfies this inequality is

$$⌈ \frac{l - N ( {2}^{s} - 1 )}{{2}^{s}} ⌉ - 1 .$$

Previously, it was assumed that all buckets were at the beginning of an interval. In order to account for the time before the eviction of a bucket's contents decreasing as the bucket reaches the end of its interval, an object is placed into the subsequent bucket if necessary. This is computed by the adjustment β. The time to eviction of a bucket's contents is N(2^{s}−1)+(o+1)2^{s}−(i mod 2^{s}), where i is the access number. The i mod 2^{s} term is the time left until the end of the current interval, when the bucket's contents will be dumped. Therefore, an object is put into the subsequent bucket when its lease time is greater than this value, ensuring that it stays in cache for at least its lease time.

Theorem 3 The time an object stays in cache beyond its least time is at most al+1, where l is the object's lease time.

Proof. Let I be the lease time of an object and let be the amount of time it actually stays in cache.

$$α \geq \frac{2}{N} = \frac{\frac{2 l}{N}}{l} = \frac{2 ( \frac{l}{N} + 1 ) - 2}{l} = \frac{{2}^{{log}_{2} ( \frac{l}{N} + 1 ) + 1} - 2}{l} \geq \frac{{2}^{⌈ {log}_{2} ( \frac{l}{N} + 1 ) ⌉} - 2}{l} = \frac{{2}^{s + 1} - 2}{l}$$

By Theorem 2, an object is placed into the bucket which is evicted soonest among those buckets which will be evicted no sooner than the object's lease expires. Therefore the lease can be extended by at most one less than the dumping interval of the bucket into which the object is placed, which can be of dumping interval at most 2^{s+1}. This means that

$$\frac{{2}^{s + 1} - 2}{l} \geq \frac{{l}^{′} - l - 1}{l}$$

and therefore

al+1≥l′−l.

Theorem 4 Each access has O(1) amortized cost.

Proof. Each access consists of two parts: (1) an object is placed into its bucket and (2) buckets at the end of their interval are dumped. The first part takes constant time. The second part may need to dump up to log₂L buckets (L is the maximum lease time), however each dumping interval of bucket is dumped only half as often as the next smallest dumping interval. Therefore, the average amount of buckets that need dumping is at most

$${\sum }_{i = 0}^{∞} \frac{1}{{2}^{i}} = 2.$$

Theorem 5 The space consumption of the cache is O(M+N log L), where M is the capacity and L is the maximum lease time.

Proof. Space is needed only for the objects in cache (M) and for each bucket (N log L).

2_3 Evaluation, 2_3.1 Experimental Setup

3.1.1 Cache Policies—We compare ideal OSL with 3 practical policies, LRU, 2Q [2_25], ARC [2_28], and 2 ideal policies, OPT [2_26] and VMIN [2_33]. LRU always replaces the least recently used data blocks, so it captures data recency. However, it does not capture data frequency. LFU captures no data recency but data frequency, thus it may accumulate stale data blocks that have high frequency but are no longer used. Many latter cache policies try to improve upon variants of LRU and LFU. LRU-K [2_32] approximates LFU while eliminating its lack of consideration of data recency by keeping track of the times of the last K references to estimate inter-arrival times for references. However, its implementation requires logarithmic time complexity. 2Q behaves as LRU-2 but with constant time overhead; therefore, we compare OSL with 2Q. Another related solution is MQ, which divides data among multiple queues based on access frequency [2_47]. ARC uses an on-line learning rule to tune cache between data recency and frequency and, empirically, performs as well as a fixed replacement policy optimized off-line. A common strategy of 2Q and ARC is to give low priority to caching streaming or random data accesses. They are highly effective in practice. According to Waldspurger et al., “ARC has been deployed widely in production systems, and is considered by many to be the ‘gold standard’ for storage caching.” [2_42].

The optimal algorithm for variable-size cache is VMIN [2_33]. VMIN takes in a parameter x and the precise future reuse times for each access. All data accesses with a reuse time less than x will have their data cached until their reuse. Accesses with reuse times greater than x will not be cached. Optimal caching is achieved by not caching data longer than strictly needed.

3.1.2 Simulators—We implemented a lease generator (by the OSL algorithm in Section 2_2.2.3) with its leases managed by a lease-cache simulator (SEAL in Section 2_2.3) in RUST. RUST is a safe language that does not use garbage collection. The extensive static analysis eliminates important classes of error (including all memory errors) in the implementation. It has good performance as the code is compiled. The generator and simulator have roughly 500 and 3,000 lines of code, respectively. We refer to them collectively as OSL cache.

OSL is an ideal policy and runs a trace twice. In training, the lease generator reads in a trace and computes the optimal lease for each data block. In testing, the lease-cache simulator reads in the trace, applies the leases at each access, and reports a miss ratio. For the lease cache, we set a to 0.5, which means that a data block stays in cache for no shorter than their lease and no longer than 1.5 times their lease.

We implemented simulators for LRU, 2Q [2_25], and ARC [2_28]. There are different versions of 2Q [2_25] implementation; we implemented it as follows. A 2Q cache has two portions. The two portions are equal sized. One is a First-In-First-Out (FIFO) queue that stores the data blocks that have been accessed only once. The other is an LRU queue, i.e. an LRU cache. Newly accessed data will be placed in the FIFO queue, and evicts the stale data as the FIFO rule indicates. If a data block is accessed in the FIFO queue, it promotes to the LRU queue. We implemented ARC by strictly following the algorithm in the work [2_28]. We use the OPT cache simulator from Sugumar and Abraham [2_39].

3.1.3 Microsoft Storage Traces—We tested a collection of storage traces collected by Narayanan, Donnelly, and Rowstron [2_30]. These traces record disk block accesses performed by 13 in-production servers in Microsoft Research's data-center and have been used in recent studies [2_24, 2_42, 2_45]. Each server had one or more volumes of storage.

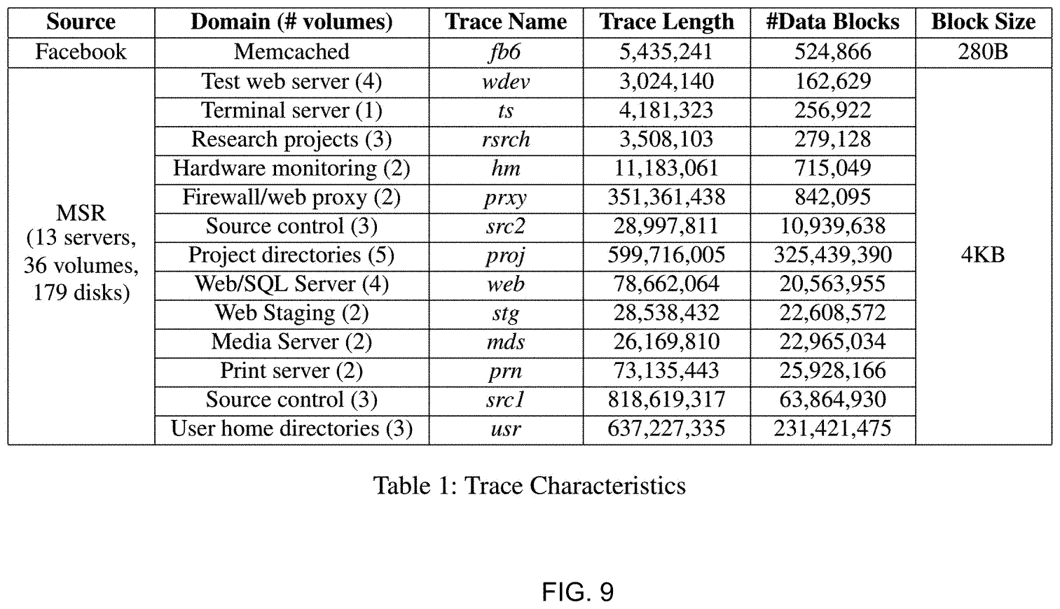

FIG. 9 shows a table 1 of trace characteristics. Table 1 provides information on the 13 traces.

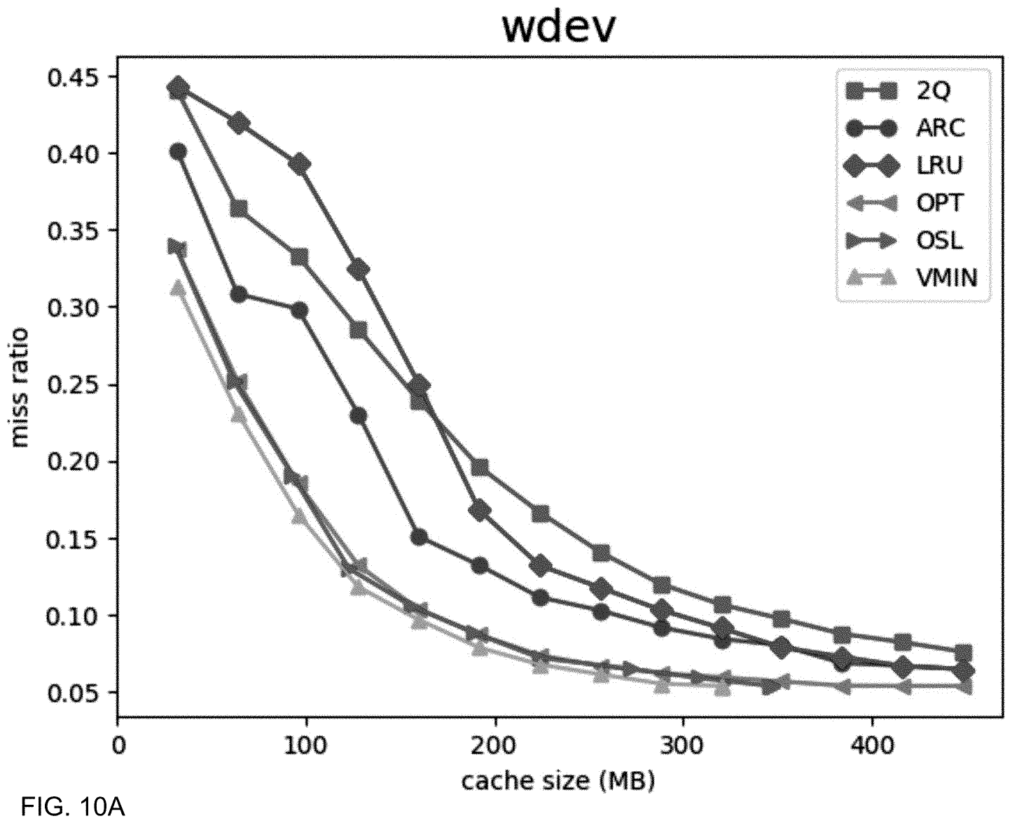

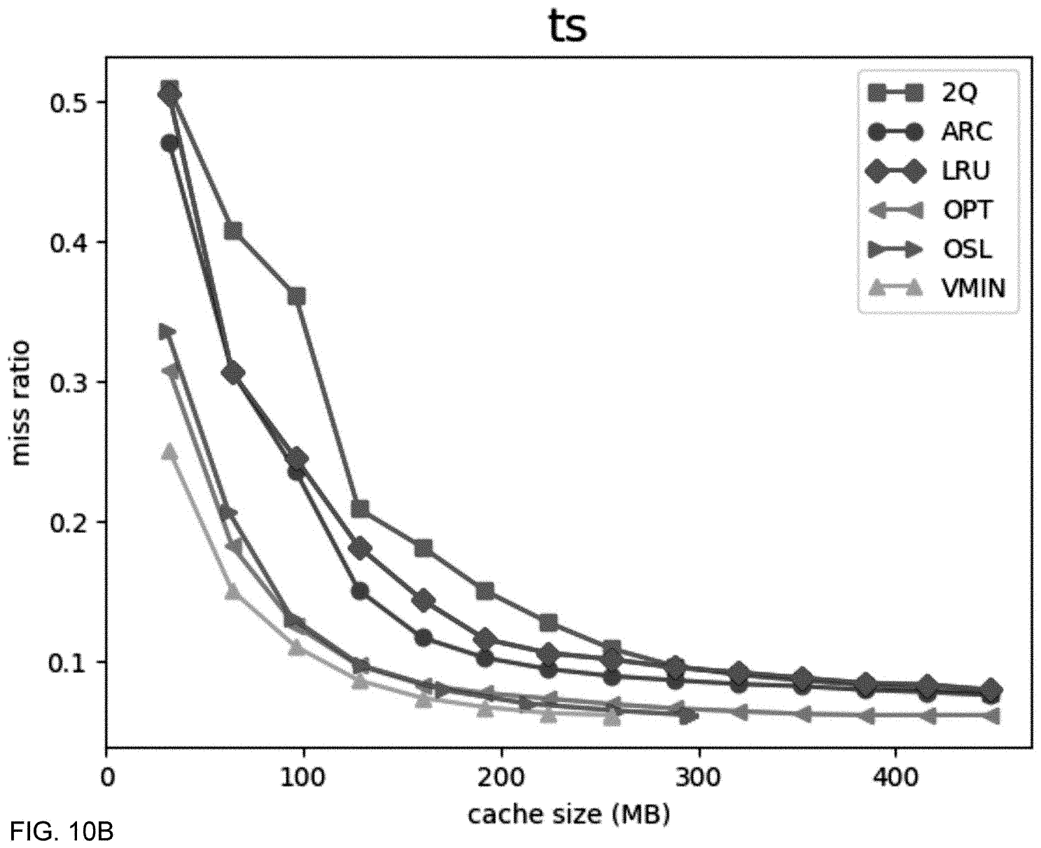

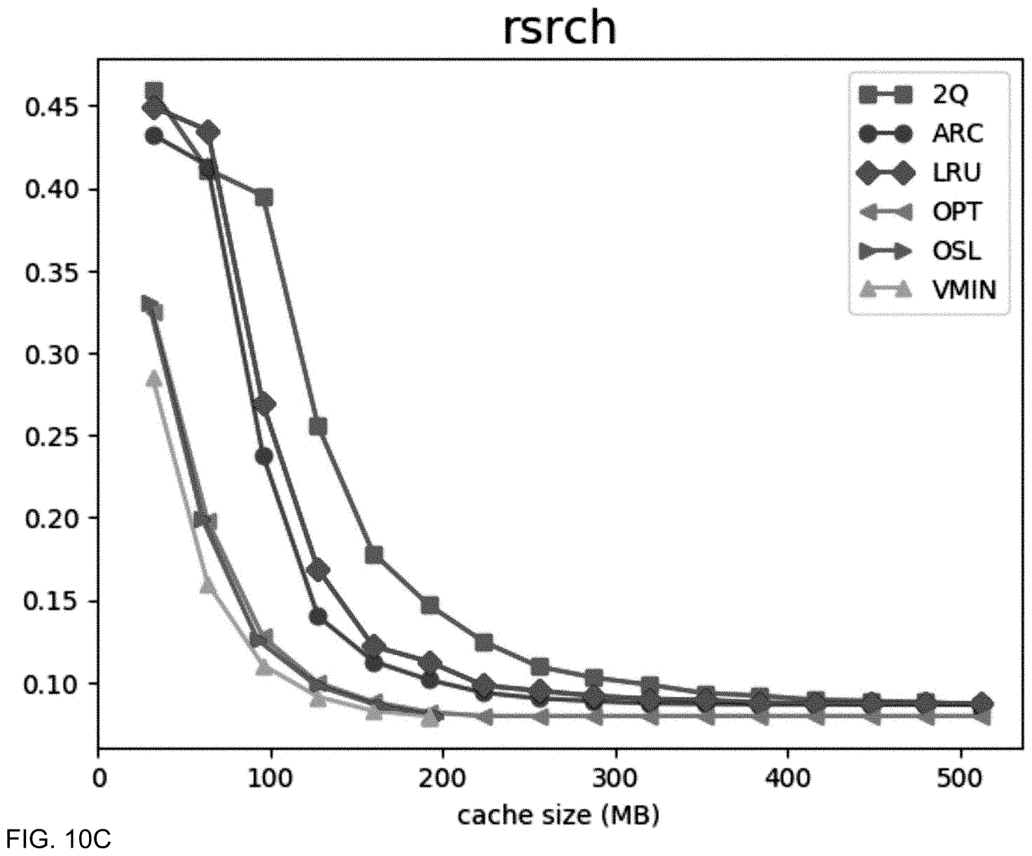

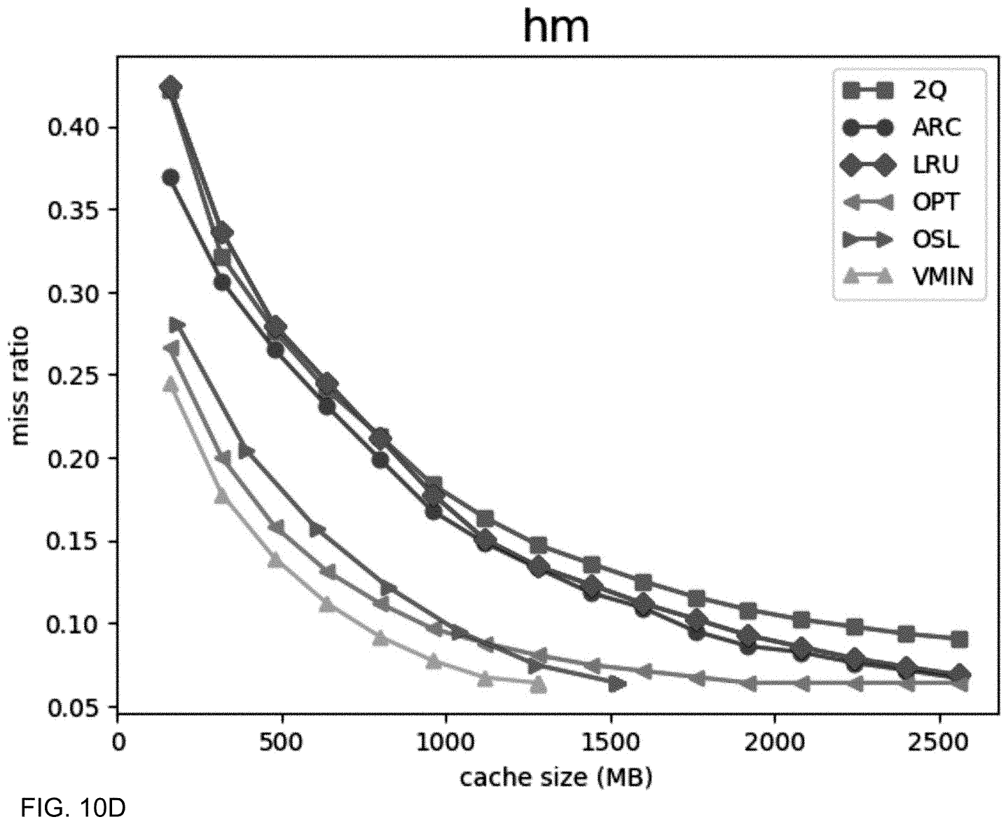

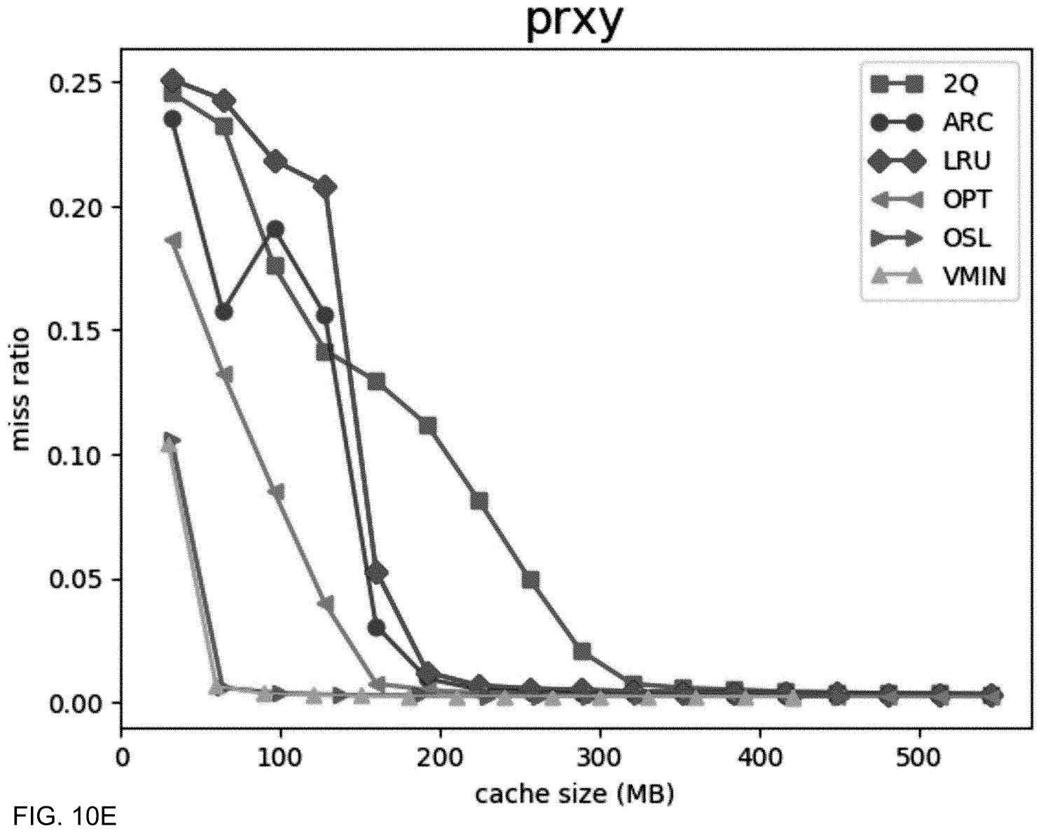

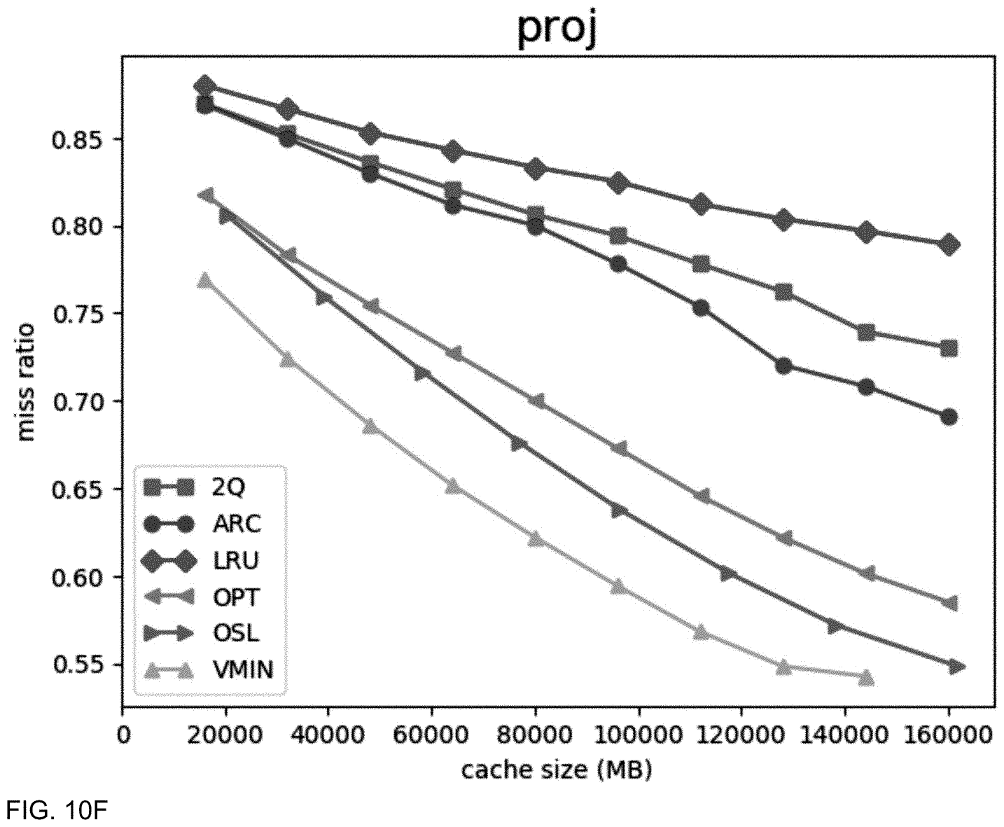

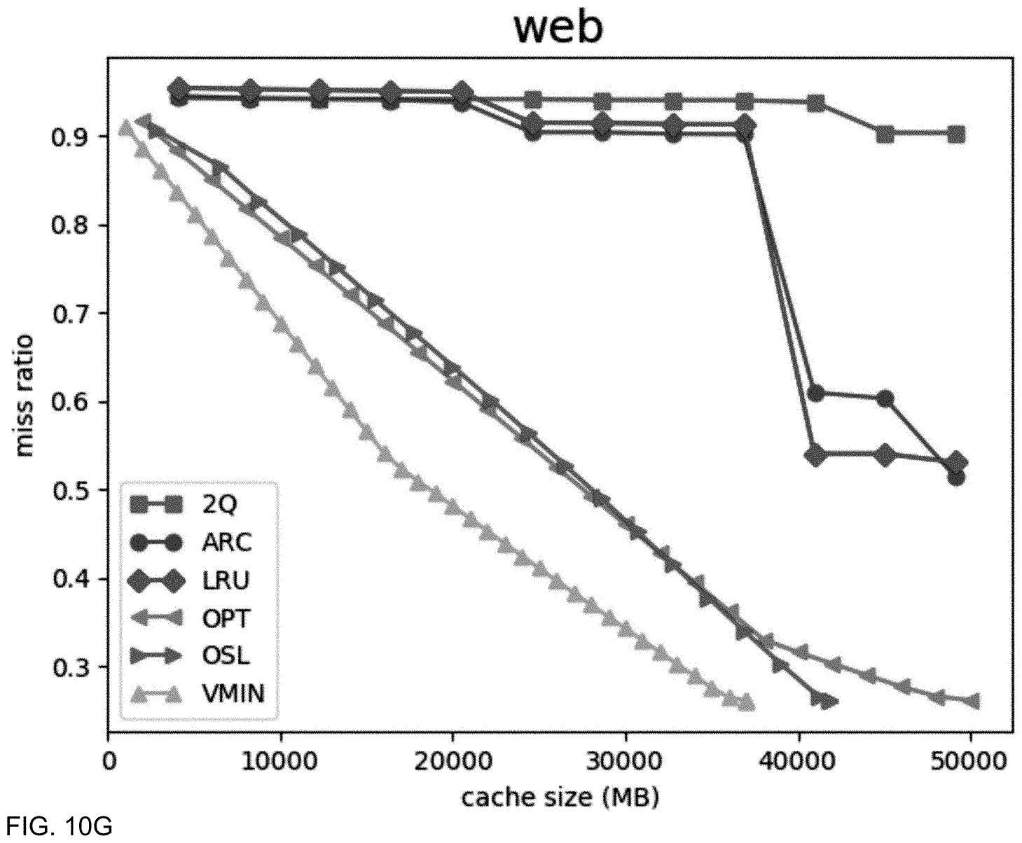

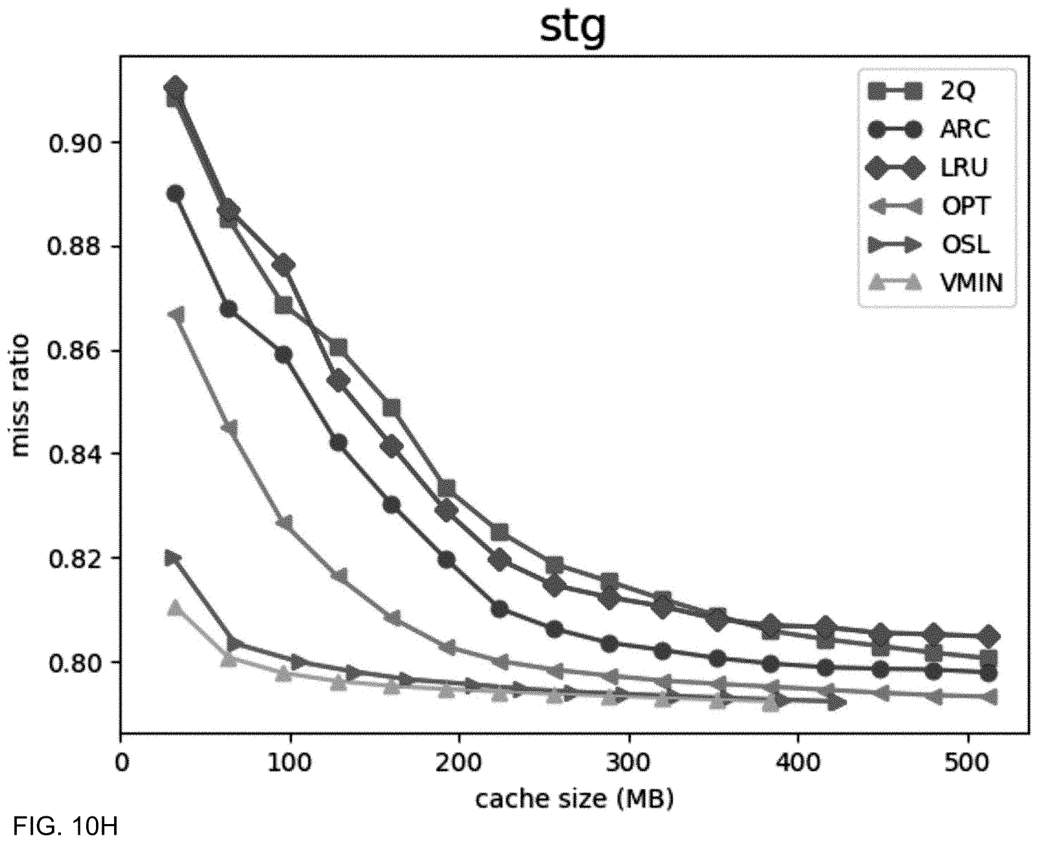

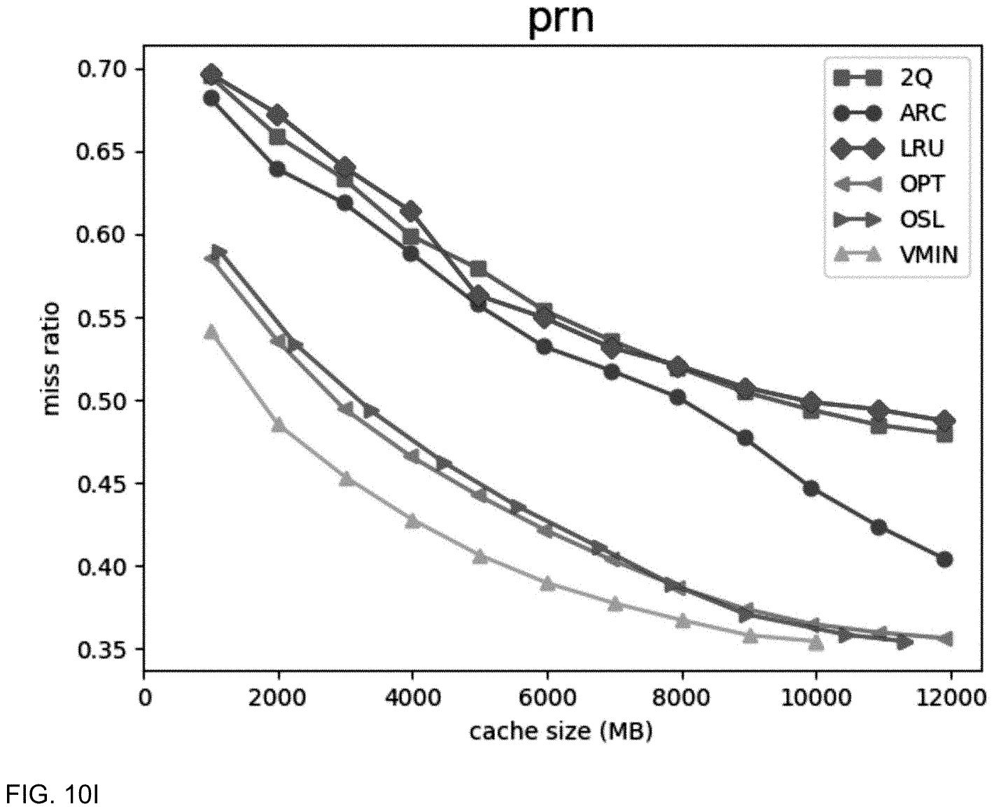

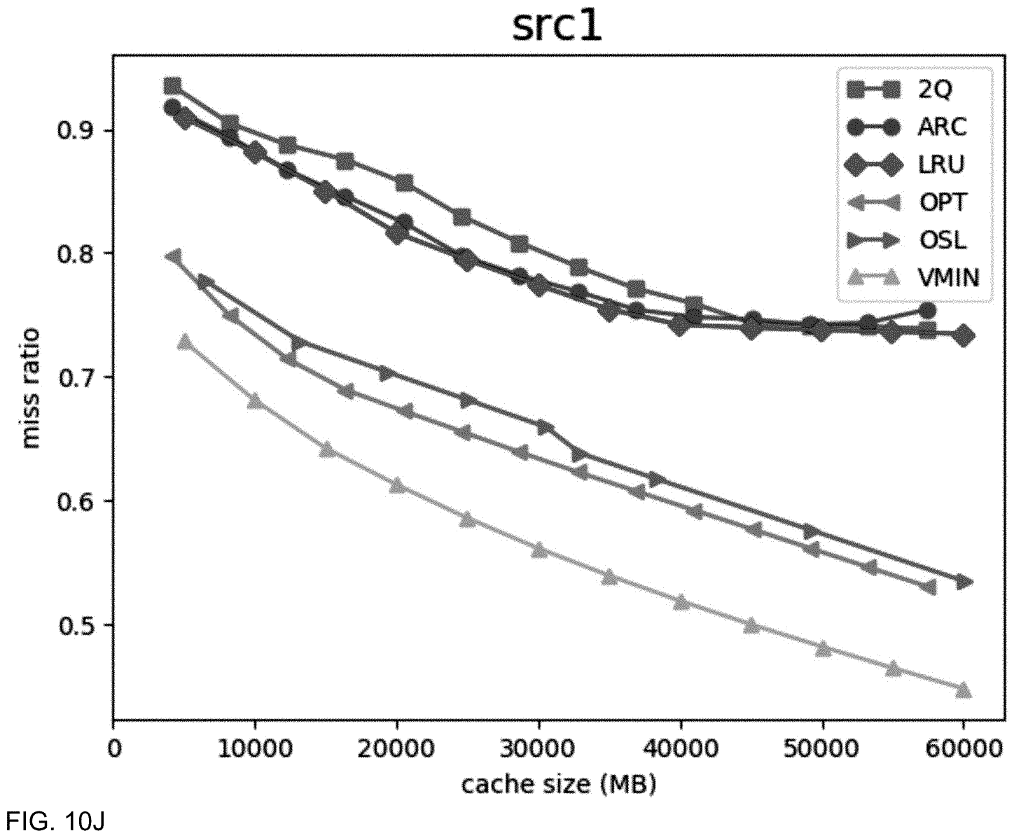

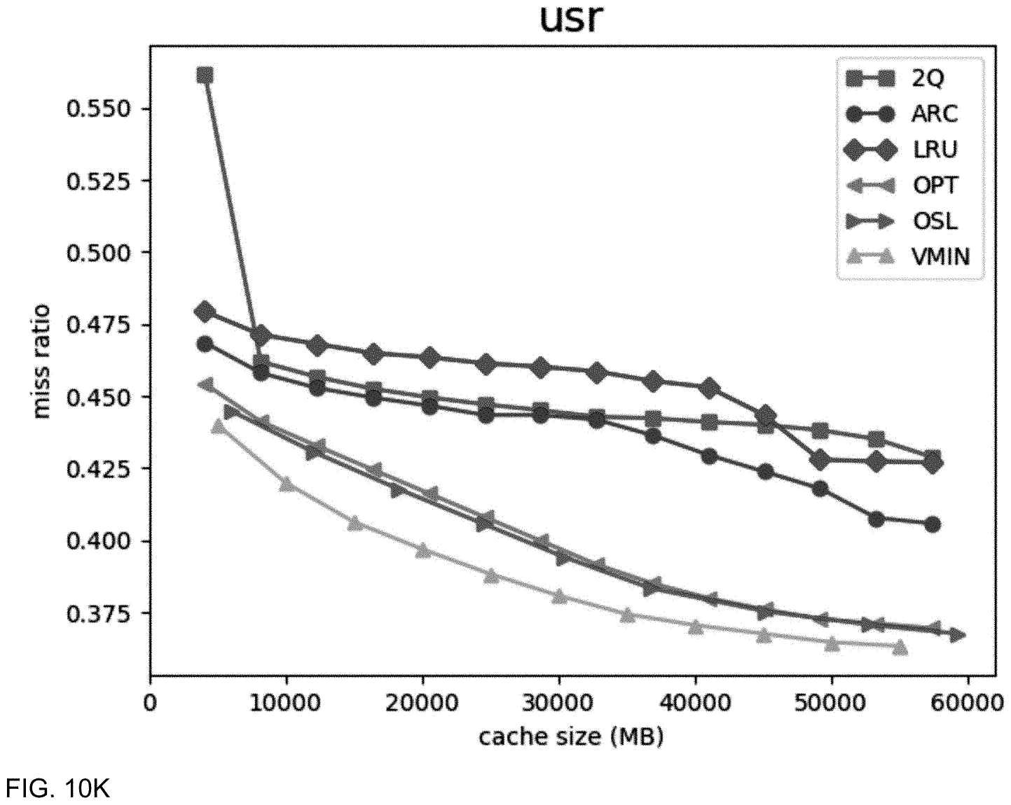

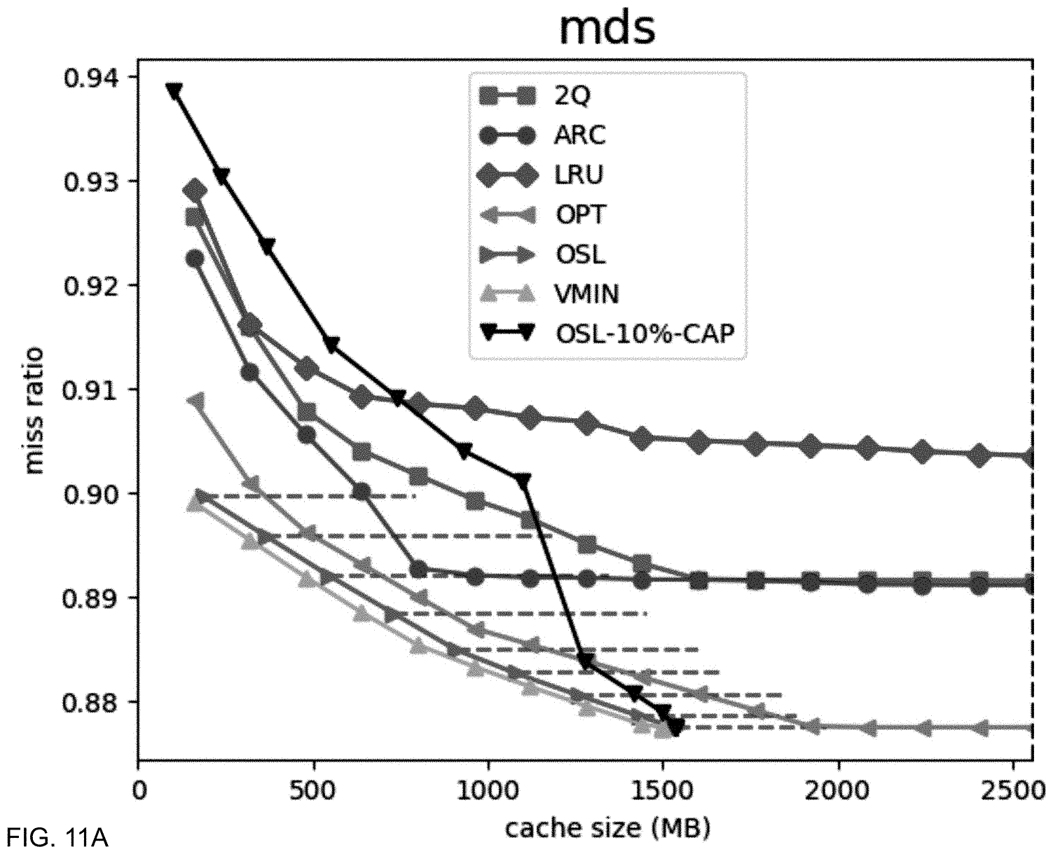

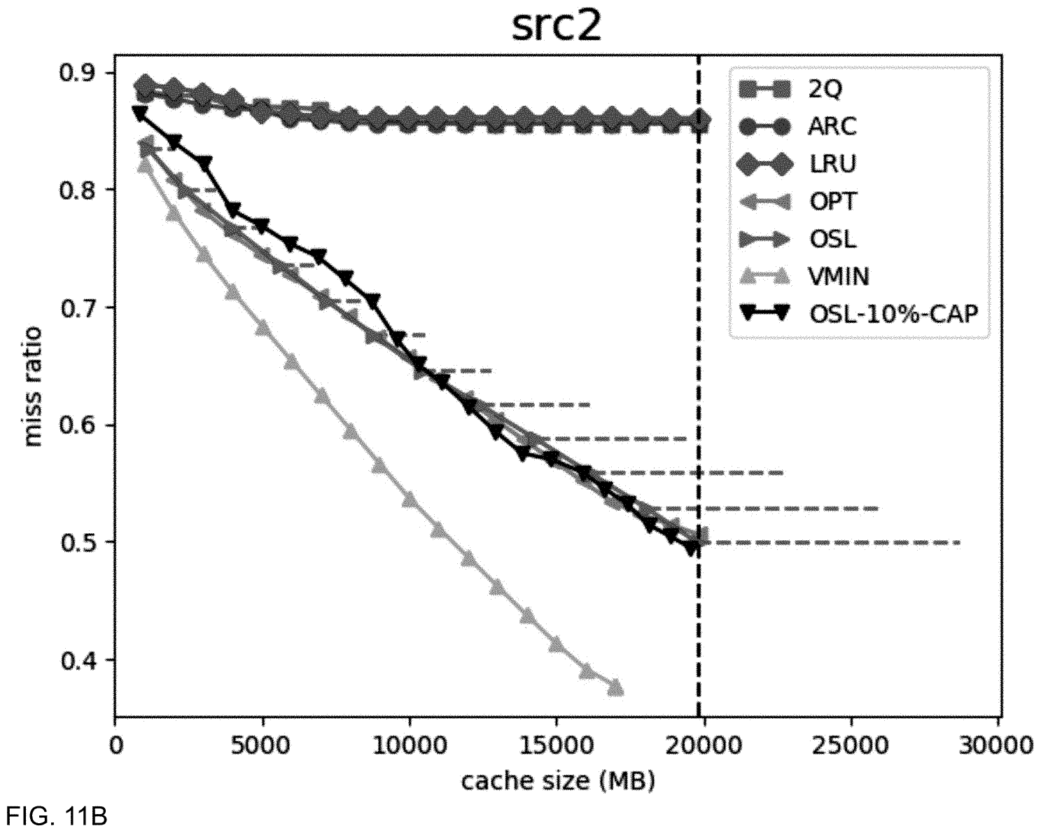

2_3.2 OSL Evaluation—The comparison for 13 MSR tests are divided between FIG. 10A to FIG. 10K, and FIG. 11A to FIG. 11B. Each graph shows 6 policies by miss ratios connected into curves. In the graphs, the miss ratio curves are separated into three groups. The practical algorithms, LRU, 2Q, and ARC, form the first group. A recent technique called SLIDE can reduce many of the miss ratios, which we discuss in Section 2_4. However, even with such improvements, there is a large gap between the practical group and the ideal policies.

Among the 3 ideal policies, there is a gap between OPT and VMIN in the graphs except the first four (with the smallest data sizes) and src1. Of the remaining 9 tests, OSL is similar to OPT in 6, similar to VMIN in 3, and between OPT and VMIN in proj.

OPT and VMIN use precise knowledge, whereas OSL uses statistical knowledge. For 7 traces, the average reuse per data block is over 12 (as high as 417 in prxy). At all accesses of the same block, OPT knows the exact time of the next access, which may differ from access to access. However, OSL knows only the distribution (which is the same at each access). It is interesting that OSL almost always performs the same as or better than OPT using the same (average) space. In particular, in 3 programs, prxy, stg, and mds, OSL clearly outperforms OPT. In 3 programs, wdev, rsrch, and usr, OSL is consistently a little better than OPT. In is and hm, OSL is worse than OPT in small cache sizes but becomes better than OPT when the cache size increases. In src2 and web, OSL starts the same as OPT, then becomes a bit worse, and finally becomes better. This is due to the main design differences between OSL and OPT. We next describe them one by one.

Support for Variable Working-set Sizes—OSL clearly outperforms OPT in 4 programs, prxy, proj, stg in FIG. 10A to FIG. 10K, and mds in FIG. 11A to FIG. 11B. To understand the reason, it is easiest to consider a program whose working-set size (WSS) varies significantly from phase to phase. We do not formally define the notions of working-set size and phase. They are used here in order to explain and contrast OSL and OPT. To simplify it further, consider a program with an equal mix of two types of phases, one has a large WSS L and the other a small WSS l. OSL alternatively uses L and l as the cache sizes. The average is a value in between. For OPT to fully cache this program, it needs the cache size of at least L, under utilizing the cache space in half of the phases. We call this behavior Working-set size (WSS) variance.

Among all MSR tests, prxy and proj have the highest data reuse, on average 417 and 29 accesses per data block respectively. They also show greatest improvement by OSL over OPT. In prxy, for the first four cache sizes between 32 MB and 138 MB, the miss ratio is 19%, 13%, 9%, and 4% by OPT, however 11%, 0.6%, 0.4% and 0.3% by OSL. The difference is as large as high as 23 times, suggesting great variance in WSS. This is corroborated by the steep fall by LRU from 22% miss ratio at 128 MB to 5.3% at 160 MB, suggesting a common WSS within the narrow range. It is also the only program with Belady anomaly where ARC produces non-monotone miss ratios, likely caused by the unusual WSS variance.

In proj, the improvement does not come from WSS variance (no sharp drop in miss ratio in either OSL or LRU). It shows a different effect—the same data is used in phases far separated from each other. Being prescriptive (Section 2_2.1), OSL keeps data in cache only in these phases. We call this effect Working-set variance. The effect of working-set variance increases with the size of the cache. The test proj has the greatest demand for cache and hence the largest displayed cache size (162 GB) among all graphs. Between 96 GB and 162 GB, OSL miss ratio is between 3.0% and 4.4% (5.2% to 6.2% relative) lower than OPT, demonstrating that the effect of working-set variance is most pronounced in large caches.

FIG. 10A to FIG. 10K are graphs showing a performance comparison for 11 MSR traces. The tests stg (FIG. 10A to FIG. 10K) and mds (FIG. 11A to FIG. 11B) mostly contain blocks that are accessed just once.

We compute the average reuse per data block by dividing the trace length with the data size in Table 1 of FIG. 9. For stg and mds, the average use is 1.1 and 1.3 respectively. In fact, they are the lowest among all tests. It is instructive to consider how a caching policy handles single-use data blocks. In LRU, such block may cause eviction of data blocks that have future reuses. In optimal policies, OPT, OSL, and VMIN, this will never happen. In fact, all three optimal policies know which block is single use. Still, OSL and VMIN outperforms OPT. The reason is WSS variance. Without such variance, the two would have the same miss ratio.

OSL outperforms OPT due to the effects of WSS and working-set variances.

Among the MSR traces, the effects are greatest in traces with the least use, stg, mds proj, and with the most reuse, prxy.

Statistical Clairvoyance—To compare statistical clairvoyance with variable size, we denote the following two benefits: Let VB be the benefit of variable size over fixed size; let PC be the benefit of precise (exact reuse time) over statistical clairvoyance (a distribution).

If we assume the two factors are independent, we have the following informal performance equations. Here performance is the hit ratio, not the miss ratio.

OSL=OPT+VB−PC, where VB=VMIN−OPT

Whether OSL is better or worse than OPT hangs in the balance of VB vs. PC. The exact VB value is the gap between VMIN and OPT. In the first 3 graphs in FIG. 2, OSL performs the same as OPT, which means that VB and PC effects cancel each other. In all others (with larger amounts of data), OSL outperforms OPT at large cache sizes, showing that the loss of PC becomes eventually less significant than the gain of VB. The increasing gains of VB at larger cache sizes are due to WSS and working-set variation explained earlier.

Fully Reuse Cache—Cache achieves maximal reuse when it loads each data block just once, and all reuses of it are hits. We call it the fully reuse cache (FRC). To be precise, FRC has only cold-start misses according to the 3C characterization by Hill [21], which is best possible cache performance. The FRC size of a cache policy is an interesting performance measure. It shows how much cache is needed by this policy to achieve this best possible performance.

OSL has much smaller FRC size than OPT. In OSL, the lifetime of a data block is always bounded (by the lease of its last access). In fact, based on statistics, it never assigns a lease longer than the longest reuse time of a data block. Comparing OSL and OPT in FIG. 10A to FIG. 10K, we see that OSL has a smaller FRC size in all except for two. In rsrch, hm, mds, its FRC size is about half of that of OPT. From paper [42, FIG. 11A and FIG. 11B], we see the same happens for web.

In other words, it takes OSL half as much space to achieve maximal cache reuse than OPT can. Another distinction, maybe important in practice, is predictability of the FRC size. OSL optimization computes the FRC size (by running the loop at line 2 in Algorithm 3 to maximal target cost), so does OPT but at a much greater time and space cost, as described in section 2_2.2.5.

OSL with Space-bounded Cache—We use two tests, mds and src2, to show more details in FIG. 11A and FIG. 11B. At each miss ratio of OSL, the graphs show the maximal cache size reached during the execution. The full range is between 0 and the maximal size, with the average is the point on the OSL curve.

In addition, we have also tested OSL with space-bounded cache, in particular, the cache will stop inserting new data blocks when the size exceeds a given bound. We call it capped OSL cache. FIG. 11A and FIG. 11B show the effect of 10% cap, where the maximal size is no more than at 10% of the average.

The two tests of FIG. 11A and FIG. 11B show the range of effects. In mds, the maximal cache size deviates from the average more as the (average) cache size increases. Capped OSL (by 10%) performs much worse than uncapped OSL but converges to OSL as the cache size increases. In src2, the maximal size deviates from the average more as the cache size increases. Capped OSL performs nearly as well as uncapped OSL. Space variation is important for performance in mds but not in src2.

Memcached—The Memcached trace is generated using Mutilate [2_48], which emulates the characteristics of the ETC workload at Facebook [2_2]. ETC is the closest workload to a general-purpose one, with the highest miss ratio in all Facebook Memcached pools. We set the workload to have 50 million requests to 7 million data objects and select the trace for size class 6, which has the most accesses among all size classes. We have tested 3 other size-class traces and found the graphs (other than the cache size on x-axis) look identical.

Because OPT performs near the same as VMIN, there is little benefit from variable-size caching. The trace is generated randomly based on a distribution, so it has no WSS and working-set variance. There is a large gap between OSL and OPT due to the lack of precise information in OSL. These characteristics are opposite of those of MSR traces.

2_4 Related Work—We focuses on related work in optimal caching.

Variable-space cache—Denning established the formalism of the working set theory in 1960s [2_15]. In 1976, Prieve and Fabry gave the optimal algorithm VMIN [2_33]. In the 1970s, Denning and his colleagues showed the formal relation between the working-set size and the miss ratio for a broad range of caching policies such as LRU, working-set cache, VMIN, and stack algorithms including OPT [2_13, 2_37, 2_14]. They gave a formal analysis of the relation between fixed and variable caching and showed “substantial economies . . . when the variation in working set sizes becomes relative large.” [2_11, Sec. 7.4] Such economies have two benefits: reducing the miss ratio and/or increasing the degree of multiprogramming

VMIN is prescriptive and optimal based on precise future knowledge, while the OSL algorithm in this Application is prescriptive and optimal based on statistical clairvoyance. In implementation, working-set allocators are usually invoked periodically, not continuously [27]. Periodic cache management does not support fine-grained allocation. The SEAL algorithm in this Application efficiently supports the lease cache, where a different lease may be assigned for each access, and the lease can be arbitrarily long.

Fixed-space cache—Optimal fixed-space policy is MIN given by Belady [2_5]. Mattson et al. developed the OPT stack algorithm which simulates Belady's optimal replacement for all cache sizes in two passes [2_26]. The high cost of OPT stack simulation was addressed by Sugumar and Abraham, who used lookahead and stack repair to avoid two-pass processing and more importantly grouping and tree lookup (instead of linear lookup) to make stack simulation much faster [2_39]. The asymptotic cost per step is logarithmic in the number of groups, which was shown to be constant by experiments. We used their implementation in our experiments.

More recently, Waldspurger et al. developed scaled-down simulation in SHARDS, which samples memory requests and measures miss ratio by emulating a miniature cache using these samples [2_41]. SHARDs was later generalized to support any cache policy including OPT [2_42].

For hardware caches, Jain and Lin developed a policy called Hawkeye [24]. Hawkeye keeps a limited history (a time window of 8× the cache size), uses interval counting (to target a single cache size), and leverages associativity and set dueling [34] to compute OPT efficiently with low time and space cost in hardware. In comparison, scaled-down simulation uses spatial sampling in software [2_42].

Past work in performance modeling has solved the problem of measuring the reuse distance (LRU stack distance), including algorithms to reduce time complexity [31, 1] and space complexity [2_44] and techniques of sampling [45, 36] and parallelization [36, 30, 12]. Recent developments use sampling to measure reuse distance with extremely low time and space overhead, including SHARDS [2_41], counter stacks [2_44], and AET [2_23]. Scaled-down simulation and Hawkeye use sampling to measure OPT efficiently, and the former also models other policies including ARC, 2Q and LIRS [2_24, 2_42].

OSL is its own performance model. Unlike original OPT stack simulation which is costly to measure its performance, OSL is efficient by construction (Algorithms 2, 3 and Section 2_2.2.5). It needs the histogram of reuse times, which can be efficiently sampled as shown by AET [2_23] following the techniques of StatCache, StatStack and SLO [2_17, 2_16, 2_6, 2_8].

Cache Optimization—Miss ratio curves (MRCs) are important tools in optimizing cache allocation in both software and hardware caches [38, 40, 35, 46, 22, 10]. Two recent techniques are Talus [4] and SLIDE [42]. Talus partitions an LRU cache to remove “cliffs” in its performance, and SLIDE, with scaled-down simulation, enables transparent cliff removal for stack or non-stack cache policies. These techniques are not based on OPT, because OPT is not practical, and for SLIDE, its MRC is already convex.

Hawkeye is an online technique based on OPT. It uses OPT decisions to predict whether a load instruction is “cache friendly or cache-averse.” [2_24] Collaborative cache lets software insert hints to affect cache management [2_43]. Gu et al. used OPT to generate cache hints (for LRU-MRU cache to indicate if an access is managed by LRU or MRU), so collaborative caching is optimal (for the same trace) [2_20]. To make it practical, Brock et al. used the OPT decision at loop level [2_9].

By using statistical rather than precise future information, OSL is less restrictive than OPT in its optimization. It does not require the same sequence of accesses in the future, merely the same statistics. OSL solves two practical problems: efficient optimization and implementation. Both are necessary for any future caching solution based on statistical prediction. Furthermore, the experiments show clearly the potential that the cache based on statistics performs as well as and better than OPT.

2_5 Summary—This Application has described variable-size caching based on statistical clairvoyance. The Application described OSL and proved its optimality. No other caching algorithm without precise reuse time information can obtain a lower miss ratio for the same cache size, and it is optimal for all its cache sizes. To manage arbitrarily long leases, we described the SEAL algorithm with constant time and logarithmic space. When evaluated using data access traces based on real-world workloads, OSL consistently matches or exceeds the performance of OPT. Although OSL is currently ideal, it has solved two practical problems, namely, efficient optimization and implementation, which are necessary for any future online solution based on statistical prediction.

Part 3—Exemplary Compiler and Device Implementations

Three sections, Managing Cache Memory Using Leases (3_1.1), Lease Marks (3_1.4), Exemplary Implementation in a multicore processor according to section 3_1.1, section 3_1.4, and a lease cache implemented in software which can run on a single or multicore processor.

A program accesses data stored in memory. The memory is hierarchical with layers of caches with different speed and capacity. The memory hierarchy is dynamically managed. The caches store blocks of data that are used now or soon and when they are no longer used, replace them with other data blocks.

This is the problem of memory hierarchy management. The cost and performance of a modern system largely depend on its memory hierarchy. Manual management is difficult and not portable. Automatic management is sub-optimal—Automatic management reacts to program behavior, however does not directly utilize program knowledge.

New processor and memory devices and methods—This Application describes and a new type of memory hierarchy management. “Leases” are used to communicate program knowledge to the memory hierarchy and improve the management of the caches.

A set of interfaces communicates the leases. Around the interfaces, a set of techniques (methods) generates leases and a set of techniques (devices) implement leases.

Leases and lease marks. The Application describes two interfaces. The first interface is based on leases. The second interface is based on lease marks. Lease generation techniques—The Application describes a set of techniques (methods) that generate leases or lease marks. Lease implementation techniques—The Application describes a set of techniques (devices) that implement a cache using leases or lease marks.

Benefits of the new devices and methods include: Program knowledge—With leases and lease marks, a program can directly control which data to store in cache. The cache management can be optimized based on program knowledge. Adaptive control—With leases and lease marks, a program can control how much cache to use based on the amount of available space at the time of the execution. Multi-policy caching—The lease control allows the same cache to be used by different cache policies, e.g. some by program control and some by automatic control, for different data at different times.

### Definitions

Memory instructions—When implemented in hardware, such as, for example in a processor structure, there will be new lease cache memory instructions to perform lease cache memory management as described by the Application. It is understood that there will be new memory instructions. For example, in the case of a processor, there will be new corresponding instructions of the processor's instruction set architecture (ISA). Those skilled in the art will understand that the exact syntax of such ISA instructions is unimportant to the implementation of lease cache in processor or memory hardware. Any suitable instruction syntax and/or any suitable ISA syntax and/or ISA structure can be used.

Uniform Lease (UL) and Uniform Lease Extension (ULE) in Section 1_5 are the same as Delegated Uniform Lease (DUL) and Base Extension Lease (BEL) in Section 3_1. Optimal lease in Section 1_1 and 1_6.1 is the same as VMIN Lease (VL) in Section 3_1.

Program—A program is a sequence of machine instructions. There are two type of instructions that access memory: memory loads and memory stores. When the program executes, it generates a sequence of references to memory locations. Each reference is a memory address, also referred to as a reference, a trace element, and its target, a data item. The words “sequence”, “trace” and “execution” are used interchangeably in this Application, as are the phrases “memory access” and “memory address”. For hardware lease cache, the data granularity is fixed, either a cache block or a page. In software lease cache, a data item is an object, which can have any size.

Lease—At each access, a lease is assigned to the data block being accessed, and the data block is cached for the length of the lease and evicted immediately when the lease expires. A lease is a number of zero or higher. The number can be also called a lease length, lease term, or lease time. The lease can be measured by private or shared time. Before the new devices and methods of the Application, in distributed file cache [3] and Web caches, e.g. Memcached [2], and in TLB and CPU cache [1]: A lease was given to a data block, but not at each access of the data block. The purpose was to reduce coherence cost in a parallel execution, not for or related to cache utilization (in both sequential and parallel executions).

In traditional caches based on least-recently-used (LRU) replacement policy, the cache is reactive.

The term cache leases was initially used in distributed file caching [3]. Such uses continue today in most Web caches, e.g. Memcached [2], and recently in TLB [1]. A lease specifies the lifetime of data in cache to reduce the cost of maintaining consistency. The lease cache is similar in that a data block is evicted when the lease expires, however, is more dynamic because in the lease cache, the lease is re-assigned each time the data block is accessed. The purpose is prescriptive caching to capture the working set of a program. The present implementation of the Application, where the cache is prescriptive with variable size caching, is more difficult, at least because lease cache as used herein manages the lease at every access.

The eviction time of a data block was prescribed each time it is accessed. Traditional cache management is reactive. In LRU cache, a data block is selected and evicted when space is needed for another data block.

Part 3_1—Managing Cache Memory Using Leases, Compiler and Device

In a first exemplary device and method according to the Application, a new device according to the Application includes a cache lease controller and a lease cache implementation. Typically, to make use of the new lease controller and a lease cache of the device, a program is first compiled by a program lease compiler to generate a suitable binary code (machine code) where the new device can make use of the new lease approach to cache management.

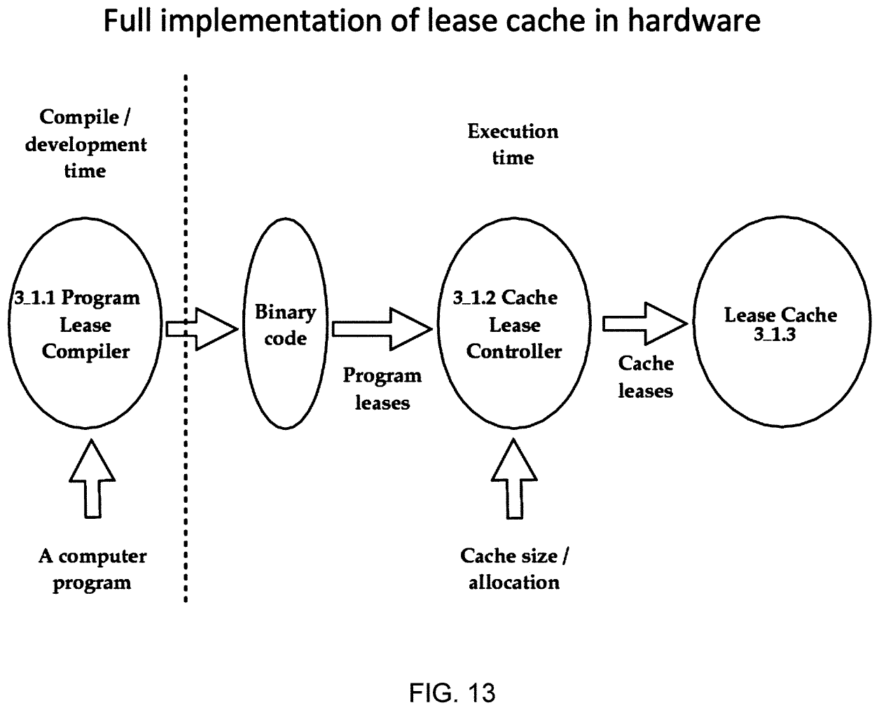

FIG. 13 is a block diagram showing an exemplary lease cache and program lease compiler according to the Application. The vertical dashed line 3010 denotes a separation between the software aspect of the program lease controller 3005, which generates binary code 3007 that runs on the hardware of the new device, including the lease controller 3003 and the lease cache 3001.

3_1.1 Program Lease Compiler

Described now are four types of program leases and two techniques for generating program leases.

3_1.1.1 Lease demand—At an access, a lease demand is the time the data item must stay in cache.

3_1.1.2 Lease request—At an access, a lease request is a “wish” by the program to be given the requested lease. The lease cache controller can assign the requested lease if there is enough cache space; otherwise, it will assign a lease less than the request. It will not assign a lease greater than the lease request.

3_1.1.3 Lease delegation—At an access, the program delegates the memory system to assign a lease for the access. Lease delegation is used when a program has no information about the future access of this data item.

3_1.1.4 Lease termination—A lease termination tells the lease cache to evict a data item from the cache. Lease termination has no effect if the data item is not in the cache. The lease termination can be implemented by a lease request where the requested lease is 0. The only difference between a lease termination and a 0-lease request is that the lease termination does not access memory, while a lease request does.

The program leases can be generated by a program interface, a compiler, or by any combination thereof.

3_1.1.5 Lease programming interface—A programming interface of pragmas and annotations can be used to allow a programmer to specify which data objects must be kept in cache. This programming interface will be translated to lease demands by the lease compiler. The interface can also let a programmer specify data reuse, which will be used by the lease compiler to generate lease requests.

3_1.1.6 The lease compiler—The lease compiler analyzes a program to determine the reuse interval. At an access, the reuse interval is the length of time until the next access to the same data item. This reuse interval information is used to generate program leases. At a memory load or store, if the referenced data item should be in cache, e.g. as specified by the programmer using the lease programming interface, the lease compiler inserts a lease demand with the demanded lease equal to the reuse interval. If the caching of the referenced data is not so specified, the lease compiler inserts a lease request requesting the lease equal to the reuse interval. If the lease compiler cannot determine the reuse interval, it generates a lease delegation. If the reuse interval is deemed too large to worth caching, the lease compiler generates a lease termination.

Program leases are based entirely on program information, independent of cache parameters. They are portable and machine independent in that they are the same regardless of the cache used. There is no need to re-analyze a program or change its code when running the program on different machines.

Compiler analysis has been used to manage registers and scratch pad memory by generating placement and addressing information in addition to allocation and eviction. However, lease request generation includes only allocation and eviction information. Existing compiler analysis does not use cache and has to re-run if the memory size is decreased. Existing compiler analysis also has to change address. By contrast, lease request generation uses the cache memory, does not change placement or addressing, and is portable (reusable without change) if the cache size changes.

Compiler analysis has been used to generate cache hints. However, the hint generated by prior compiler analysis is not based on leases. The analysis should consider the cache parameters, and the resulting hints may become counter productive (i.e. reducing cache utilization) if the cache size changes. Also, a lease request is machine independent. Finally, existing techniques do not combine all three types of program leases.

3_1.2 Cache Lease Controller (CLC)

The lease controller assigns actual leases to the cache memory by considering program information, i.e. program leases, the hardware information, i.e. the cache size or if the cache is shared, the cache allocation.

Lease policies, and the implementation—Given program leases a program or for its different groups of accesses, CLC assigns the actual lease by selecting the appropriate lease policy and choosing the appropriate implementation.

3_1.2.1 Delegated Uniform Lease (DUL)—For lease delegation, the policy of Uniform Lease (UL) [symbol] ₓ is as follows: Every data access is assigned the same default lease x≥0. UL policy is used for delegated leases, for which a program provides no information.

3_1.2.2 VMIN Lease (VL)—For lease requests, the policy of VMIN Lease (VL) V, is as follows: given the lease request t (not a delegation), V, keeps the data in cache if t≤x; otherwise, it evicts the data immediately.

3_1.2.3 Base Extension Lease (BEL)—For lease demands, Base-Extension Lease (BL) [symbol] ₓ takes the lease demand from a program as the base lease. BL gives the program additional leases, if there is additional cache space available. All base leases (regardless of the initial value) are extended by the same amount x.

3_1.2.4 Optimal Steadystate Lease (OSL) Statistical caching: In the general case, when the future reuse time is not known precisely but known statistically, a lease is selected based on such statistics using the algorithm described in section 2_2.2. OSL uses the same lease for all accesses of the same data. Given the reuse intervals of a group of accesses, it assigns the same lease for all accesses in the group. By calculating the profit per unit cache (ppuc), OSL ranks candidate leases to maximize cache utilization.

3_1.2.5 Multi-policy Lease (ML)—Cache is shared, between different data for the same program or between data of different programs. The letters S/M symbolize these cases to mean single/multiple and the letters D/P mean data/policy. SDSP means single data, single policy, i.e. no sharing. The remaining cases are those of sharing. Lease cache can support all three remaining types. Lease cache can support MDSP, where different data managed by the same policy may share the same lease cache, for example, by two programs both using uniform leases. Lease cache can support MDMP, where different data managed by different policies may share the same cache. Finally, Lease cache can support SDMP, where the same data may be managed by different policies, even in the same period of execution.

Implementation of the lease-cache policies, in particular, given a target cache size, how to determine the parameter used by a policy.

The size of the lease cache is the average number of active leases at an access. The size of the lease cache can be computed by the total lease divided by the trace length. Two leases can overlap for the same data block and hence the same cache slot. To count space usage accurately, all such overlaps can be removed through lease fitting. If a lease overlaps with a later lease for the same data block, the first lease is shortened to remove the overlap.

3_1.2.6 Choosing x for Delegated Uniform Lease (DUL) Policy [symbol] ₓ Let p be the program using [symbol] ₓ, we have the relation between lease length x, the average cache size s(p, [symbol] ₓ), and the miss ratio mr(c) as follows:

$$s ( p , {𝒰}_{x} ) = x - \frac{{\sum }_{{r}_{i} < x} x - {r}_{i}}{n}$$

$$m r ( c ) = Δ s ( p , {𝒰}_{x} ) {\vert}_{s ( p , {𝒰}_{x} ) = c}$$

where n is the number of accesses in p, rᵢ is the forward reuse time of the ith access, and Δ is the finite-difference operator, i.e. Δf(x)=f(x+1)−f(x).

3_1.2.7 Choosing x VMIN Lease (VL) Policy Vₓ Given the forward reuse interval t, VMIN keeps the data in cache if t≤x; otherwise, it evicts the data immediately. The average cache size s(p,Vₓ) and the miss ratio mr(c) are computed from the reuse time as follows:

$$s ( p , {𝒱}_{x} ) = \frac{{\sum }_{{r}_{i} \leq x} {r}_{i} + {\sum }_{{r}_{i} > x} 1}{n}$$

$$mr ( c ) \frac{{\sum }_{{r}_{i} > x} 1}{n} , where c = s ( p , {𝒱}_{x} )$$

3_1.2.8 Choosing x for Base-Extension Lease (BEL) Policy [symbol] ₓ [symbol] ₓ is determined by the base policy and the extension x≥0. For a program p, let the base policy be Bₓ=lᵢ and the extension be lᵢ+x for x≥0, the cache size s(p,Bₓ) is

$$s ( p , {ℬ}_{x} ) = \frac{L}{n} + x - \frac{{\sum }_{{l}_{i + x > {r}_{i}}} {l}_{i} + x - {r}_{i}}{n}$$

$$mr ( c ) = Δ s ( p , {ℬ}_{x} ) {\vert}_{s ( p , {ℬ}_{x} ) = c}$$

The minimal cache size is s(p, [symbol] ₀) and the upper bound miss ratio mr(c), where c=s(p, [symbol] ₀).

3_1.2.9 Choosing Leases in Optimal-steadystate Lease (OSL) Policy OSL provides the size-performance formulas as part of its algorithm (See section 2_2.2).

3_1.2.10 Optimal Multi-policy Sharing Let there be g non-overlapping groups, p₁, p₂, . . . , p_{g}, with |pᵢ| accesses in each group (n=τᵢ₌₁^{g}|pᵢ|), and managed by g lease policies, [symbol] _{1,x}_{₁}, [symbol] _{2,x}_{₂}, . . . , [symbol] _{g,x}_{_{g}}. Each policy [symbol] _{i,x}_{ᵢ} may be uniform lease [symbol] ₓ, VMIN lease Vₓ, or base-extension lease [symbol] ₓ. Each policy [symbol] _{i,x}_{ᵢ} has a parameter xᵢ that controls how much space its data occupy in the shared cache. The cache size functions of individual groups are sufficient to compute the cache size and miss ratio of the shared cache for any type of policy mixing. The shared cache size is

$$s ( {p}_{1} {p}_{2} … {p}_{g ,} {ℒ}_{1 , {x}_{1}} {ℒ}_{2 , {x}_{2}} … {ℒ}_{g , {x}_{g}} ) = \frac{{\sum }_{i = 1}^{g} s ( {p}_{i} , {ℒ}_{i , {x}_{i}} ) \vert {p}_{i} \vert}{n}$$

and the shared cache miss ratio is

$${m r ( c ) = \frac{{\sum }_{i = 1}^{g} m r ( s ( {p}_{i} , {ℒ}_{i , {x}_{i}} ) ) \vert {p}_{i} \vert}{n} \vert}_{s ( {p}_{1} {p}_{2} … {p}_{g} , {ℒ}_{1 , {x}_{1}} {ℒ}_{2 , {x}_{2}} … {ℒ}_{g , {x}_{g}} ) = c}$$

where mr(s(pᵢ, [symbol] _{i,x}_{ᵢ})) is the formula for computing the miss ratio for program pᵢ and policy [symbol] _{i,x}_{ᵢ}.

Given the size of a lease cache c, multi-policy caching can be optimized by dividing the space between the groups of accesses to minimize the total of cache misses across all groups. Dynamic programming can be used to optimize the lease cache and compute the allocation that minimizes the total miss ratio across all groups.

The methods and devices of the Application use the policy in the context of the lease cache. Prior work, such as VMIN policy developed by Prieve and Fabry in 1976 [4], used offline trace analysis. VL policy used program analysis (3_1.1.1). Also, the existing techniques assumed complete program knowledge. By contrast, VL of the Application can be used with partial program knowledge, i.e. by combining VL and DUL.

The lease cache supports more flexible sharing than traditional caches such as LRU. In prior art, different policies can only be applied on disjoint sets of data, i.e. it cannot support the case when the same data are cached by different policies (SDMP). In addition, the cache space must be pre-partitioned among different policies, i.e. it supports multiple-data-multiple-policies (MDMP) in different partitions but not in the same partition. In a lease cache, the space used by each policy may grow and shrink, and the same space could be used to store data managed by different policies, and this same space could store different data at different times (in MDSP or MDMP) or the same data at different times when under different management (in SDMP).

3_1.3 Lease Cache—Traditional caches such as LRU maintain a fixed size, by ranking all cached data. The ranking carries a global cost which makes eviction logic difficult. By contrast, lease cache has a logic where the eviction is determined by the lease.

3_1.3.1 Space-efficient Approximate Lease (SEAL)—(See also: section 2_2.3) SEAL achieves O(1) amortized insertion time and uses

$$O ( M + \frac{1}{α} log L )$$

space while ensuring that data stay in cache for no shorter than their lease and no longer than one plus some factor α times their lease. SEAL creates “buckets” to store cached objects, and these bucket are “dumped” into the next bucket at some interval, called the “dumping interval.” When an object is dumped out of the last bucket, the object is evicted. The dumping interval of any particular bucket is a power of two. The number of buckets with dumping interval 2^{k} for k∈N depends on the accuracy parameter, α, specifically

$$\frac{2}{α} .$$

3_1.3.2 Cache Occupancy Control—The cache keeps an occupancy counter and a cache-allocation register for each program. The total cache allocation (of all running programs) cannot exceed the cache size. In this exemplary implementation, the mapping from a program to its counter and cache-allocation register is maintained by device hardware (for fixed allocation, e.g. equal allocation among all cores) or privileged software (i.e. the operating system). The occupancy counter is maintained by the hardware. The occupancy counter increments when a data block is loaded into the cache and decrements when a data block is evicted from the cache.

When a program loads a data block into the cache, if there is a cache block currently not used to store data (i.e. a free, unoccupied cache block), the free block is used to store the new data block.

When a program p loads a data block into the cache and there is no unoccupied block, the occupancy control uses one of the two policies: peer first and self first. In the peer-first policy, the occupancy control finds a program q whose counter is larger than q's cache allocation. The occupancy control evicts a data block from q and gives the space to p's new data block. If such program q does not exist, the occupancy control evicts a block of program p and gives the space to the new data block.

In the self-first policy, the occupancy control checks if p's allocation is under utilized, i.e. whether the occupancy is smaller than the allocation. If p's allocation is under utilized is under utilized, the occupancy control finds a program q whose counter is larger than its cache allocation. The occupancy control evicts a data block from q and gives the space to the new data block. If p utilizes all its cache allocation, i.e. its occupancy counter equals to or exceeds its cache allocation, the occupancy control evicts a data block of p and gives the space to the new data block.

3_1.4—Program Lease-Mark Compiler

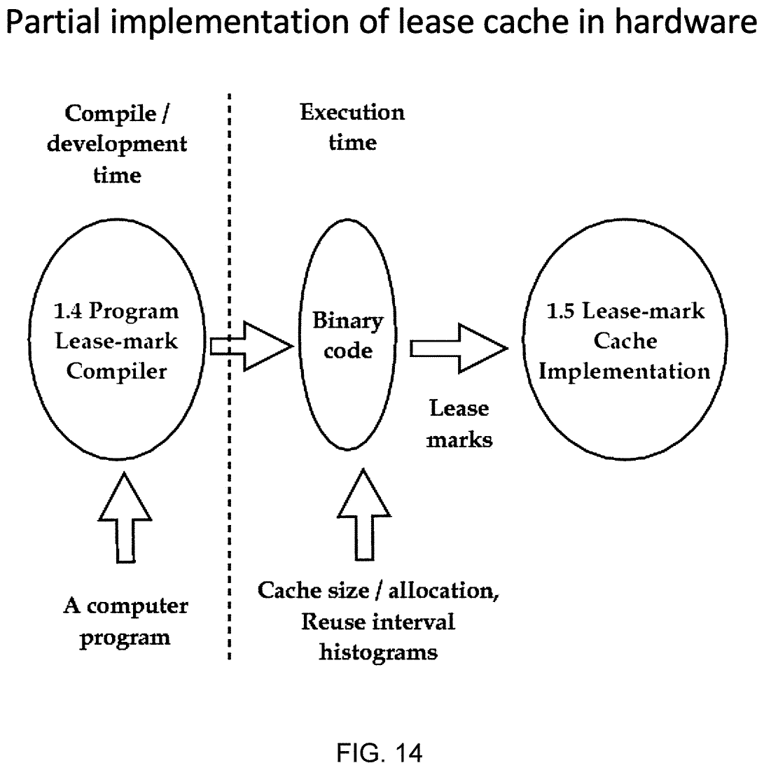

FIG. 14 is a block diagram showing an exemplary partial implementation of lease cache in hardware.

Instead of separating program analysis and policy control as done in sections 3_1.1 and 3_1.2, an alternative design is now described, where the functions of the lease controller are combined into the compiler. Instead of generating program leases as by the lease compiler (section 3_1.1), the compiler can add the code into the program binary which will compute the actual lease when the program binary is executed. This embodiment can be added to an existing cache implementation. A program lease-mark compiler implementation conducts lease analysis and policy implementation in software and adds a small set of extensions to an existing hardware design (section 3_1.5).

3_1.4.1 Lease Marks—Each memory instruction is optionally accompanied by a lease mark. To generate such marks, the compiler inserts code to a program so that at each memory instruction, and the compiler-inserted code determines whether to generate a lease mark and if so, which mark is used. There are two types of lease marks:

lease-active mark—The mark lease-active mark tells the cache not to evict the data block. When choosing a block for eviction, the cache first evicts data blocks without a lease-active mark before evicting a data block with the lease-active mark.

lease-end mark—The lease-end mark tells the cache to evict the data block. When choosing a block for eviction, the cache first evicts data blocks with a lease-end mark before evicting a data block without the lease-end mark. The memory instruction, also called an eviction instruction, with the lease-end mark does not fetch data from memory.

3_1.4.2 Policy Embedding—The lease-mark compiler uses the techniques of program lease compiler (section 3_1.1). In addition, to generate the lease mark, the compiler embeds the lease cache policies in the generated code, a step of the compiler referred to as policy embedding which embeds different policies (from section 3_1.2) as follows:

Delegation Lease—For memory instructions whose program lease is a lease delegation, the host cache management is used. The compiler generates memory instructions with no lease marks. The delegated uniform lease (DUL) described in section 3_1.2.1 is not used in the lease-mark cache.

VMIN Lease (VL)—The compiler generates the VMIN policy code, which, based on the cache allocation and the reuse interval of each memory instruction whose program lease is a lease request, computes the lease to use by the memory instruction.

Base Extension Lease (BEL)—The compiler generates the BEL policy code, which, based on the cache allocation, computes the lease to use by each memory instruction whose program lease is a lease demand

Optimal Steadystate Lease (OSL)—The compiler generates the OSL policy code, which, based on the cache allocation and the reuse interval histogram of each data or reference group, computes the lease to use by each memory instruction of the group. The OSL algorithm is described in more detail hereinabove in section 2_2.2.

Multi-policy Lease (ML)—The compiler generates the ML policy code, which, based on the overall cache allocation for the program, divides it among different policies.

SEAL Based Eviction—For memory instructions governed by three of the policies in section 3_1.4.2: VL, BEL and OSL, the compiler generates the code that runs the SEAL procedure (section 3_1.3.1). As a memory instruction is executed, the compiler-generated code first issues the access with a lease-active mark to the lease-mark cache and then inserts the addresses of accessed data block and its lease into SEAL buckets. The compiler also generates the code that maintains a time counter. The SEAL procedure is running either embedded in the program execution or by a separate parallel thread. The SEAL procedure determines which data blocks should be evicted. SEAL procedure executes an eviction instruction (section 3_1.4.1) for each data block when it is evicted.

3_1.4.4 Programmed Eviction—To reduce the run-time time and space cost, the eviction code can be programmed to leverage the control structure of the program (instead of using the SEAL procedure in section 3_1.4.3). In a loop nest, the eviction instruction may be inserted in a later iteration of a loop. Such programmed eviction is used to complement the SEAL based eviction (section 3_1.4.3), where the compiler employs the program eviction if possible and otherwise uses the SEAL based eviction.

3_1.5 Lease-mark Cache Implementation

The lease-mark cache uses two extensions to a traditional cache. In the cache-interface extension, each load and store is optionally accompanied by a mark (section 3_1.4.1). The following shows an exemplary suitable cache-management extension.

3_1.5.1 Lease-mark Tags—The extension is added to an existing cache design, referred to as the host cache policy. In cache-management extension, in addition to the host policies of management and eviction, the cache supports the lease marks by storing them as tags and using them in cache management. Each data block in cache stores a tag, which may be one of the following three types:

No-mark tag—The data block is last accessed by a normal memory instruction, without a lease mark;

Lease-active tag—The data block is last accessed by a memory instruction with the lease-active mark; and

Lease-end tag—The data block is last accessed by a memory instruction with the lease-end mark.

In hardware cache, data blocks are first mapped to cache sets. The eviction in a cache set is based on the cache management policy, e.g. LRU or pseudo LRU. When selecting a data block for eviction, the marks are considered in conjunction with the default policy. If a data block has the no-mark tag, it is managed by the host policy with no change. If a data block in the cache set has a lease-end tag, then this data block is evicted before the data blocks not so tagged. If there is no data blocks with the lease-end tag, then a data block without the lease-active tag is evicted before the data blocks that have a lease-active tag.

3_1.5.2 Multi-level Lease-mark Cache—There may be multiple levels of CPU caches that form a hierarchy. The least-mark cache can be implemented for one, all, or any set of cache levels. Each level requires its own lease-active and lease-end marks and tags. The upper level cache stores the tags for all lower level caches. A memory instruction contains the lease-active or lease-end marks for any subset of cache levels (the subset may be empty). The lease-mark tags are added when a data block is accessed, and the tags for lower level caches are kept with the data block when it is evicted from the current cache.

The no-mark tag is a single tag for all least-mark caches, while a pair of lease-active and lease-end tags are specific for each lease-mark cache.

3_1.5.3 Lease-mark Cache Occupancy Control—The cache keeps an occupancy counter and a cache-allocation register for each program. The total cache allocation (of all running programs) cannot exceed the cache size. The mapping a program to its counter and cache-allocation register is maintained by hardware (for fixed allocation, e.g. equal allocation among all cores) or privileged software (i.e. the operating system). The occupancy counter is maintained by the hardware. The occupancy counter increments when a data block is loaded into the cache and decrements when a data block is evicted from the cache, see section 3_1.3.2.

The occupancy counter stores the total number of data blocks with the no-mark tag and the lease-active tag. When a program loads a data block into the cache, if its occupancy counter equals to the cache-allocation register, the data block is tagged with the lease-end mark, regardless of the mark (or no mark) contained by its memory operation.

When multiple levels of caches are implemented with lease marks, the occupancy control is applied at each cache. The occupancy counter records the total number of data blocks with the no-mark tag and the lease-active tag for this cache.

3_1.6 Software Lease Cache Interface

Introduction to Software Caches—A software cache manages main memory (DRAM) as a cache to serve data from local disks, local databases, or remote systems.

Software cache typically has several differences from hardware caches.

A first difference is that a software cache manages main memory as a cache, e.g. an in-memory cache. In today's web server architecture, distributed in-memory caches are vital components to ensure low-latency service for user requests. When a server uses an in-memory cache to support web applications, the time to retrieve a web page from a database can be reduced by caching the web page in a server's memory since accessing data in memory cache is much faster than querying a database. Through this cache layer, the database query latency can be reduced as long as the cache is sufficiently large to maintain a high hit rate.

A second difference is that a software cache manages data items of different granularity called size classes. For example, Memcached [3_2] is a commonly used distributed in-memory key-value cache system. Memcached splits the memory cache space into different classes to store variable-sized objects as items. Initially, each class obtains its own memory space by requesting free slabs, 1 MB each, from the allocator. Each allocated slab is divided into slots of equal size. According to the slot size, the slabs are categorized into different classes, from Class 1 to Class n, where the slot size increases exponentially.

A third difference is that the applications using the cache may be local or remote. In file caching, the cache supports local applications. In Memcached, the cache supports remote clients. We refer to both cases as clients.

Lease cache as described by the Application, can be used to improve the cache management of software caches. When a newly incoming item is admitted, the item is assigned to a size class whose the slot size is the best fit of the item size. If there is no free space in the class, a currently cached item has to be first evicted from the class of slabs following a cache replacement policy. This is where the new lease cache of the Application is applied.

Software Lease Cache Interface—New interface functions are added to specify four types of lease information as follows:

3_1.6.1 Lease delegation—The interface function contains no information about a lease. This is called a lease delegation. The client delegates the lease cache to assign a lease for the accessed data item. Delegation is used when a client has no information about the future access of a data item.

3_1.6.2 Lease request—The interface function includes a number to specify a lease request. The lease request is a “wish” by the client to be given the requested lease. The lease cache (See: 3_1.7) may assign the requested lease if there is enough cache space; otherwise, the lease cache will assign a lease less than the request. Lease cache will not assign a lease greater than the lease request.

The lease request is specified numerically as a lease length. The encoding of a lease length can use various solutions. One solution is to represent a range in a logarithmic scale.

3_1.7 Software Lease Cache—The lease cache uses a lease policy to assign actual leases based on the requests from the clients and the available memory in the machine. Below are the set of lease policies:

3_1.7.1 Delegated Uniform Lease (DUL) For lease delegation, the policy of Uniform Lease (UL) [symbol] ₓ is as follows: Every data access is assigned the same default lease x≥0.

3_1.7.2 VMIN Lease (VL) For lease requests, The policy of VMIN Lease (VL) Vₓ is as follows: given the lease request t (not a delegation), Vₓ keeps the data in cache if t≤x; otherwise, it evicts the data immediately.

3_1.7.3 Optimal Steadystate Lease (OSL) Statistical caching: In the general case, when the future reuse interval is not known precisely but known statistically, a lease is selected based on such statistics using the algorithm (Section 2_2.2). OSL uses the same lease for all accesses of the same data. Given the reuse intervals of a group of accesses, OSL assigns the same lease for all accesses in the group. By calculating the profit per unit cache (ppuc), OSL ranks candidate leases to maximize cache utilization.

3_1.7.4 Multi-policy Lease (ML) Cache is always shared, between different data for the same program or between data of different programs. We may symbolize these cases using letters S/M to mean single/multiple and D/P to mean data/policy. SDSP means single data, single policy, i.e. no sharing. The remaining cases are those of sharing. Lease cache supports all three remaining types. Lease cache supports MDSP, where different data managed by the same policy may share the same lease cache, for example, by two programs both using uniform leases. Lease cache supports MDMP, where different data managed by different policies may share the same cache. Finally, lease cache supports SDMP, where the same data may be managed by different policies, even in the same period of execution.

The following sections address the implementation of the lease-cache policies, in particular, given a target cache size, how to determine the parameter used by a policy.

The size of the lease cache is the average number of active leases at an access. We compute it by the total lease divided by the trace length. Two leases may overlap for the same data block and hence the same cache slot. To count space usage accurately, we remove all such overlaps through lease fitting. If a lease overlaps with a later lease for the same data block, the first lease is shortened to remove the overlap.

3_1.7.5 Choosing x for Delegated Uniform Lease (DUL) Policy [symbol] ₓ Let p be the program using [symbol] ₓ, we have the relation between lease length x, the average cache size s(p, [symbol] ₓ), and the miss ratio mr(c) as follows:

$${s ( p , {𝒰}_{x} ) = x - \frac{{\sum }_{{r}_{i} < x} x - {r}_{i}}{n} \\ mr ( c ) = Δ s ( p , {𝒰}_{x} ) \vert}_{s ( p , {𝒰}_{x} ) = c}$$

where n is the number of accesses in p, rᵢ is the forward reuse time of the ith access, and Δ is the finite-difference operator, i.e. Δf(x)=f(x+1)−f(x).

3_1.7.6 Choosing x VMIN Lease (VL) Policy V_{X} given the forward reuse interval t, VMIN keeps the data in cache if t≤x; otherwise, it evicts the data immediately. The average cache size s(p, Vₓ) and the miss ratio mr(c) are computed from the reuse time as follows:

$$s ( p , {𝒱}_{x} ) = \frac{{\sum }_{{r}_{i} \leq x} {r}_{i} + {\sum }_{{r}_{i} > x} 1}{n}$$

$$mr ( c ) = \frac{{\sum }_{{r}_{i} > x} 1}{n} , where c = s ( p , {𝒱}_{x} )$$

3_1.7.7 Choosing Leases in Optimal-steadystate Lease (OSL) Policy OSL provides the size-performance formulas as part of its algorithm (Section 2_2.2).

3_1.7.8 Optimal Multi-policy Sharing—Let there be g non-overlapping groups, p₁, p₂, . . . , p_{g}, with |pᵢ| accesses in each group (n=Σᵢ₌₁^{g}|pᵢ|), and managed by g lease policies, [symbol] _{1,x}_{₁}, [symbol] _{2,x}_{₂}, . . . , [symbol] _{g,x}_{_{g}}. Each policy [symbol] _{i,x}_{ᵢ} may be uniform lease [symbol] ₓ, VMIN lease Vₓ, or base-extension lease [symbol] _{X}. Each policy [symbol] _{i,x}_{ᵢ} has a parameter xᵢ that controls how much space its data occupy in the shared cache. The cache size functions of individual groups are sufficient to compute the cache size and miss ratio of the shared cache for any type of policy mixing. The shared cache size is

$$s ( {p}_{1} {p}_{2} … {p}_{g} , {ℒ}_{1 , {x}_{1}} {ℒ}_{2 , {x}_{2}} … {ℒ}_{g , {x}_{g}} ) = \frac{{\sum }_{i = 1}^{g} s ( {p}_{i} , {ℒ}_{i , {x}_{i}} ) \vert {p}_{i} \vert}{n}$$

and the shared cache miss ratio is

$${mr ( c ) = \frac{{\sum }_{i = 1}^{g} mr ( s ( {p}_{i} , {ℒ}_{i , {x}_{i}} ) ) \vert {p}_{i} \vert}{n} \vert}_{s ( {p}_{1} {p}_{2} … {p}_{g} , {ℒ}_{1 , {x}_{1}} {ℒ}_{2 , {x}_{2}} … {ℒ}_{g , {x}_{g}} ) = c}$$

where mr(s(pᵢ, [symbol] _{i,x}_{ᵢ})) is the formula for computing the miss ratio for program pᵢ and policy [symbol] _{i,x}_{ᵢ}.

Given the size of a lease cache c, multi-policy caching may be optimized by dividing the space between the groups of accesses to minimize the total of cache misses across all groups. To optimize the lease cache and compute the allocation that minimizes the total miss ratio across all groups, we can use dynamic programming

The lease cache has a simple logic—the eviction is determined by the lease. Next is how a software lease cache implements the leases.

3_1.7.9 Space-efficient Approximate Lease (SEAL) SEAL achieves O(1) amortized insertion time and uses

$$O ( M + \frac{1}{α} log L )$$

space while ensuring that data stay in cache for no shorter than their lease and no longer than one plus some factor α times their lease. SEAL creates “buckets” to store cached objects, and these bucket are “dumped” into the next bucket at some interval, called the “dumping interval.” When an object is dumped out of the last bucket, it is evicted. The dumping interval of any particular bucket is a power of two. The number of buckets with dumping interval 2^{k} for k∈ [symbol] depends on the accuracy parameter, a, specifically

$$\frac{2}{α} .$$

The SEAL algorithm is described in Section 2_2.3.

SEAL organizes data items in doubly linked lists and adds meta-data for each data item, in particular, two pointers: one pointing to the previous item in the list and the other the next item.

### Example

An exemplary implementation of lease cache in a processor of one or more cores is now described in more detail.

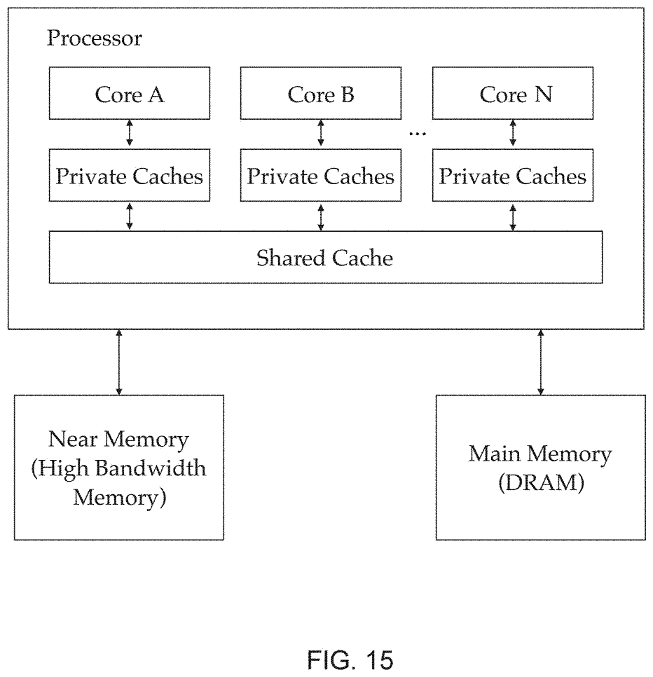

FIG. 15 is a block diagram showing an exemplary multicore processor and associated near memory and main memory for the exemplary implementation of lease cache according to the Application. It is unimportant to the implementation of lease cache of the Application if the near memory and/or the main memory is disposed on a common substrate or how it is operatively coupled to the processor (at least the main memory (e.g. DRAM) is typically “off-chip”). The memory can be operatively coupled in any suitable manner consistent with the data transfer bus speed used.

The exemplary processor of FIG. 15 has a collection of caches including one or more private caches (used by one core), one or more shared cache, and off-chip memory that can also be used as a cache. Each of the caches (including the memory cache) can be implemented as a hardware lease cache according to the Application. Near Memory can be implemented either as a hardware lease cache a described hereinabove, or as a software lease cache. Main Memory can be implemented as a software lease cache (fill in reference, or cite).

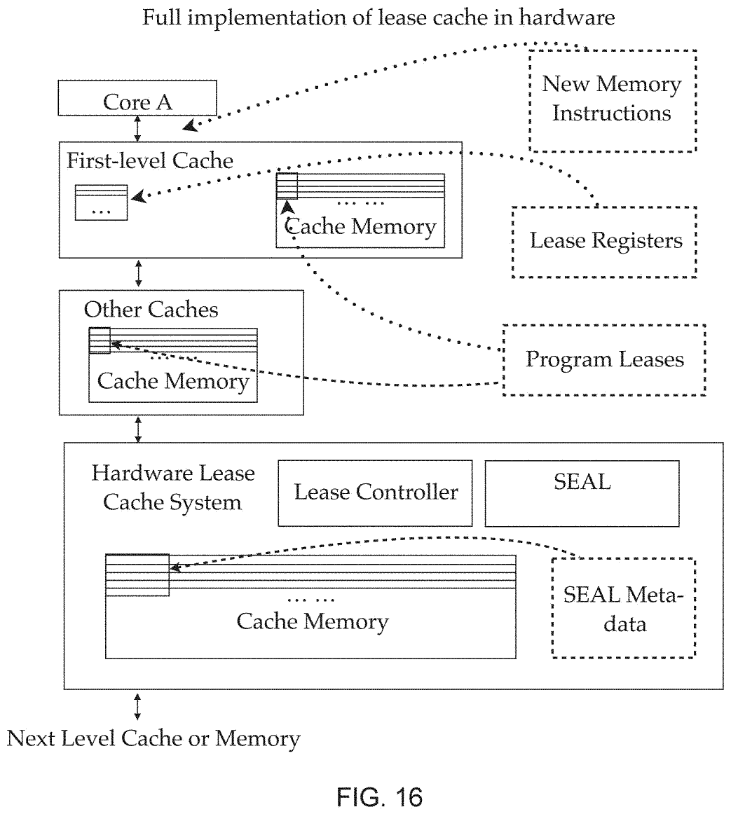

FIG. 16 is a block diagram showing an exemplary full implementation of lease cache in hardware for Core A (representative of similar implementations for cores B . . . N).

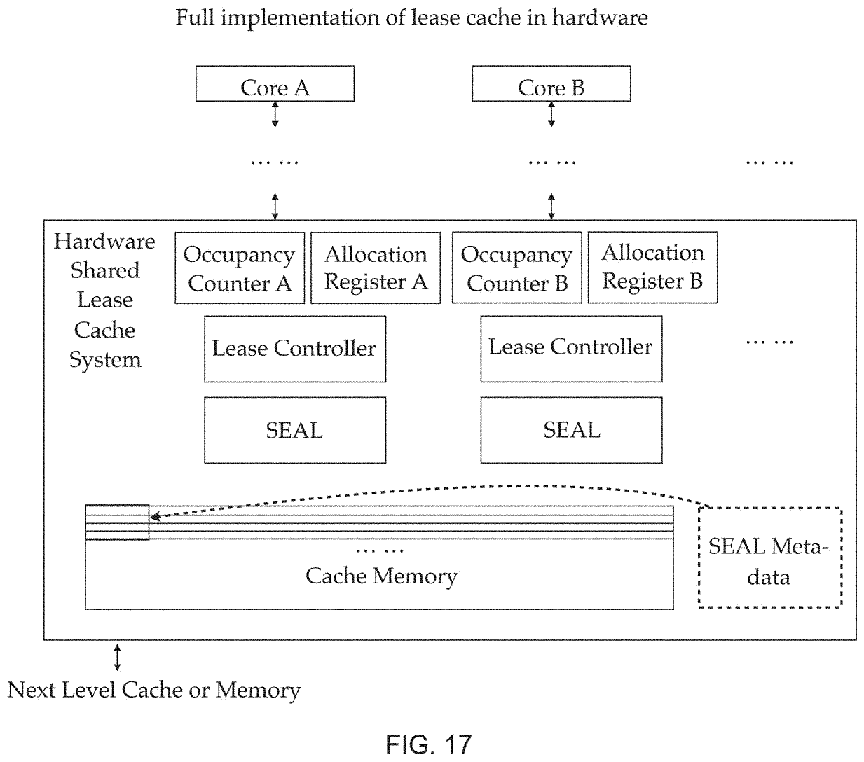

FIG. 17 is a block diagram showing more detail of the hardware shared lease cache system of FIG. 16.

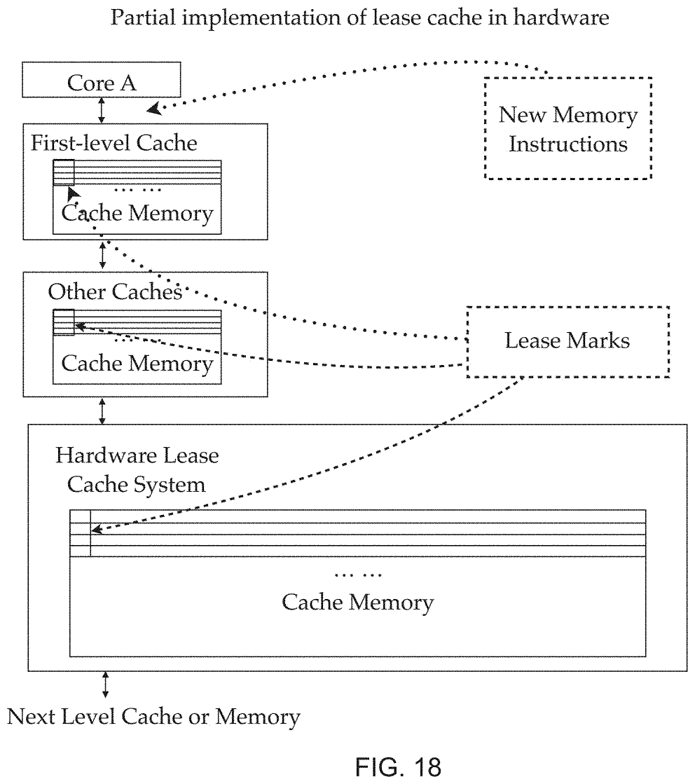

FIG. 18 is a block diagram showing an exemplary partial implementation of lease cache in hardware for Core A (representative of similar implementations for cores B N).

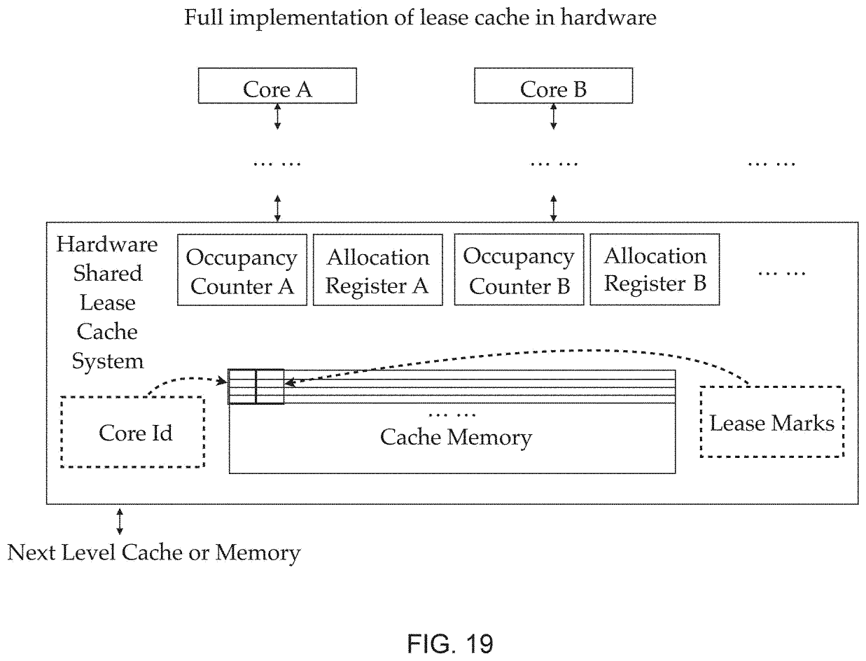

FIG. 19 is a block diagram showing more detail of the hardware lease cache block of FIG. 18.

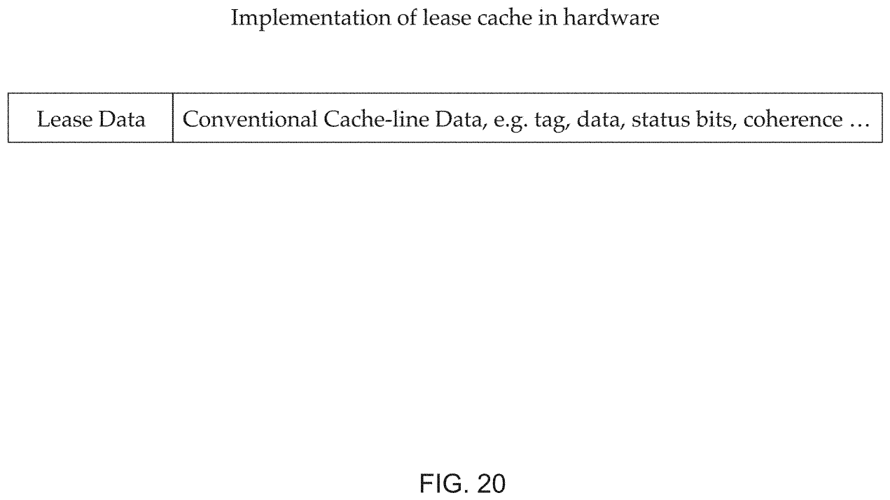

FIG. 20 is a block diagram showing an exemplary data format for an implementation of lease cache in hardware.

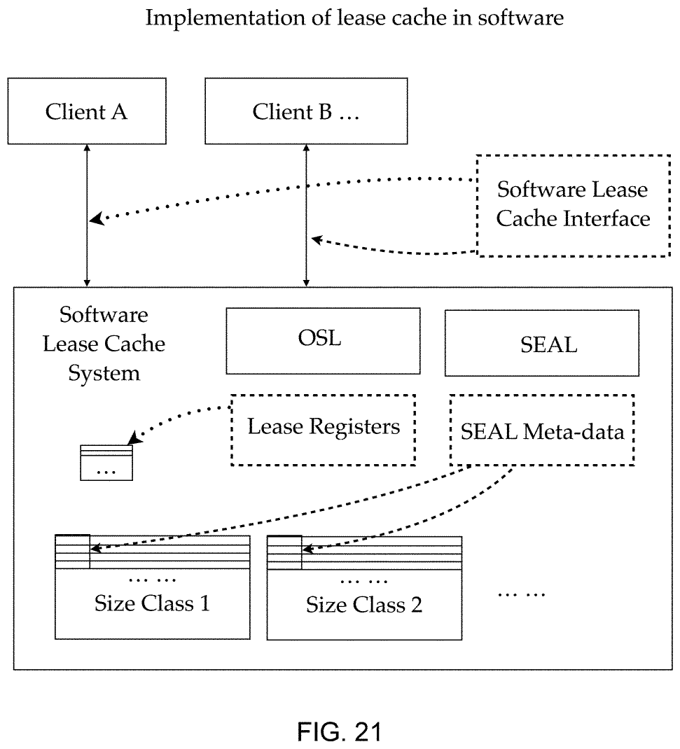

FIG. 21 is a block diagram showing an exemplary implementation of lease cache in software (e.g. implementing DRAM memory on a server as a lease cache).

FIG. P3, 10 is a block diagram showing an exemplary implementation of lease cache in software.

Any software for firmware used for testing lease cache or to implement lease case can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES

### Part 1 References

1_1 R. Allen and K. Kennedy. 2002. Optimizing Compilers for Modern Architectures. Morgan Kaufmann Publishers, Inc., San Francisco, Calif.
1_2 B. Alpern, L. Carter, E. Feig, and T. Selker. 1994. The uniform memory hierarchy model of computation. Algorithmica 12, 2/3 (1994), 72-109.
1_3 Laszlo A. Belady, Robert A. Nelson, and Gerald S. Shedler. 1969. An anomaly in space-time characteristics of certain programs running in a paging machine. Commun. ACM 12, 6 (1969), 349-353.
1_4 Kristof Beyls and Erik H. D'Hollander. 2005. Generating cache hints for improved program efficiency. Journal of Systems Architecture 51, 4 (2005), 223-250.
1_5 Jacob Brock, Chencheng Ye, Chen Ding, Yechen Li, Xiaolin Wang, and Yingwei Luo. 2015. Optimal Cache Partition-Sharing. In Proceedings of ICPP.
1_6 Peter J. Denning 1968. The working set model for program behaviour. Commun. ACM 11, 5 (1968), 323-333.
1_7 Peter J. Denning 1980. Working sets past and present. IEEE Transactions on Software Engineering SE-6, 1 (January 1980).
1_8 Peter J. Denning 2005. The locality principle. Commun. ACM 48, 7 (2005), 19-24.
1_9 Peter J. Denning and Kevin C. Kahn 1975. A study of program locality and lifetime functions. In Proceedings of the ACM Symposium on Operating System Principles. 207-216.
1_10 Peter J. Denning and Craig H. Martell. 2015. Great Principles of Computing. MIT Press.
1_11 Peter J. Denning and Stuart C. Schwartz. 1972. Properties of the working set model. Commun. ACM 15, 3 (1972), 191-198.
1_12 Peter J. Denning and Donald R. Slutz. 1978. Generalized working sets for segment reference strings. Commun. ACM 21, 9 (1978), 750-759.
1_13 Venmugil Elango, Fabrice Rastello, Louis-Noel Pouchet, J. Ramanujam, and P. Sadayappan. 2015. On Characterizing the Data Access Complexity of Programs. In Proceedings of POPL. 567-580. https://doi.org/10.1145/2676726.2677010
1_14 Xiaoming Gu and Chen Ding. 2011. On the theory and potential of LRU-MRU collaborative cache management. In Proceedings of ISMM. 43-54.
1_15 Brian Hackett and Radu Rugina. 2005. Region-based shape analysis with tracked locations. In Proceedings of POPL. 310-323. https://doi.org/10.1145/1040305.1040331
1_16 J. Hong and H. T. Kung. 1981. I/O complexity: The red-blue pebble game. In Proceedings of the ACM Conference on Theory of Computing. Milwaukee, Wis.
1_17 Xiameng Hu, Xiaolin Wang, Yechen Li, Lan Zhou, Yingwei Luo, Chen Ding, Song Jiang, and Zhenlin Wang. 2015. LAMA: Optimized Locality-aware Memory Allocation for Key-value Cache. In Proceedings of USENIX ATC.
1_18 Xiameng Hu, Xiaolin Wang, Lan Zhou, Yingwei Luo, Chen Ding, and Zhenlin Wang. 2016. Kinetic Modeling of Data Eviction in Cache. In Proceedings of USENIX ATC. 351-364. https://www.usenix.org/conference/atc16/technical-sessions/presentation/hu
1_19 R. L. Mattson, J. Gecsei, D. Slutz, and I. L. Traiger. 1970. Evaluation techniques for storage hierarchies. IBM System Journal 9, 2 (1970), 78-117.
1_20 Flemming Nielson, Hanne R. Nielson, and Chris Hankin. 1999. Principles of Program Analysis. Springer-Verlag New York, Inc., Secaucus, N.J., USA.
1_21 Vivek S. Pai, Mohit Aron, Gaurav Banga, Michael Svendsen, Peter Druschel, Willy Zwaenepoel, and Erich M. Nahum. 1998. Locality-Aware Request Distribution in Cluster-based Network Servers. In Proceedings of ASPLOS. 205-216. https://doi.org/10.1145/291069.291048
1_22 Barton G. Prieve and Robert S. Fabry. 1976. VMIN—An Optimal Variable-Space Page Replacement Algorithm. Commun. ACM 19, 5 (1976), 295-297. https://doi.org/10.1145/360051.360231
1_23 Donald R. Slutz and Irving L. Traiger. 1974. A Note on the Calculation Working Set Size. CACM 17, 10 (1974), 563-565. https://doi.org/10.1145/355620.361167
1_24 Harold S. Stone, John Turek, and Joel L. Wolf. 1992. Optimal Partitioning of Cache Memory. IEEE Trans. Comput. 41, 9 (1992), 1054-1068. https://doi.org/10.1109/12.165388
1_25 Carl A Waldspurger, Nohhyun Park, Alexander Garthwaite, and Irfan Ahmad. 2015. Efficient MRC construction with SHARDS. In 13th USENIX Conference on File and Storage Technologies (FAST 15). 95-110.
1_26 Z. Wang, K. S. McKinley, A. L. Rosenberg, and C. C. Weems. 2002. Using the compiler to improve cache replacement decisions. In Proceedings of PACT. Charlottesville, Va.
1_27 Xiaoya Xiang, Chen Ding, Hao Luo, and Bin Bao. HOTL: a higher order theory of locality. In Proceedings of ASPLOS.343-356, 2013.
1_28 Jake Wires, Stephen Ingram, Zachary Drudi, Nicholas JA Harvey, Andrew Warfield, and Coho Data. Characterizing storage workloads withcounter stacks. In Proceedings of the Symposium on Operating SystemsDesign and Implementation, pages 335-349. USENIX Association, 2014

### Part 2 References

2_1 George Almasi, Calin Cascaval, and David A. Padua. Calculating stack distances efficiently. In Proceedings of the ACM SIGPLAN Workshop on Memory System Performance, pages 37-43, Berlin, Germany, June 2002.
2_2 Berk Atikoglu, Yuehai Xu, Eitan Frachtenberg, Song Jiang, and Mike Paleczny. Workload analysis of a large-scale key-value store. In Proceedings of the International Conference on Measurement and Modeling of Computer Systems, pages 53-64, 2012.
2_3 Amro Awad, Arkaprava Basu, Sergey Blagodurov, Yan Solihin, and Gabriel H. Loh. Avoiding TLB shootdowns through self-invalidating TLB entries. In Proceedings of the International Conference on Parallel Architecture and Compilation Techniques, pages 273-287,2017.
2_4 Nathan Beckmann and Daniel Sanchez. Talus: A simple way to remove cliffs in cache performance In Proceedings of the International Symposium on High-Performance Computer Architecture, pages 64-75,2015.
2_5 L. A. Belady. A study of replacement algorithms for a virtual-storage computer. IBM Systems Journal, 5(2):78-101, 1966.
2_6 Erik Berg and Erik Hagersten. Fast data-locality profiling of native execution. In Proceedings of the International Conference on Measurement and Modeling of Computer Systems, pages 169-180,2005.
2_7 Kristof Beyls and Erik H. D'Hollander. Generating cache hints for improved program efficiency. Journal of Systems Architecture, 51(4):223-250, 2005.
2_8 Kristof Beyls and Erik H. D'Hollander. Discovery of locality-improving refactoring by reuse path analysis. In Proceedings of High Performance Computing and Communications. Springer. Lecture Notes in Computer Science, volume 4208, pages 220-229, 2006.
2_9 Jacob Brock, Xiaoming Gu, Bin Bao, and Chen Ding. Pacman: Program-assisted cache management. In Proceedings of the International Symposium on Memory Management, 2013.
2_10 Calin Cascaval, Evelyn Duesterwald, Peter F. Sweeney, and Robert W. Wisniewski. Multiple page size modeling and optimization. In Proceedings of the International Conference on Parallel Architecture and Compilation Techniques, pages 339-349, 2005.
2_11 Edward G. Coffman Jr. and Peter J. Denning Operating Systems Theory. Prentice-Hall, 1973.
2_12 Huimin Cui, Qing Yi, Jingling Xue, Lei Wang, Yang Yang, and Xiaobing Feng. A highly parallel reuse distance analysis algorithm on GPUs. In Proceedings of the International Parallel and Distributed Processing Symposium, 2012.
2_13 Peter J. Denning and Stuart C. Schwartz. Properties of the working set model. Communications of the ACM, 15(3):191-198, 1972.
2_14 Peter J. Denning and Donald R. Slutz. Generalized working sets for segment reference strings. Communications of the ACM, 21(9):750-759, 1978.
2_15 Peter J. Denning. The working set model for program behaviour. Communications of the ACM, 11(5):323-333, 1968.
2_16 David Eklov, David Black-Schaffer, and Erik Hagersten. Fast modeling of shared caches in multicore systems. In Proceedings of the International Conference on High Performance Embedded Architectures and Compilers, pages 147-157, 2011.
2_17 David Eklov and Erik Hagersten. StatStack: Efficient modeling of LRU caches. In Proceedings of the IEEE International Symposium on Performance Analysis of Systems and Software, pages 55-65, 2010.
2_18 Brad Fitzpatrick. Distributed caching with Memcached. Linux Journal, 2004(124):5, 2004.
2_19 Cary G. Gray and David R. Cheriton. Leases: An efficient fault-tolerant mechanism for distributed file cache consistency. In Proceedings of the ACM Symposium on Operating System Principles, pages 202-210, 1989.
2_20 Xiaoming Gu and Chen Ding. On the theory and potential of LRU-MRU collaborative cache management. In Proceedings of the International Symposium on Memory Management, pages 43-54, 2011.
2_21 M. D. Hill. Aspects of cache memory and instruction buffer performance. PhD thesis, University of California, Berkeley, November 1987.
2_22 Xiameng Hu, Xiaolin Wang, Yechen Li, Lan Zhou, Yingwei Luo, Chen Ding, Song Jiang, and Zhenlin Wang. LAMA: Optimized locality-aware memory allocation for key-value cache. In Proceedings of USENIX Annual Technical Conference, 2015.
2_23 Xiameng Hu, Xiaolin Wang, Lan Zhou, Yingwei Luo, Chen Ding, and Zhenlin Wang. Kinetic modeling of data eviction in cache. In Proceedings of USENIX Annual Technical Conference, pages 351-364, 2016.
2_24 Akanksha Jain and Calvin Lin. Back to the future: Leveraging Belady's algorithm for improved cache replacement. In Proceedings of the International Symposium on Computer Architecture, pages 78-89, 2016.
2_25 Theodore Johnson and Dennis Shasha. 2Q: A low overhead high performance buffer management replacement algorithm. In Proceedings of the 20th International Conference on Very Large Data Bases, 1994.
2_26 R. L. Mattson, J. Gecsei, D. Slutz, and I. L. Traiger. Evaluation techniques for storage hierarchies. IBM System Journal, 9(2):78-117, 1970.
2_27 Marshall Kirk McKusick, George V. Neville-Neil, and Robert N. M.
Watson. The Design and Implementation of the FreeBSD Operating System. Pearson Education, second edition, 2015.
2_28 Nimrod Megiddo and Dharmendra S. Modha. ARC: A self-tuning, low overhead replacement cache. In Proceedings of the 2Nd USENIX Conference on File and Storage Technologies, 2003.
2_29 Dushyanth Narayanan, Austin Donnelly, and Antony Rowstron. Write off-loading: Practical power management for enterprise storage. Trans. Storage, 4(3):10:1-10:23, November 2008.
2_30 Qingpeng Niu, James Dinan, Qingda Lu, and P. Sadayappan. PARDA: A fast parallel reuse distance analysis algorithm. In Proceedings of the International Parallel and Distributed Processing Symposium, 2012.
2_31 F. Olken. Efficient methods for calculating the success function of fixed space replacement policies. Technical Report LBL-12370, Lawrence Berkeley Laboratory, 1981.
2_32 Elizabeth J. O'Neil, Patrick E. O'Neil, and Gerhard Weikum. The LRU-K page replacement algorithm for database disk buffering. In Proceedings of the 1993 ACM SIGMOD International Conference on Management of Data, 1993.
2_33 Barton G. Prieve and Robert S. Fabry. VMIN—an optimal variable-space page replacement algorithm. Communications of the ACM, 19(5):295-297, 1976.
2_34 Moinuddin K. Qureshi, Aamer Jaleel, Yale N. Patt, Simon C. Steely, and Joel S. Emer. Adaptive insertion policies for high performance caching. In Proceedings of the International Symposium on Computer Architecture, pages 381-391,2007.
2_35 M. K. Qureshi and Y. N. Patt. Utility-based cache partitioning: A low-overhead, high-performance, runtime mechanism to partition shared caches. In Proceedings of the International Symposium on Microarchitecture, 2006.
2_36 Derek L. Schuff, Milind Kulkarni, and Vijay S. Pai. Accelerating multicore reuse distance analysis with sampling and parallelization. In Proceedings of the International Conference on Parallel Architecture and Compilation Techniques, pages 53-64, 2010.
2_37 Donald R. Slutz and Irving L. Traiger. A note on the calculation working set size. Communications of the ACM.
2_38 Harold S. Stone, John Turek, and Joel L. Wolf. Optimal partitioning of cache memory. IEEE Transactions on Computers, 41(9):1054-1068,1992.
2_39 R. A. Sugumar and S. G. Abraham. Efficient simulation of caches under optimal replacement with applications to miss characterization. In Proceedings of the International Conference on Measurement and Modeling of Computer Systems, Santa Clara, Calif., May 1993.
2_40 G. Edward Suh, Larry Rudolph, and Srinivas Devadas. Dynamic partitioning of shared cache memory. The Journal of Supercomputing, 28(1):7-26, 2004.
2_41 Carl A. Waldspurger, Nohhyun Park, Alexander T. Garthwaite, and Irfan Ahmad. Efficient MRC construction with SHARDS. In Proceedings of the USENIX Conference on File and Storage Technologies (FAST), pages 95-110, 2015.
2_42 Carl A. Waldspurger, Trausti Saemundsson, Irfan Ahmad, and Nohhyun Park. Cache modeling and optimization using miniature simulations. In Proceedings of USENIX Annual Technical Conference, pages 487-498, 2017.
2_43 Z. Wang, K. S. McKinley, A. L. Rosenberg, and C. C. Weems. Using the compiler to improve cache replacement decisions. In Proceedings of the International Conference on Parallel Architecture and Compilation Techniques, Charlottesville, Va., 2002.
2_44 Jake Wires, Stephen Ingram, Zachary Drudi, Nicholas JA Harvey, Andrew Warfield, and Coho Data. Characterizing storage workloads with counter stacks. In Proceedings of the Symposium on Operating Systems Design and Implementation, pages 335-349. USENIX Association, 2014.
2_45 Yutao Thong and Wentao Chang. Sampling-based program locality approximation. In Proceedings of the International Symposium on Memory Management, pages 91-100, 2008.
2_46 Pin Zhou, Vivek Pandey, Jagadeesan Sundaresan, Anand Raghuraman, Yuanyuan Zhou, and Sanjeev Kumar. Dynamic tracking of page miss ratio curve for memory management. In Proceedings of the International Conference on Architectural Support for Programming Languages and Operating Systems, pages 177-188, 2004.
2_47 Y. Zhou, P. M. Chen, and K. Li. The multi-queue replacement algorithm for second level buffer caches. In Proceedings of USENIX Technical Conference, June 2001.
2_48 Mutilate. https://github.com/leverich/mutilate, 2014. [Online].

### Part 3 References

3_1 A. Awad, A. Basu, S. Blagodurov, Y. Solihin, and G. H. Loh. Avoiding TLB shootdowns through self-invalidating TLB entries. In Proceedings of the International Conference on Parallel Architecture and Compilation Techniques, pages 273-287,2017.
3_2 B. Fitzpatrick. Distributed caching with Memcached. Linux Journal, 2004(124):5, 2004.
3_3 C. G. Gray and D. R. Cheriton. Leases: An efficient fault-tolerant mechanism for distributed file cache consistency. In Proceedings of the ACM Symposium on Operating System Principles, pages 202-210,1989.
3_4 B. G. Prieve and R. S. Fabry. VMIN—an optimal variable-space page replacement algorithm. Communications of the ACM, 19(5):295-297, 1976.

What is claimed is:

1. A processor comprising:
at least one core and an instruction set logic including a plurality of lease cache memory instructions; and
at least one cache memory operatively coupled to said at least one core, said at least one cache memory having a plurality of lease registers.

2. The processor of claim 1, wherein said at least one cache memory comprises a first-level cache.

3. The processor of claim 1, having a lease cache shared memory system comprising:
a lease controller; and
a lease cache memory operatively coupled to and controlled by said lease controller.

4. The processor of claim 1, wherein a lease cache shared memory system comprises for each of said at least one core:
an occupancy counter; and
an allocation register.

5. The processor of claim 1, wherein said instruction set logic comprises a processor instruction set architecture (ISA).

6. The processor of claim 1, wherein a lease cache shared memory system comprises an optimal steady state lease (OSL) statistical caching component.

7. The processor of claim 1, wherein a lease cache shared memory system comprises for each of said at least one core a space efficient approximate lease (SEAL) component.

8. The processor of claim 7, wherein a data structure of said lease cache shared memory system comprises a SEAL metadata.

9. The processor of claim 7, wherein said space efficient approximate lease (SEAL) component achieves an O(1) amortized insertion time and uses an O(M+1/α log L) space while ensuring that data stay in cache for no shorter than their lease and no longer than one plus some factor α times their lease, where O is a time, M is a number of unique items, α is an accuracy parameter, and L is a maximal lease.

10. The processor of claim 1, further comprising a near memory disposed on a same or different substrate as said processor, said near memory operatively coupled to said processor and comprising a lease controller; and a lease cache memory operatively coupled to and controlled by said lease controller.

11. A lease cache memory method comprising:
providing a computer program on a non-volatile media;
compiling said computer program with a program lease compiler to generate a binary code;
executing said binary code on a processor having a lease cache memory and an instruction set including a plurality of lease cache memory instructions; and
managing a population and an eviction of data blocks of said lease cache memory based on leases, each lease having assigned thereto a lease number.

12. The lease cache memory method of claim 11, wherein said step of compiling comprises assignment of a lease demand type of program lease, a time a data item is to stay in lease cache.

13. The lease cache memory method of claim 11, wherein said step of compiling comprises assignment of a lease request type of program lease, a time a data item is to stay in lease cache based on a cache size.

14. The lease cache memory method of claim 11, wherein said step of compiling comprises assignment of a lease termination type of program lease, to evict a data item from a lease cache.

15. The lease cache memory method of claim 11, wherein said step of managing a population and an eviction of data blocks of said lease cache memory is based on an optimal steady state lease (OSL) statistical caching.

16. The lease cache memory method of claim 15, wherein said OSL caching comprises a space efficient approximate lease (SEAL) component achieves O(1) amortized insertion time and uses an O (M+1/α log L) space while ensuring that data stay in cache for no shorter than their lease and no longer than one plus some factor α times their lease, where O is a time, M is a number of unique items, α is an accuracy parameter, and L is a maximal lease.

17. The lease cache memory method of claim 11, wherein said step of executing said binary code on a processor comprises executing said binary code on a processor having at least one lease controller and at least one lease cache.

18. The lease cache memory method of claim 11, wherein said step of executing said binary code on a processor comprises executing said binary code on a processor having at least one lease mark cache.

19. A software product provided on a non-volatile media which manages a main memory use by at least one or more clients comprising:
a lease cache interface to manage a main memory use by at least one or more clients, said lease cache interface operatively coupled to said at least one or more clients; and
a software lease cache system operatively coupled to said lease cache interface, said software lease cache system having a plurality of lease cache registers which manage use of a plurality of size classes of said main memory as directed by an OSL caching component.

20. The software product of claim 19, wherein said client comprises file caching of at least one local application.

21. The software product of claim 19, wherein said client comprises at least one remote client.
